(19) United States
(12) Patent Application Publication
(10) Pub. No.: US 2003/0105692 A1
(43) Pub. Date: Jun. 5, 2003

(54) Interfaces implementing management of retirement accounts over a network

(76) Inventors: James A. Gilbert, Los Angeles, CA (US); Manish Gupta, Tarzana, CA (US)

Correspondence Address: LACASSE & ASSOCIATES, LLC, 1725 DUKE STREET, SUITE 650, ALEXANDRIA, VA, 22314, US

(21) Appl. No.: 10/197,677

(22) Filed: Jul. 18, 2002

Related U.S. Application Data
(60) Provisional application No. 60/305,889, filed on Jul. 18, 2001.

(51) Int. Cl. G06F 17/60

(52) U.S. Cl. 705/35

(57) ABSTRACT

A plurality of specialized interfaces interact with a plurality of specialized gateways to provide plan provider representatives, plan sponsor representatives, and plan participants with access to a network-based retirement funds management system, wherein the interfaces assist in the real-time or near real-time management of retirement funds. The interfaces include at least the following: a plan provider interface (providing authorized plan provider representatives with access to plan provider gateway), a plan sponsor interface (providing authorized plan sponsor representatives with access to plan sponsor gateway), and a plan participant interface (providing plan participant with access to plan participant gateway).

### CROSS-REFEREMCE TO OTHER APPLICATIONS

The present application claims the benefit of provisional patent application “Select Administrator Software Specifications”, serial No. 60/305,889, filed Jul. 18, 2001.

### BACKGROUND OF THE INVENTION

1. Field of Invention

The present invention relates generally to the field of network-based funds management. More specifically, the present invention is related to network-based real-time management of retirement funds.

2. Discussion of Prior Art

401(k) plans are arguably the best government-sanctioned, tax-deferred retirement savings opportunities in the United States, and their numbers have grown commensurably since their institution by Congress in 1978. One estimate, by CHALK 401(k) Advisory Board, Inc., places the number of qualified 401(k) plans in 1997 (the last year surveyed) at 225,000, and the number of participants in those plans at approximately 28 million. The Investment Company Institute (ICI) estimated 36.7 million participants in 1998. New plans continue to grow in number at an annual rate of more than 14% (Source: U.S. Department of Labor).

However, 401(k) plans must be sponsored by an employer. Millions of American workers can't take advantage of a 401(k)s many attractive attributes because, for one reason or another (typically high plan costs, plan inflexibility, and/or prohibitive minimum participation standards), their employers do not sponsor such a plan. In particular, very small (including “micro” companies), small, and medium-sized companies have found sponsorship difficult, if not impossible Eighty-nine percent of very small companies (10-50 employees), 72% of small companies (50-100 employees), and 66% of medium-sized companies (100-250 employees) do not have 401(k) plans (Source: Census Bureau). It should be noted that these figures do not include the companies that have fewer than 10 employees—what might be called “micro” companies.

With regard to the desirability of employer offered benefits, employees rank 401(k) plans second only to health benefits when it comes to employer-offered benefits they desire. 401(k)s offer employees an unmatched long-term savings potential—primarily because neither 401(k) contributions nor their earnings are subject to income tax withholding during plan participants' pre-retirement years.

This tax deferral has a huge compounding effect: $150 per month put into a typical taxable savings account paying 8% annual interest will grow to $42,034 by the end of 20 years (assuming a combined federal and state personal income tax rate of 34%). In a 401(k), however, the same deposits earning the same rate of return during the same 20 years will yield $88,353. Even if that amount is taxed at the 34% rate when the money is withdrawn from the plan (which is unlikely if the participant is retired), the 401(k) participant will walk away with more than $16,000 compared to the typical equivalent non-401 (k) investment return. 401(k) plans have the highest annual contribution ceiling of any tax-deferred savings program (including IRAs, SEPs, etc.). Higher contributed amounts equal more money earning money—which equates to more money in the account 20 years later. Added to this earning potential is the convenience of using automatic payroll deductions. For the foregoing, it's easy to see why 401(k)s are so popular.

The non-profit Investment Company Institute (ICI), the trade association of the mutual fund industry, estimates that, at the end of 1998, assets in 401(k) plans stood at $1.41 trillion. These plan assets grew an average rate of 18% per year during the 1990s. Plansponsor.com reports that assets rose nearly 22% in the final year of the decade, from $1.7 trillion in 1999 to $2.1 trillion in 2000.

Average salary deferral rates of plan participants have also been on an exponential rise. The non-profit Profit Sharing 401(k) Council of America (PSCA) reports that the average salary deferral rate grew from 4.2% in 1991 to 5.4% by 1999—an increase of more than 28%.

According to the ICI and the non-profit Employee Benefit Research Institute, the average account balance at the end of 1998 was $47,000 per participant, up 26% from 1996. On average, 78% of eligible employees will participate in a 401(k) plan if one is made available, with the number of participants growing from 19.5 million in 1990 to 53.2 million in 2000.

Some of the increase in participation rates is due to the introduction of “negative election,” which allows an employer to automatically enroll employees into its 401(k) when employees meet the plan's eligibility requirements. The negative election deferral rate and investment(s) must be defined ahead of time, and the employee must be immediately notified of his or her participation status. Automatic enrollment programs are sanctioned by the IRS under the Employment Retirement Income Security Act (ERISA) as long as the employee has ample ability to cease enrollment at will.

A constraint on 401(k) growth is the fact that 401(k) plans must be sponsored by an employer and contributions must be subtracted from the employee's pay within the payroll process before income tax withholding is calculated. Due largely to misinformation about the complexity of running a 401(k), coupled with a general fear of the IRS and the Department of Labor (both of which have regulatory power over the plans), many employers have excluded this popular benefit from their employee benefits package. This is especially true of very small (including micro), small, and medium-sized companies.

For many small and medium-sized companies that do have 401(k)s, the plans' futures are bleak: many are being canceled because they are not profitable enough a service for vendors to maintain; in other cases, service is not being canceled but the level of service is so disproportionate to the high fees being charged that employers themselves must pull out or endure the aggravation of continually feeling as if they are being over-charged. As an estimate, it is believed that there are more than 400,000 very small (including micro companies), small, and medium-sized companies that: (a) have no plan, (b) have had their plan canceled or have canceled their plan, or (c) have a plan with which they are unsatisfied.

Traditional 401(k) plan vendors did not think much about approaching smaller companies until recently, and then did so only because they recognized that the larger-company market was pretty well saturated. When they did turn their attention to the smaller and mid-sized plan market, they were well prepared, with a library of useful educational materials for potential and actual plan participants.

Unfortunately, however, these vendors were not as equally prepared to service the needs of the smaller companies: the plans they designed and the packages they offered were not always appropriate in price, substance, or style; and their pamphlets and publications have often been too dry, legalistic, and expensive. Perhaps because most of these vendors are large companies themselves, they have difficulty conceiving 401(k) plans that embody the entrepreneurial, “do-it-yourself” spirit so prevalent in many small and medium-sized companies.

Thus, there is a need for high-quality, affordable 401(k) plans for small and medium-sized companies; i.e., plans that would:

accommodate any number of participants;

offer a wide selection of SEC-regulated mutual fund investment options and self-directed brokerage accounts;

allow multiple families of mutual funds within a single plan;

provide a full range of 401(k) features such as employer-matching contributions, monthly participant account statements, loans, and hardship withdrawals; and

provide a computer network structure to enable 24/7 access to all parties involved in the 401(k) plan.

U.S. Pat. No. 6,041,313, assigned to the applicant, teaches the use of individual participant accounts rather than a pooling of employees' contributions in a single omnibus mutual fund account.

In 1997, the applicant began development of a new generation of 401(k)-administration software, to be called 401(k) Easy®. 401(k) Easy, delivered to adopting employers on CD-ROM, is a Windows®-based, complete 401(k) set-up and administration system designed to run on an employer's in-house computer system. 401(k) Easy is highly automated and designed for easy operation by non-professionals. Since the plan sponsor runs the company's plan “in-house,” the need to hire and retain an outside third-party administrator (TPA) is eliminated. By eliminating the TPA, the plan sponsor can expect a savings of up to 90% off the traditional cost of providing a 401(k) to company employees.

401(k) Easy software is simple to use and inexpensive to license, so primary obstacles that small businesses face when offering a 401(k)—high cost and operational complexity—have been eliminated. The “run-it-yourself” approach so popular today with small businesses in addressing tasks such as payroll and bookkeeping has proven to be equally well suited to the routine task of 401(k) plan administration.

The invention relies substantially on the speed, efficiencies, and information mobility inherent on the Internet. Internet penetration and usage by small business is a key component of the present invention. According to a survey conducted by the International Data Corporation (IDC), Internet usage by small business reached 62% in 1998. Total small business spending on Internet-related applications is expected to increase from $6.6 billion in 1998 to 418.2 billion by the end of 2002, yielding an annual growth rate of 45%.

The following references provide for a general description of systems and interfaces that allow for the management of various types of funds, including retirement funds. But, as stated earlier, none of these references teaches along the lines of the present invention's interfaces utilized for the management of retirement accounts, such as 401(k) plan accounts, over a network such as the Internet.

The U.S. patent to Harris et al. (U.S. Pat. No. 5,517,406), assigned to The Shareholder Services Group, Inc., provides a method and apparatus for data verification and position reporting in an automated trade transaction processing system. The system also includes a record keeper for receiving participant mutual fund transaction requests and a record keeper that aggregates the participant mutual fund transaction requests by mutual funds into omnibus plan transaction requests.

The U.S. patent to Jennings et al. (U.S. Pat. No. 5,659,165), assigned to Citibank N.A., provides for a customer-directed, automated process for transferring funds between accounts via a communication network. The system automatically computes the appropriate exchange rates and any fees to be charges to the account and displays them to the user so that the user may authorize or cancel a transaction. Additionally, the system is provided with various safeguards to assure that only authorized individuals have access to accounts and the funds and immediately verifies successful completion or failure to the customer.

The U.S. patent to Campbell (U.S. Pat. No. 5,749,077), assigned to FS Holding, Inc., provides for a method and apparatus for updating and selectively accessing financial records related to investments. In the preferred approach, for selected categories of information, the user may elect one of three options as to each screen field to obtain rapid, customized information delivery.

The U.S. patent to Funk (U.S. Pat. No. 5,793,497), assigned to Infobeat, Inc., provides for a method and apparatus for delivering and modifying information electronically from one or more information sources such as a stock exchange.

The U.S. patent to Hackel et al. (U.S. Pat. No. 5,806,047), assigned to Metlife Life Insurance Company, provides for a system for combined pool portfolio. The disclosed system allows pension plans and individuals' pension accounts which own employer securities to transfer the employer securities into a combined pool.

The U.S. patent to Wilson (U.S. Pat. No. 5,864,827), assigned to Belzberg Financial Markets and News International, Inc., provides a system and method for providing an information gateway, wherein the gateway allows the transfer of information between financial markets and customers.

The U.S. patent to Maggioncalda et al. (U.S. Pat. No. 5,918,217), assigned to Financial Engines, Inc., provides a user interface for an advisory system. Disclosed is a user interface for a financial advisory system, which provides a user with an interactive method of exploring how changes in one or more input decisions such as a risk tolerance, a savings level, and a retirement age affect one or more output values such as a probability of achieving a financial goal or an indication of short-term risk.

The U.S. patent to Harris et al. (U.S. Pat. No. 5,918,218), assigned to First Data Investor Services Group, Inc., provides for a method and apparatus for automated trade transactions processing. In the disclosed system, a record keeping system aggregates the participants mutual fund transactions into omnibus plan trades which is then transmitted to a host processor.

The U.S. patent to Debe (U.S. Pat. No. 5,983,204), assigned to Americus Shareowner Service Corp., provides a system and method for supporting a new financial instrument for use in closed end funds. Disclosed is a data processing system to effectuate all transactions pertaining to PREPs (Put Ratio Equity Protection) and the creation of PREP certificates.

The U.S. patent to Williams et al. (U.S. Pat. No. 5,999,918), assigned to Rational Investors, Inc., provides for interactive color confidence indicators for statistical data. Disclosed is a computer interface system (virtual investment advisor) that includes interactive interface controls as well as aural and kinetic interface controls to assist in educating a user, in profiling a user, and in controlling and monitoring the implementation of actions involving investments. In addition, the user is able to manipulate the interface controls to evaluate results in terms of confidence and risk, and upon approval, may transmit selections to effectuate an action.

The U.S. patent to Ferguson et al. (U.S. Pat. No. 6,064,984), assigned to MarketKnowledge, Inc., provides for a graphical user interface for a computer-implemented financial planning tool. Disclosed is a computer-implemented method for financial planning, which may provide a display framework in conjunction with a repository of information about financial products for the purpose of creating an on-line financial plan. In addition, the method provides a computer-implemented method of financial planning to be used by a broker and a customer together in an interactive manner.

The U.S. patent to Edelman (U.S. Pat. No. 6,064,986), assigned to Edelman Financial Services, Inc., provides for a computer assisted and/or implemented architecture for customer account creation, maintenance and administration for an investment and/or retirement program. The U.S. Pat. No. 6,085,174, also to the same assignee, provides a computer product for instructing a computer to perform a process of administering in the administration of resources of a customer for the benefit of a beneficiary.

The U.S. patent to Schoen et al. (U.S. Pat. No. 6,235,176), assigned to MB Schoen and Associates, provides for a computer apparatus and method for defined contribution and profit sharing pension and disability plan.

The published patent application to Calver (U.S. 2001/0032092 A1) discloses a small business web-based portal method and system for interactively providing user-tailored financial and business information based upon user-provided financial and business information.

The published patent application to Kelly et al. (U.S. 2001/0037276 A1) provides a system and method for group retirement plan administration. The disclosed method provides group retirement services to one or more sponsors, wherein at least one sponsor has one or more participants enrolled in a retirement plan.

The interface of the present invention overcomes the pitfalls posed by many prior art funds management systems, including the prior art systems described above, and provides for the management of retirement accounts by account holders over a network such as the Internet. Whatever the precise merits, features, and advantages of the above-cited references, none of them achieves or fulfills the purposes of the present invention.

### SUMMARY OF THE INVENTION

The present invention provides for a plurality of specialized interfaces capable of interacting with a plurality of specialized gateways to provide plan provider representatives, plan sponsor representatives, and plan participants with access to a network-based retirement funds management system. The interfaces include at least a plan provider interface, a plan sponsor interface, and a plan participant interface.

The plan provider interface receives inputs from authorized plan provider representatives and based on the received inputs performs (via instructions to a plan provider gateway, a plan sponsor gateway, or a plan participant gateway) any of, or a combination of, the following tasks: perform all plan maintenance, approve and modify client and plan settings, process corrections and adjustments, review audit trail of transactions and activities for each plan, suspend plans, maintain a spectrum of funds, process and distribute income and dividends, review system logs, as well as other essential plan provider functions.

The plan sponsor interface receives inputs from authorized plan sponsors and based on the received inputs performs (via instructions to said plan sponsor gateway or a plan participant gateway) any of, or a combination of, the following tasks: setup and maintain client information, setup and maintain multiple concurrent plans, define fund availability, process plan activity, approve plan activity, administer plan activity, review fee changes, enter company bulletins, perform compliance testing, as well as other essential plan sponsor functions.

The plan participant interface receives inputs from authorized plan participants and based on said received inputs performs (via instructions to said plan participant gateway) any of, or a combination of, the following tasks: updating information associated with said participants, updating investment designations, view and print activity reports, and monitoring, modeling and applying for loans, transfers, distribution, as well as other essential plan participant functions.

In the preferred embodiment, the interfaces are implemented via Java and can be rendered via any industry standard browser. Additionally, in one embodiment, the retirement funds are funds associated with any of the following plans: 401(k) plans, money purchase plans, or profit sharing plans.

### BRIEF DESCRIPTION OF THE DRAWINGS

FIG. 1 illustrates a web-based retirement funds management system working in conjunction with the present invention's specialized interfaces.

FIG. 2 illustrates the functionality associated with the present invention's plan provider interface.

FIG. 3 illustrates the functionality associated with the present invention's plan sponsor interface.

FIG. 4 illustrates the functionality associated with the present invention's plan participant interface.

FIG. 5 summarizes the interaction between various entities and gateways used in conjunction with the interfaces of the present invention.

FIG. 6 illustrates a three-tier implementation of a system based upon the interfaces of the present invention.

FIG. 7 illustrates the various interfaces associated with the plan provider.

FIGS. 8-36 collectively illustrate screenshots of various interfaces described in FIG. 7.

FIG. 37 illustrates the various interfaces associated with the plan sponsor.

FIGS. 38-85 collectively illustrate screenshots of various interfaces described in FIG. 37.

FIG. 86 illustrates the various interfaces associated with the employee/plan participant.

FIGS. 87-99 collectively illustrate screenshots of various interfaces described in FIG. 86.

FIG. 100 illustrates the core data structure of various relational data structures associated with the present invention.

FIG. 101 illustrates an example of how the core data structure of FIG. 10 is utilized for distributions and transfers.

FIG. 102 illustrates an example of how the core data structure of FIG. 10 is utilized for processing contributions.

### DESCRIPTION OF THE PREFERRED EMBODIMENTS

While this invention is illustrated and described in a preferred embodiment, it should be noted that the interface may be created with different looks and feels. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. The terms “end user”, “user”, “participant”, “customer”, “account holder”, and “employee” are used interchangeably throughout the specification, and therefore should not be used to limit the scope of the present invention.

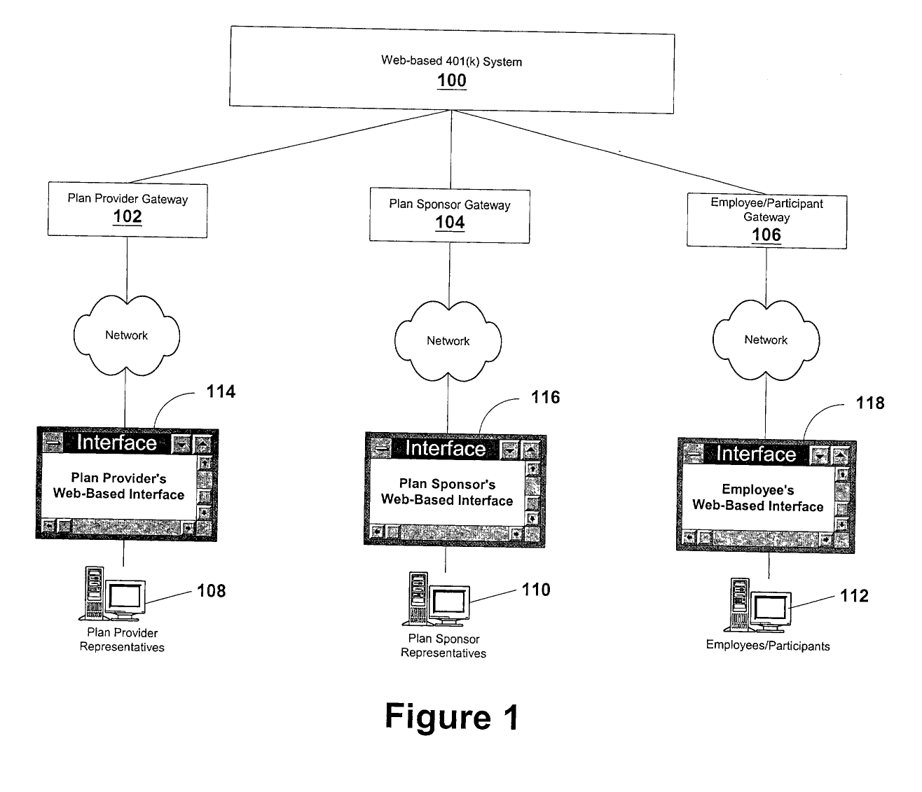

FIG. 1 illustrates a web-based retirement funds management system 100 working in conjunction with the present invention's specialized interfaces, wherein the system is accessible by three types of users: plan providers (banks, brokerages, insurance companies, payroll services, etc.); plan sponsors (individual companies that offer 401(k) to their employees); and plan participants. Each type of user has the ability to perform his/her appropriate and necessary functions via three user-defined gateways: plan provider gateway 102, plan sponsor gateway 104, and plan participant gateway 106. Plan provider representatives 108, plan sponsor representatives 110, and plan participants 112 access the above-mentioned gateways via the present inventions specialized interfaces: plan provider interface 114, plan sponsor interface 116, and plan participants interface 118. Interfaces 114, 116, and 118 interact with gateways 102, 104, 106 over a network such as the local area network (LAN), wide area network (WAN), wireless network, or the Internet.

A detailed description of each of the interfaces (plan provider interface, plan sponsor interface, and plan participant interface) of the present invention is provided below. It should be noted that although each interface is addressed as a singular entity, a plurality of interfaces can be collectively envisioned implementing each of the described interfaces.

### Plan Provider Interface 114

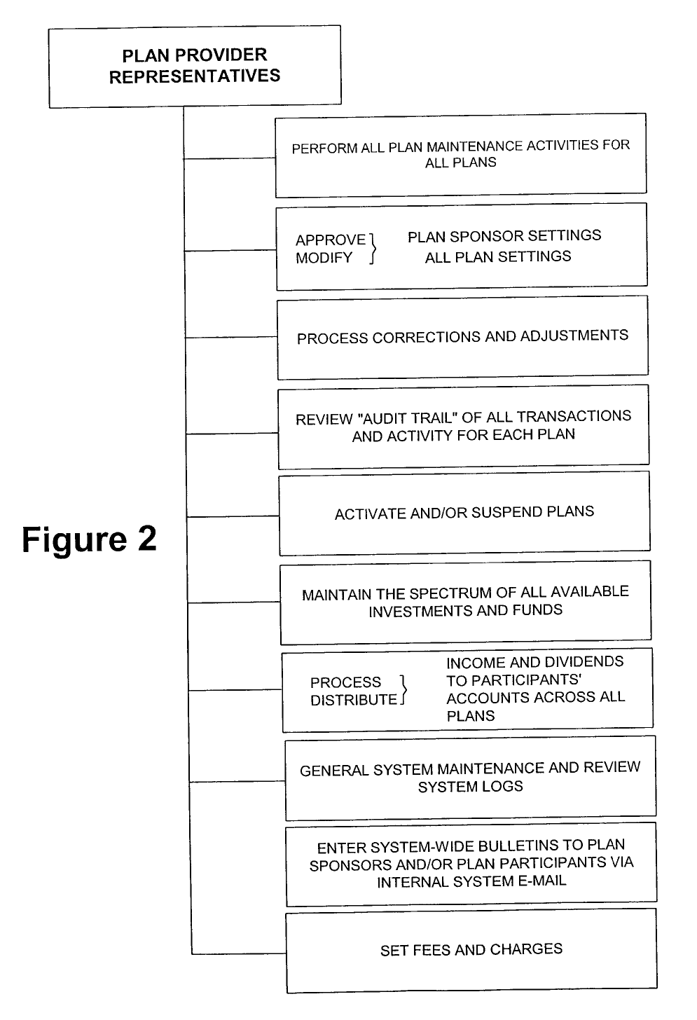

FIG. 2 illustrates various functionalities associated with the present invention's plan provider interface 114. The plan provider interface 114, in conjunction with the plan provider gateway 102 allows personnel of a financial intermediary the ability to interactively:

Perform any plan maintenance activities available through the plan sponsor gateway.

Approve and modify client and plan settings, including: general information, fee structure, and available investments/fund choices.

Process plan corrections and adjustments.

Review the “audit trail” of all transactions and the activity for each plan.

Suspend a plan's operation.

Maintain the offered spectrum of investments/funds.

Process and distribute investment income and dividends.

Perform general system maintenance activities and review system logs.

The present invention's plan provider interface 114 provides intuitive configuration controls that enable the provider's authorized personnel to navigate and update system settings.

Functions pertain to:

Users: The plan provider can add, delete, and modify the security privileges of its authorized customer service and back-office personnel;

Investments: The plan provider interface allows maintenance of the spectrum of investments offered by the provider. Investments appear within each client's plan sponsor gateway and plan participant gateway according to the subset of investments the client selects for its plan. Investment data includes, among other fields: investment name, investment type, abbreviation, ticker symbol, cusip, fund number, daily net asset value (editable by provider), daily accrual factors (editable by provider), and income posted to each investment (editable by provider but validated against the asset custodian's records);

Prototype Plan: The provider can have the prototype plan configuration wizard operate in conjunction with an IRS-approved prototype plan document, or the provider can have the wizard operate in conjunction with any other vendor's plan documents;

General: The interface includes provisions for activation/deactivation, archival period, and setting of batch transmittal times.

Within the client and plan management functions, the provider's authorized personnel can:

View a list of all plans in the system.

Review and update plan information, including: settings, activity, fees, pending transactions, corrections, and adjustments thereof.

Jump to plan administration for a selected client's plan, with automatic entry through the plan sponsor gateway, if security privileges so authorize.

View and update client information.

Review plans submitted through the plan setup wizard, review items with the client as needed, then approve or decline the plan for acceptance into the system.

Generate plan documents by having the system export relevant client and plan data, as captured by the plan setup wizard (export file layout keyed to provider's prototype plan document system), with documents transmitted to the client for approval, then the provider's representative can open the plan-specific plan sponsor and plan participation gateways.

View and apply detailed histories of plan activity, including contributions, liquidations, transfers, and distributions (plan activity is listed as current or archived, depending on appropriate factors and choices made during processing).

Establish, review, and update fee activity for client's plan(s). Fees can be processed through a predefined payment algorithm (algorithm used to determine which investments are liquidated to satisfy payment of fee), as defined by provider, and fee information can be exported to provider's fee processing center, if any.

View and act upon pending transactions for the specified plan, as listed in the “Pending Transactions” panel and provider representatives can review transaction details (participant name, plan name, transaction type/description, etc.), note why a transaction is pending, and, if desired, release the pending transaction for processing or cancel it (a transaction might be pending, for example, because receipt of money by the trust system cannot be verified though the asset custodian interfaces).

View and organize activity via the plan audit log. Information can be sorted by date, range, user, participant name, transaction type, investment name or type, and/or source.

Make corrective entries via the corrections/adjustments panels. The interface includes provisions for calculating adjustment amounts for the user based on the corrections. Moreover, the service representative can then choose to post or override the adjustments.

Access and use any plan administration functions available through the client's plan sponsor interface.

The global audit log maintains a record of all activity performed throughout the system, including activities at the general system administration level. The provider's personnel can search for information by client, plan, date range, plan administrator, participant, and/or transaction type.

### Plan Sponsor Interface 116

The present invention's plan sponsor interface 116 provides plan sponsor with a pathway, via the plan sponsor gateway 104, to the 401(k) system's plan administration functions. It is accessible to both authorized provider representatives 108 as well as, to the degree that the plan is a self-service 401(k), authorized plan sponsor personnel 110. For instance, in fully self-service plans, all plan administration functions are active and accessible to authorized plan sponsor personnel; whereas in more full-service plans—ones in which the client is paying the provider to handle the plan's administration—either the entire gateway is hidden to anyone but the authorized provider representatives, or perhaps just one or two of the most basic communication functions—such as fees and configure bulletins—are apparent to authorized plan sponsor personnel. It should be noted that access to the 401(k) system's plan administration is user-name and password protected. Functions are separated into two streams: (1) plan configuration functions, which control overall plan information and operation parameters; and (2) day-to-day plan administration functions, which power and monitor day-to-day administrative activity.

The 401(k) system's plan configuration wizard enables a plan sponsor, with or without the help of the licensed provider, to customize its 401(k) plan within the options allowed within the IRS-approved prototype plan that the licensed provider has chosen to employ (go to system provider gateway, system configuration functions for details on the licensed provider's prototype plan options). Data collected by the wizard is transmitted to the licensed provider in a format conducive to speedy and accurate production of necessary documents and collateral materials.

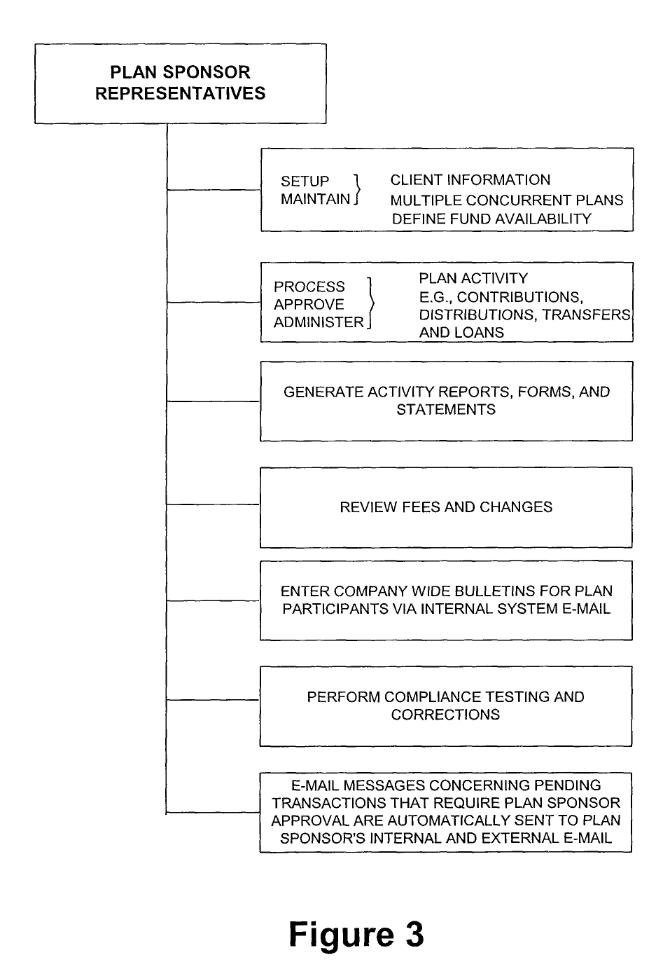

FIG. 3 illustrates various functionalities associated with the present invention's plan sponsor interface 116 of FIG. 1. The plan sponsor interface, in conjunction with the plan sponsor gateway 104, provides all functionality necessary for the subscribing employer to:

Configure Client: Allows authorized user(s) to view and edit the company's name, address, tax ID number(s), etc., to be associated with the selected plan, as well as to establish log-in names and passwords authorizing the entry to a plan's day-to-day administration functions. Thus, authorized user(s) are able to set up and maintain company information, divisions, employee records, etc.;

Configure Bulletins: Enables authorized user(s) to create bulletins that will be visible to each employee as they log into the system;

Configure Divisions: Enables authorized user(s) to create and modify divisions to attach to employee data. Common division categories include branch office locations and company departments (i.e., accounting, marketing, etc.);

Configure Employees: Enables authorized user(s) to access the list of fees the provider service representative has posted to the plan sponsor's account. If the plan sponsor has more than one plan, fees are categorized by application plan.

### Day-to-Day Plan Administration Functions

401(k) system's day-to-day plan administration functions include:

Plans: The ability to view and edit (as appropriate) a list of the plan sponsor's existing plan(s) with the provider and to model a new plan, if desired, for approval submission to a provider service representative.

Transaction Log: Displays a list of transactions for the currently selected plan as well as the status of each transaction (pending, held, settled, etc.).

Participants: Leads into the main participant activity functions for the selected plan. The initial panel displays a list of plan participants and links to the plan participant gateway for access to direct management of employees' accounts, including loan, transfer, and distribution activity.

Investments: Displays the investments (including self-directed brokerage accounts, if any) currently offered within the selected plan. Investments can be any subset (including the complete set) of investments the provider has chosen to have its licensed 401(k) system offer its 401(k) clients.

Process Contributions: Allows the authorized user(s) to process regular as well as “special” contributions, such as transfers from a previous employer's 401(k) plan. Contribution payroll information can be uploaded from a text file directly into the processing grid. The system will perform automatic validation checking and report any errors or rule violations encountered in the data. The authorized user(s) can do all plan processing at once or save data and continue later. In self-service plans, once data is submitted for processing, it is held by the system until verification of funds is received through the asset custodian or released by a provider service representative.

Set up and maintain multiple concurrent plans.

Define fund availability within each plan.

Process, approve, and administer plan activity including contributions, distributions, transfers, and loans.

Generate activity reports, forms, and statements.

Review fees and charges.

Enter company-wide bulletins for employees.

Perform compliance testing, including: 402(g), 401(k), 401(m), 415, multiple use test, top heavy test, coverage test, and compensation test.

Participant Loans, Transfers, and Distributions: Accessed through the plan participant gateway, the loans, transfers and distributions panel displays a list of pending loan, distribution, and transfer requests submitted by plan participants. Authorized plan administration user(s) can approve or deny the requests and can model new loans, distributions, and transfers for plan participants.

In addition, authorized plan administration user(s) can key in loan payoffs, partial payoffs, and re-amortizations. In the case of payoffs or partial payoffs within self-service plans, transactions remain in “pending” status until verification of funds is received from the asset custodian or until specifically released by an authorized provider service representative.

Activity: Accessed through the plan participant gateway, the activity panel displays a detailed list of buy/sell activity for all participants of the selected plan. Data can be filtered by date range, participant, investment name, and source.

In self-service plans, authorized plan sponsor personnel handle all of the above. In full-service plans, provider representatives run these day-to-day administration functions.

The plan sponsor interface of the present invention enables viewing and printing forms related to the activity in the plan. Forms include, among many others, enrollment, loan request, and request for investment statements being sent to more than one address.

The present invention's plan sponsor interface enables viewing, printing, and generating any of a variety of administration reports, including: contribution statements for participants, allocation logs, and ERISA 404c compliance logs (which list, among other things, fulfillment of information requests to eligible employees).

In self-service plans, the authorized plan sponsor can access and generate the above. In full-service plans, the provider representatives take charge.

### Plan Participant Interface 118

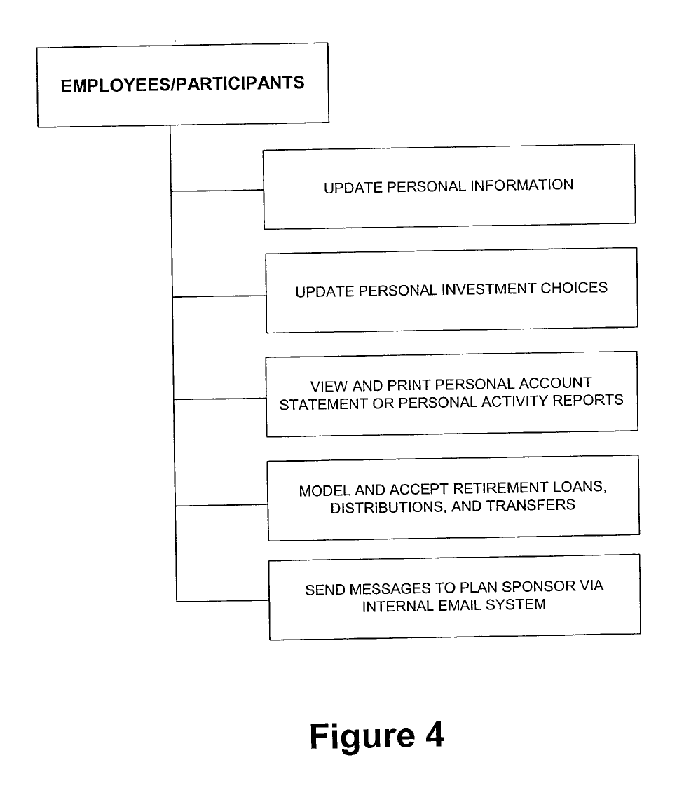

The plan participant interface 118 of the present invention allows plan participants to serve themselves—at any time, day or night, from any location connected to the Internet—to their 401k account activity and information. FIG. 4 illustrates the functionality associated with the plan participant interface that provides plan participants with access to the 401(k) system via the plan participant gateway.

401(k) system's self-service plan participation gives eligible employees on-the-spot access to enrolling in the plan, updating personal information and investment designations, viewing/printing activity reports and account statements, and 401(k) loan, transfer and distribution modeling and/or new submissions, among other things.

Self-service plan participation is extremely convenient for plan participants and can greatly boost plan participation rates.

Self-service plan participation means far less work for the plan administrator (whether that administrator is the plan sponsor, in the case of self-service plans, or provider personnel, in the case of full-service plans).

Self-service plan participation means the licensed provider can stay completely out of day-to-day plan participation activity and yet monitor and/or get involved in activity at any time.

The 401(k) system creates a home page for each plan participant. Upon login, the participant arrives at the home page, which welcomes the participant to the system's self-service plan participation functions and, subject to the provider's and/or plan sponsor's desire, shows the participant's investment designations, account balances, recent account activity, etc. Any current bulletins the plan sponsor and/or provider have created via the 401(k) system are also displayed on each participant's home page.

Plan participants never have to involve the plan administrator (whether that administrator is the plan sponsor, in the case of self-service plans, or provider personnel, in the case of full-service plans) in routine account information updates.

Plan participants update personal information themselves, online, at their leisure. Participants can amend their address, telephone number(s), disbursement preferences, passwords, and more. The 401(k) system immediately notifies the designated plan administrator via e-mail of any changes.

The provider and, at the provider's discretion, the plan sponsor can elect to mandate that the designated plan administrator approve changes before they become effective.

(Unless the plan is fairly small, however, such is not recommended, as it can become too time-consuming for the plan administrator.)

Plan participants never have to go through their designated plan administrator (whether that administrator is the plan sponsor, in the case of self-service plans, or provider personnel, in the case of full-service plans) to access and/or amend their salary deferral rates and/or their investment designations.

The 401(k) system displays for the participant all available plan investments and indicates those to which the participant is contributing and at what rates.

The 401(k) system also gives the participant options for amending his/her designations.

The licensed provider or, at the provider's discretion, the plan sponsor can elect to mandate that the designated plan administrator approve changes before they become effective.

All investment and salary deferral designations are restricted within the 401(k) system by rates allowable under the current federal law.

In addition, the provider can impose restrictions on investing, such as monthly minimums per investment; any such restrictions are incorporated into the provider's 401(k) system and applied to all relevant functions within all gateways.

Any changes the provider chooses to make to such restrictions are easily communicated to plan participants via the 401 (k) system bulletins functions.

Plan participants never have to go through their designated plan administrator for transaction information (on existing loans, transfers, distributions, etc.). Instead, participants simply go online and access the information themselves. Participants are able to monitor, model, and apply for loans, transfers, and distributions.

In addition, participants considering a new loan, transfer, or distribution can have the 401(k) system model the effect of such on their 401(k) account:

During the modeling process, the 401(k) system calculates the availability of funds based on money sources, aged buckets (if applicable), and other applicable rules.

To accept a new loan, transfer, or distribution, the participant must correctly answer one of his or her “secret” questions that the employee established when setting up his or her log-in name and password (see below).

New loans, distributions, and transfers must be approved by the designated plan administrator and are indicated as “pending” until so approved.

The 401(k) system gathers the information the designated plan administrator needs to approve or deny an application.

The provider (or at provider's discretion, the plan sponsor) can have the 401(k) system decline any new submission for loans, transfers, or distributions if an application for such is already in the system as “pending” approval of the designated plan administrator. This works as a safeguard against plan participants flooding the system with applications for the same transaction while the plan administrator awaits, for example, a spousal content.

Within the loans, transfers, and distributions panel, the participant also has the option to download and/or print necessary forms to request loans, distributions, and transfers in person from the designated plan administrator and to manually perform other related account maintenance activities.

Plan participants enter the plan participation gateway by keying in the user name and password they established during their first visit.

The designated plan administrator (whether the plan sponsor, in the case of self-service plans, or provider personnel, in the case of full-service plans) issues a temporary password for that first visit to allow an employee entrance into the system.

Eligible employees not currently enrolled in the plan can easily be granted temporary passwords by the designated plan administrator so that they can discover how easy saving money via the company's online 401(k) plan can be.

When establishing their user name and password, plan participants also establish three identifying questions and answers, such as to “mother's maiden name”. These questions are later used to confirm the participant's identity when the participant, for instance, applies for a 401(k) loan or forgets his/her password.

The 401(k) system houses a complete log of each employee's user name, password, and three questions/answers within the plan sponsor gateway (which is also accessible to authorized provider personnel); plan participants can request help from the designated plan administrator (via the 401(k) system, in person, by phone, etc.) at any time.

Self-service equates to low overhead for the provider and marketability to plan sponsors. With the 401(k) system, plan participation is self-service.

Self-service plan participation means participants can access their 401(k) accounts anytime from anywhere. This flexibility makes the 401(k) system plans highly popular with plan participants, and thus highly marketable to plan sponsors.

The 401(k) system allows the licensed provider the flexibility of promoting its self-service plan participation with both full-service (i.e., administration handled via the 401(k) system by the provider) and self-service (administration handled via the 401(k) system by the plan sponsor) 401(k) plans with very low overhead on the service.

The 401(k) system's self-service plan participation means that whoever (be it plan sponsor or licensed provider) is using the 401(k) system to run the 401(k) plan is freed from numerous tasks such as fulfilling participant requests for enrollment, information, forms, address updates, and more.

The 401(k) system's self-service plan participation means the licensed provider can have the system pre-programmed to access all information a participant is likely to request—including investment information and prospectuses—thus completely freeing the provider from day-to-day participation activities (but always with complete oversight capabilities of those activities).

Self-service plan participation means such a greatly reduced plan administration load that most plans can be run—whether by an authorized provider or by plan sponsor personnel—via the 401(k) system on average of few minutes.

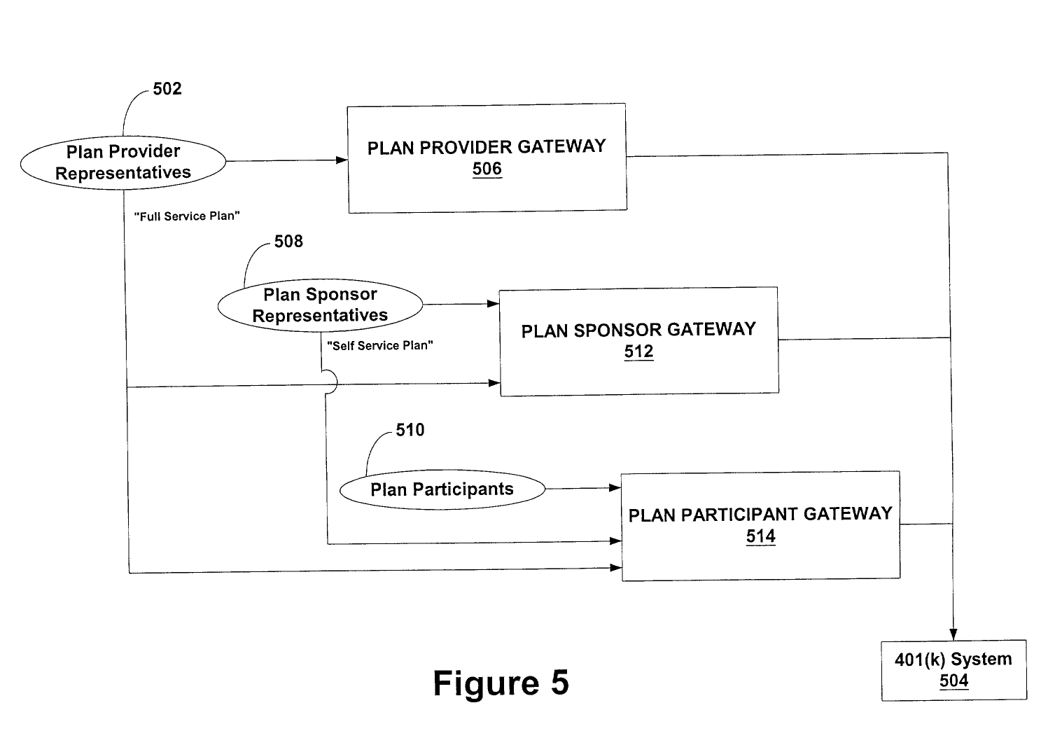

FIG. 5 summarizes the interaction between various entities and gateways. Plan provider representatives 502 are able to access the network-based 401(k) system 504 using the plan provider interface and the plan provider gateway 506. Similarly, plan sponsor representatives 508 and plan participants 510 are able to access the 401(k) system 504 via the plan sponsor gateway 512 (and plan sponsor interface) and plan participant gateway 514 (and plan participant interface) respectively. It should be noted that in the above-mentioned full service plan, plan provider representatives 502 are able to additionally access both the plan sponsor gateway 512 and the plan participant gateway 514. Similarly, in a self-service plan, the plan sponsor representatives 510 are able to additionally access the plan participation gateway 514.

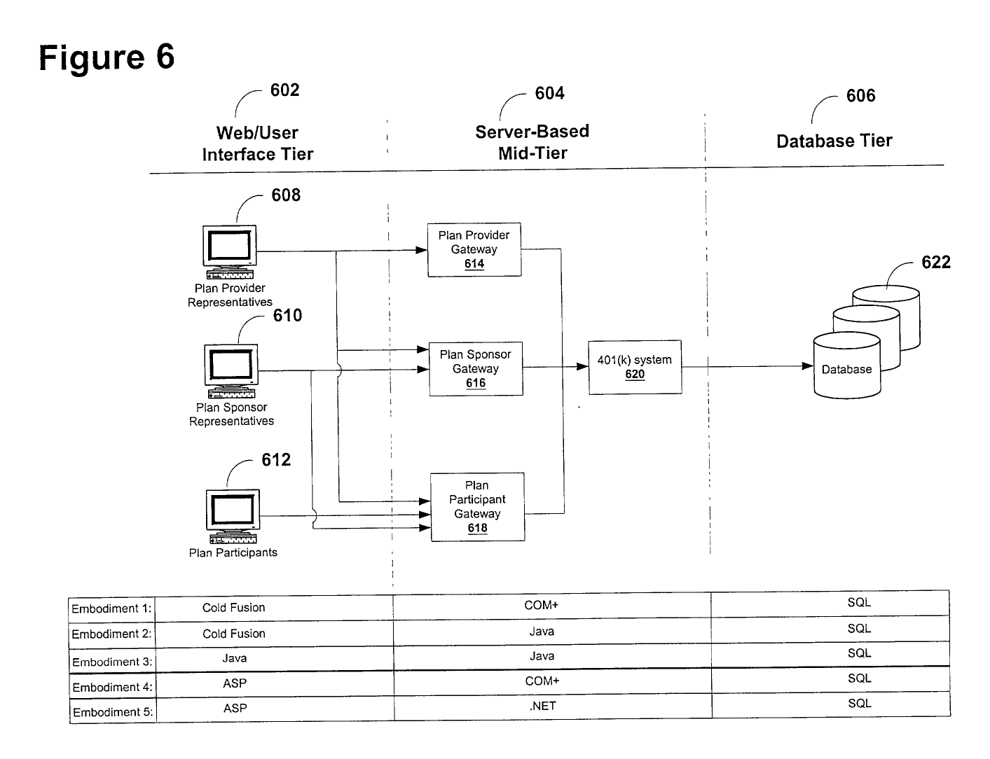

FIG. 6 illustrates a three-tier implementation (web/user interface tier 602, server-based mid-tier 604, and database tier 606) of a system based upon the present invention. In the web/user interface tier 602, plan provider representatives 608, plan sponsor representatives 610, and plan participants 612 use their respective interfaces (i.e., plan provider interface, plan sponsor interface, and plan participant interface) to interact with a server-based mid tier comprising the gateways (i.e., plan provider gateway 614, plan sponsor gateway 616, and plan participant gateway 618) and the 401(k) system as outlined in FIG. 5. The 401(k) system 620 in turn is operatively linked to the database tier 606.

In one embodiment, the web/user interface tier 602 is implemented using ColdFusion® and the server-based mid-tier 604 is implemented via COM+®. In a second embodiment, the web/user interface tier 602 is implemented using ColdFusion® and the server-based mid-tier 604 is implemented via Java®. In a third embodiment, both the web/user interface tier 602 and the server-based mid-tier 604 are implemented via Java. In a fourth embodiment, the web/user interface tier 602 is implemented via ASP and the mid-tier 604 is implemented using COM+. In a fifth embodiment, the web/user interface tier 602 is implemented using ASP and the mid-tier 604 is implemented using a NET® architecture. In each of the above-mentioned three-tier embodiments, the database tier 606 can be implemented via an ODBC compliant database implementation such as a SQL server 622. It should be noted that in each of the embodiments the business logic is encapsulated in the server-based mid-tier 604. For example, the business logic can be encapsulated in the form of Enterprise Java Beans®.

In an extended embodiment, the database tier 606 is behind a firewall, and the server-based based mid-tier 604 and the database tier 606 are connected via an encrypted pathway, thereby provided an added level of security.

### Interfaces Associated with the Plan Provider

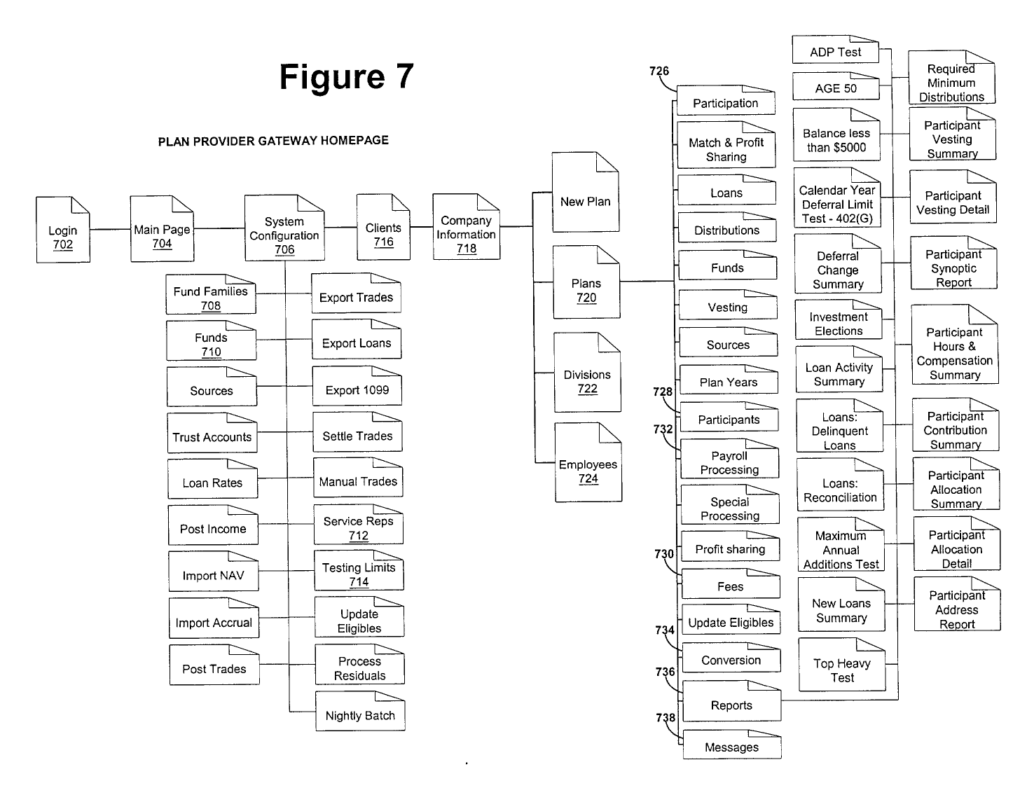

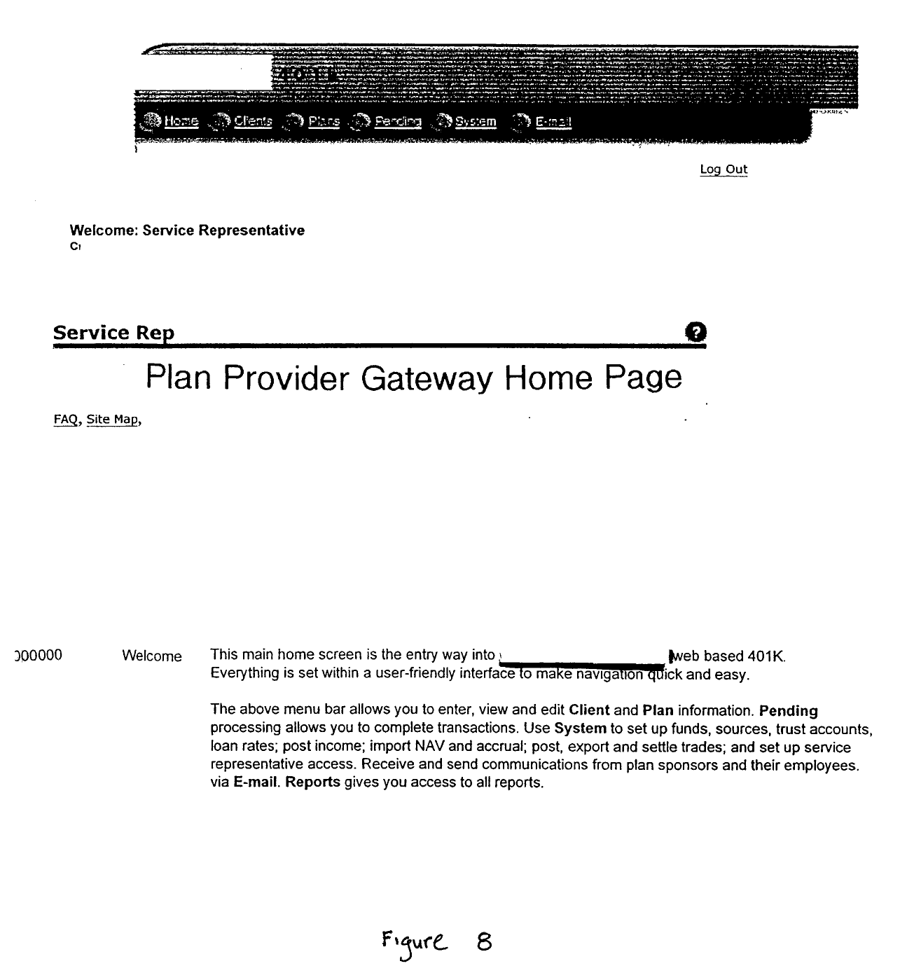

FIG. 7 illustrates the various interfaces associated with the plan provider interface. FIGS. 8-36 illustrate various screenshots of the interfaces outlined in FIG. 7. Plan provider representatives are able to log in (via login page 702) and, upon authentication, are able to access the main home page (704). FIG. 8 illustrates a screenshot of the plan provider's page. The main home screen provides for an entryway into the web-based 401(k) system that works in conjunction with the interfaces of the present invention. The main page (704) is a user-friendly interface that makes navigation quick and easy.

From the main page (704) shown in FIG. 8, plan providers are able to enter, view, and edit client and plan information. Additionally, the main page (704) allows plan providers to complete transactions and set up service representative access. Additionally, they are able to receive and send communications from plan sponsors and their employees via e-mail. The plan provider representatives are also able to access various reports.

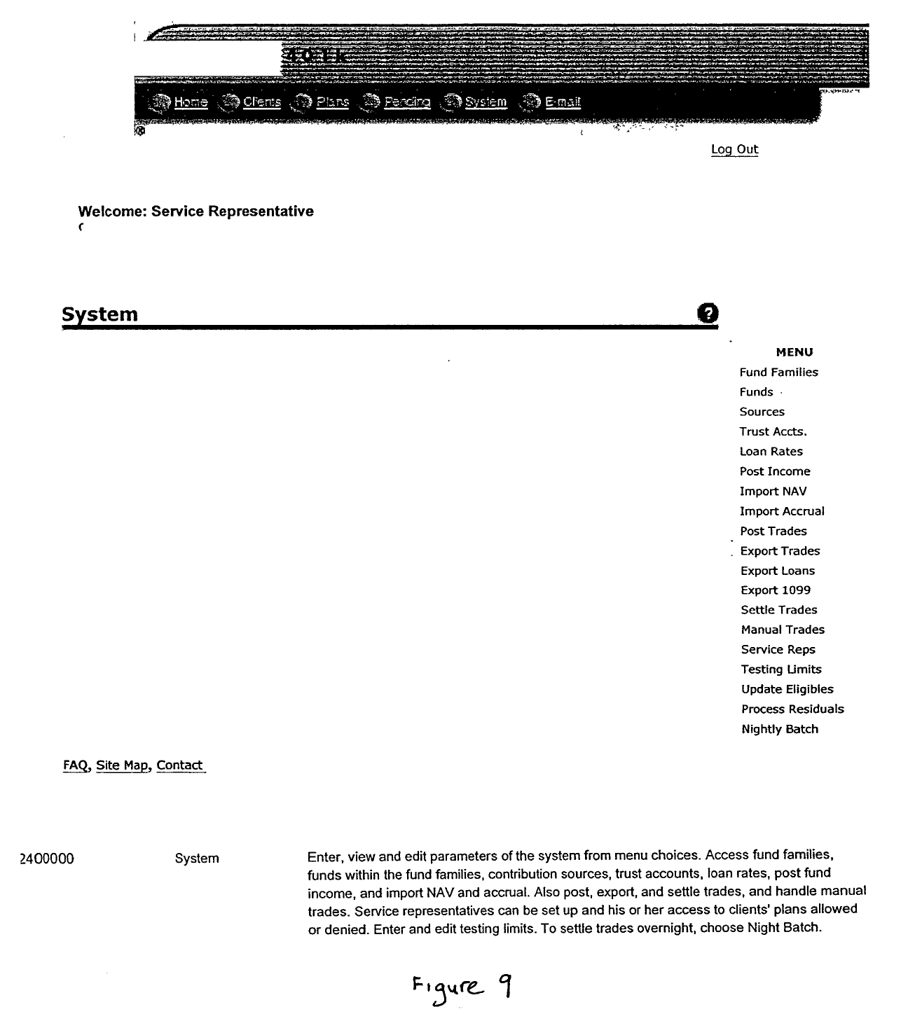

Furthermore, plan provider representatives are able to tweak various system configuration functions via the system configuration page (706). FIG. 9 illustrates a screenshot of the system configuration page (706). Plan provider representatives are able to enter, view, and edit parameters of the system from menu choices; access fund families (708) and funds (710), contributions sources, trust accounts, and loan rates; post fund income; and import NAV and accrual. Representatives are also able to post, export, and settle trades, and also handle manual trades. Service representatives can be set up (712) along with defining their access to clients' plans. Lastly, representatives are able to enter and edit testing limits (714), settle trades overnight, and choose night batch.

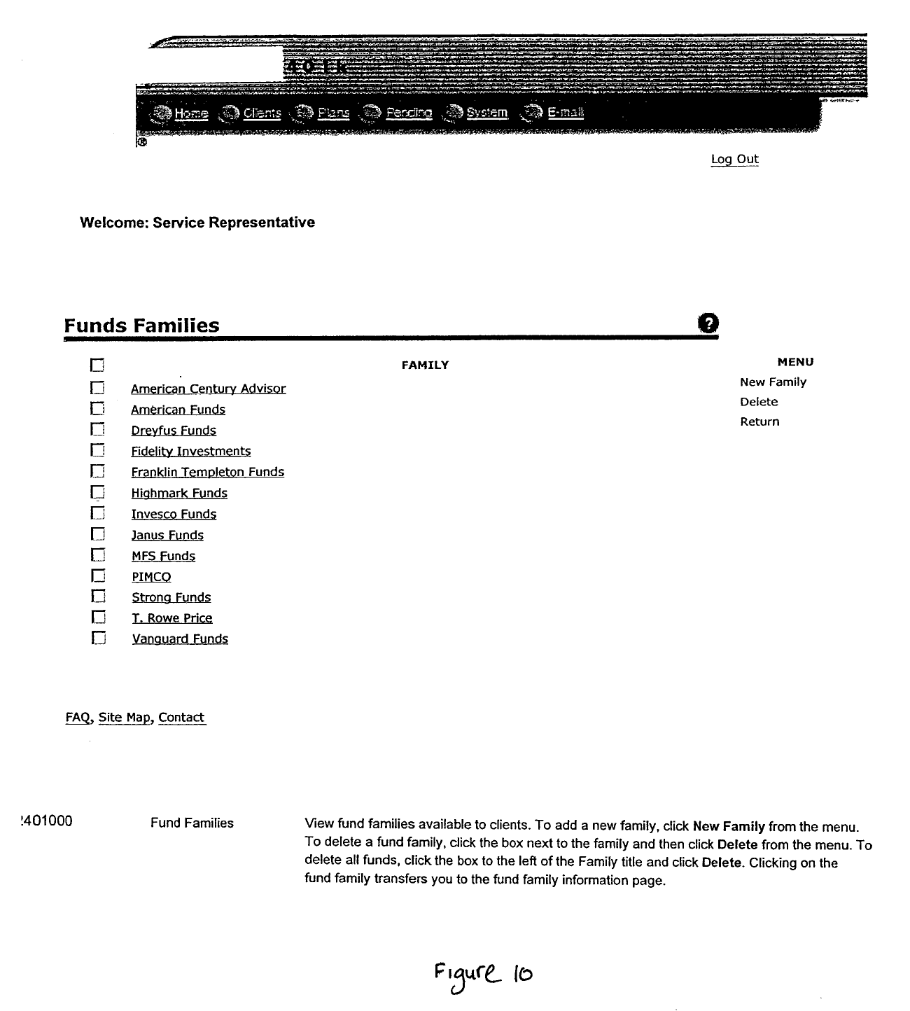

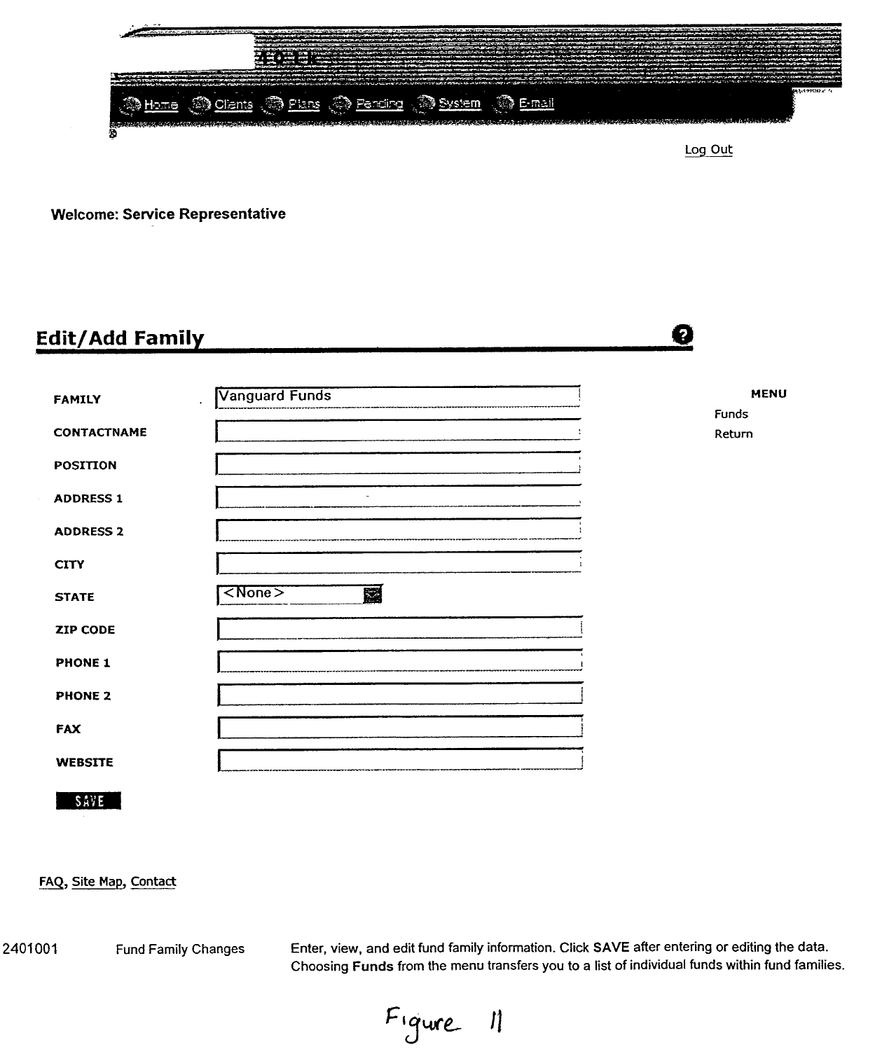

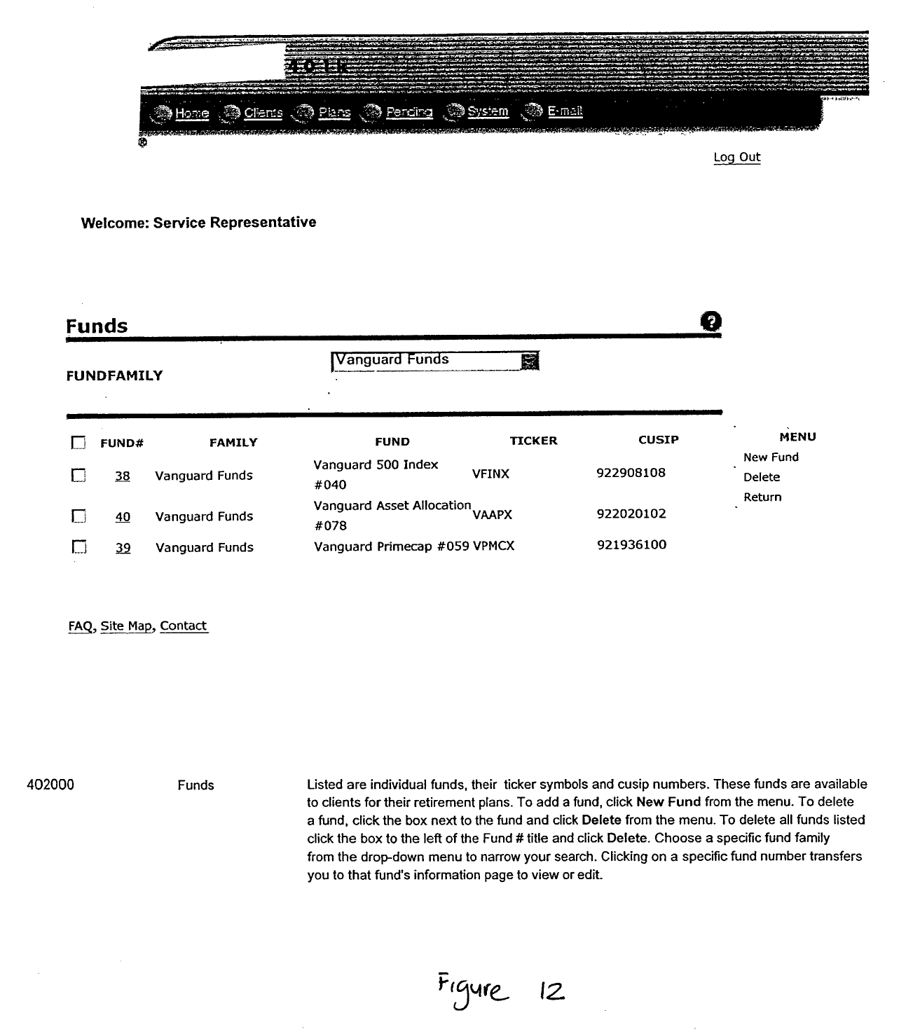

FIG. 10 illustrates a screenshot of the fund families access interface (708) of FIG. 7. This interface (708) allows representatives to view fund families available to clients. Using this to interface, representatives are able to add or delete a fund family (or all funds). FIG. 11 illustrates the specific interface used by representatives to enter, view, and edit fund family information. From the interface shown in FIG. 11, representatives are able to be transferred to the “Funds” interface, a screenshot of which is provided in FIG. 12. The funds interface (710) lists individual funds, their ticker symbols, and the cusip numbers wherein these funds are available for clients for their retirement plans. Representatives are able to add a new fund, delete an existing fund or all funds, or choose a specific fund family via a drop-down menu. It should be noted that clicking on a specific fund number transfers the representative to the specific fund's information page for viewing or editing.

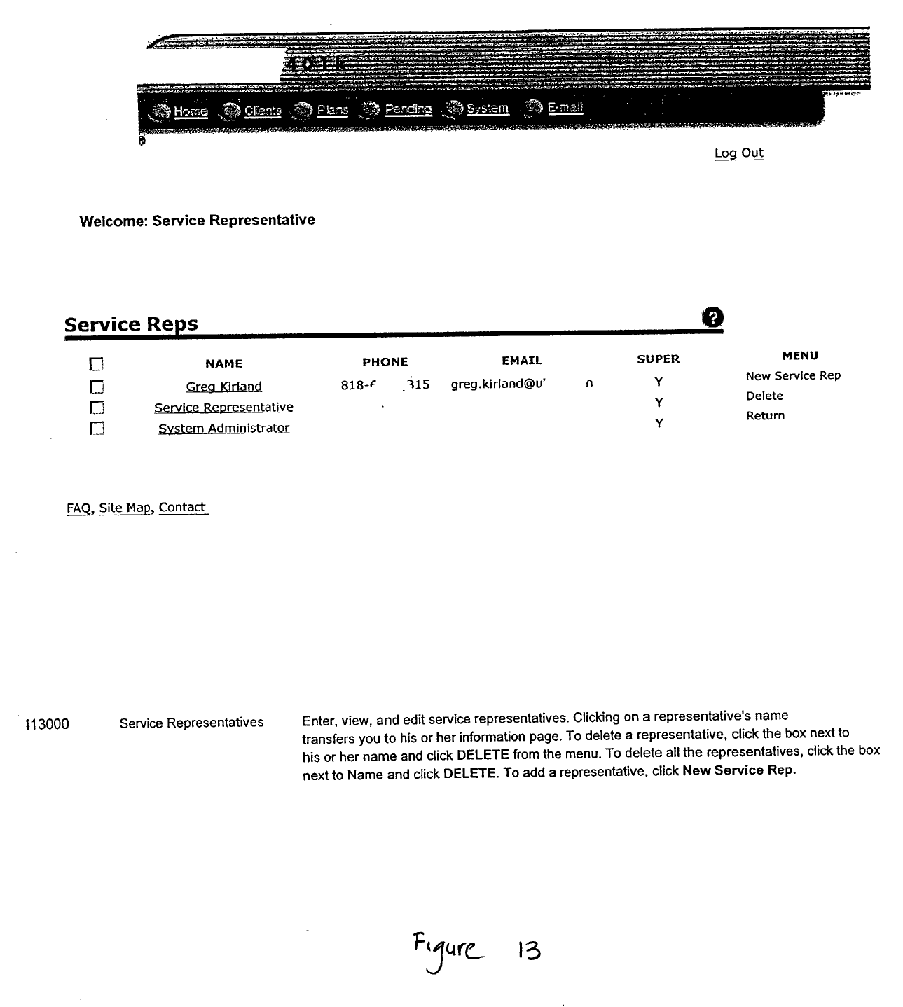

FIG. 13 illustrates a screenshot of the interface for adding or deleting service representatives (712). Using this interface, representatives are able to enter, view, or edit service representatives. Clicking on a representative's name transfers one to his or her information page.

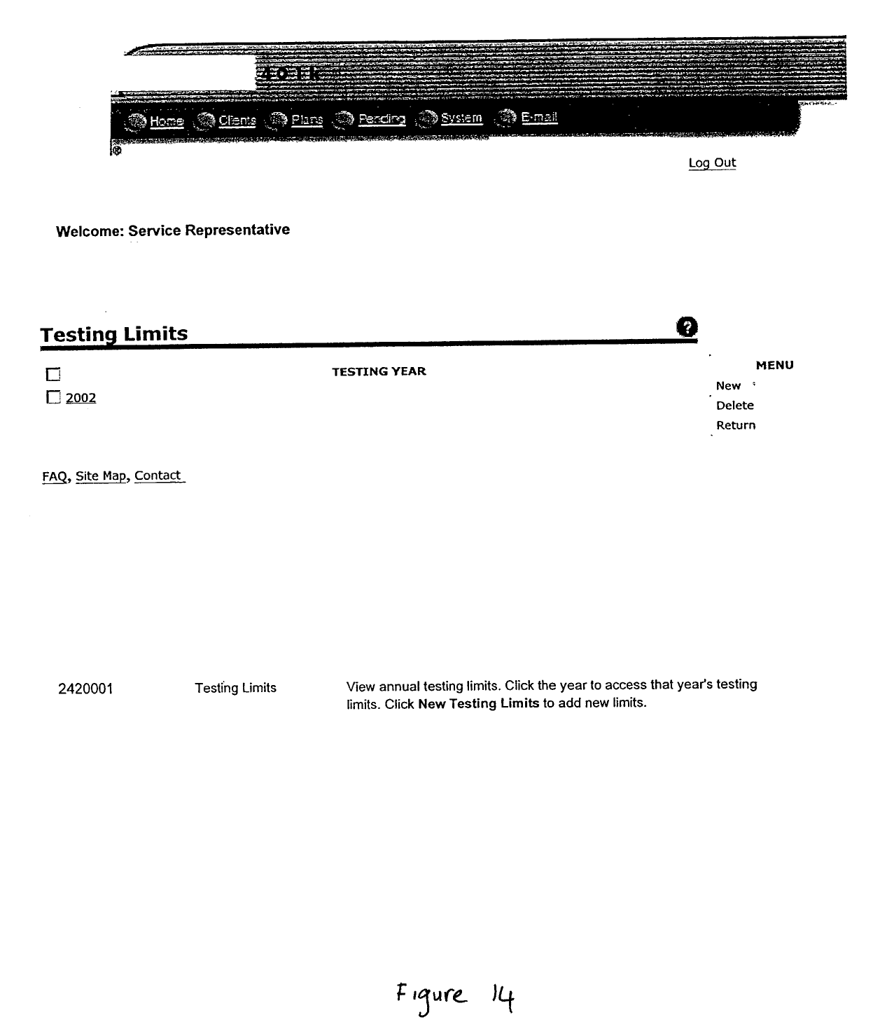

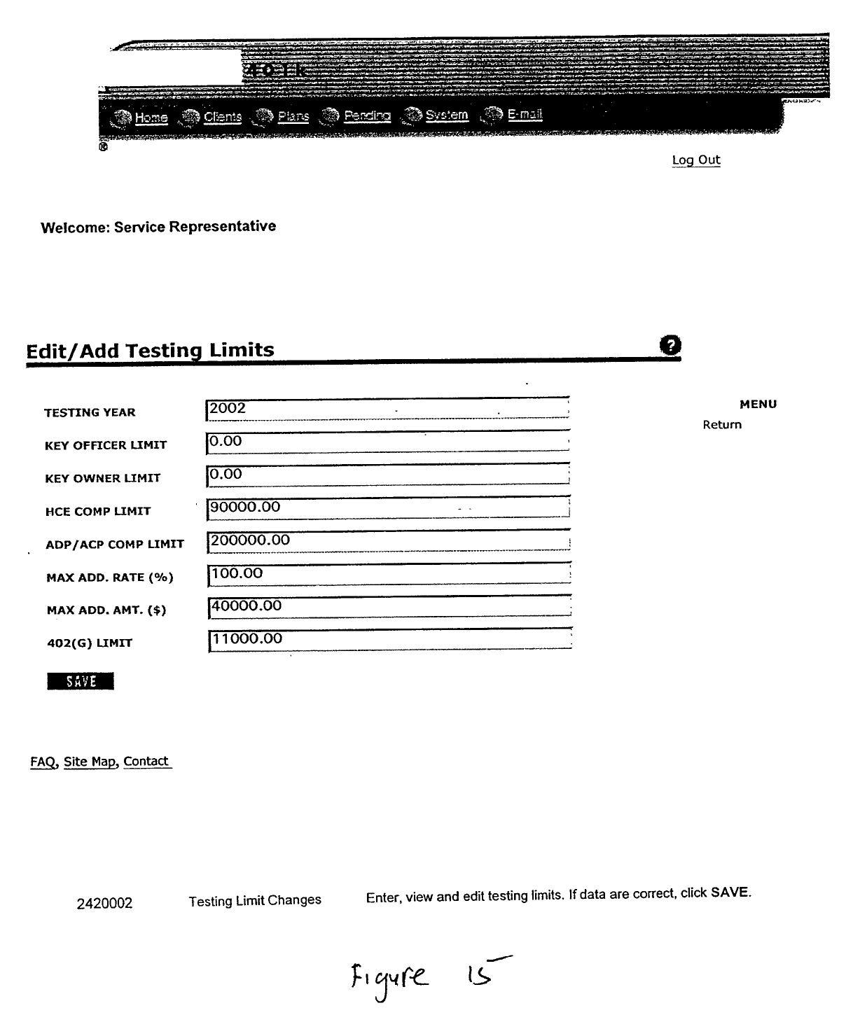

FIG. 14 illustrates a screenshot of the testing limits interface (714). Using this interface, representatives are able to view annual testing limits. Representatives click the year to access that year's testing limits. FIG. 15, on the other hand, illustrates the interface used for editing/adding testing limits.

Returning to the description of FIG. 7, the plan provider gateway homepage provides representatives with pathways to information regarding clients (716) and specific company information (718). The company information interface (718) allows representatives to create new plans or edit existing plans (720), divisions (722), and employee information (724). The interface to edit existing plans (720) allows for representatives to access/manipulate the following interfaces: participation (726), match and profit sharing, loans, distributions, funds, vesting, sources, plan years, participants (728), payroll processing (732), special processing, profit sharing, fees (730), update eligibles, conversion (734), reports (736), and messages (738). The reports interface (736) provides representatives with the following reports: ADP test, age 50, balance less than $5,000, calendar year deferral limit test—402(G), deferral change summary, investment elections, loan activity summary, delinquent loans, loans-reconciliation, maximum annual additions test, new loans summary, top-heavy test, required minimum distributions, participant vesting summary, participant vesting detail, participant synoptic report, participant contribution summary, participant allocation summary, participant allocation detail, and participant address report.

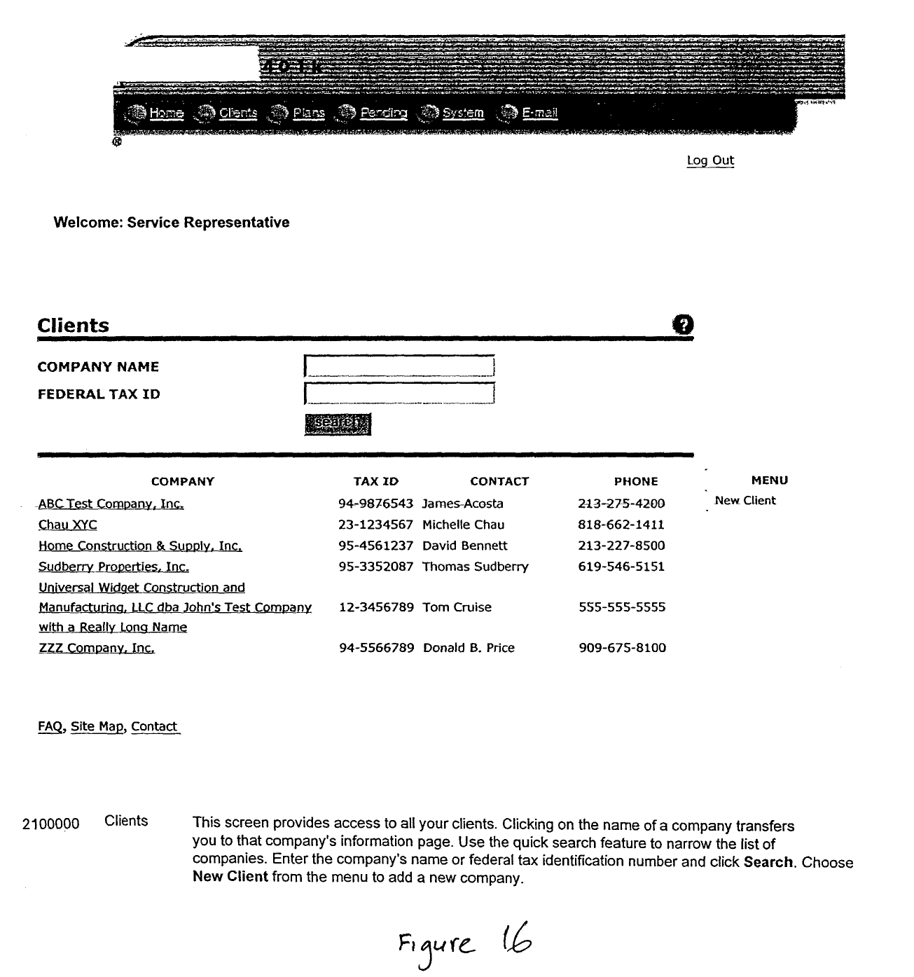

FIG. 16 illustrates the clients interface (716) that allows plan provider representatives to access all their clients. Clicking on the name of a particular company transfers the user to that company's information page. Additionally, the quick search feature (e.g., searching by entering a company name or federal tax ID) can be used to narrow the list of displayed companies.

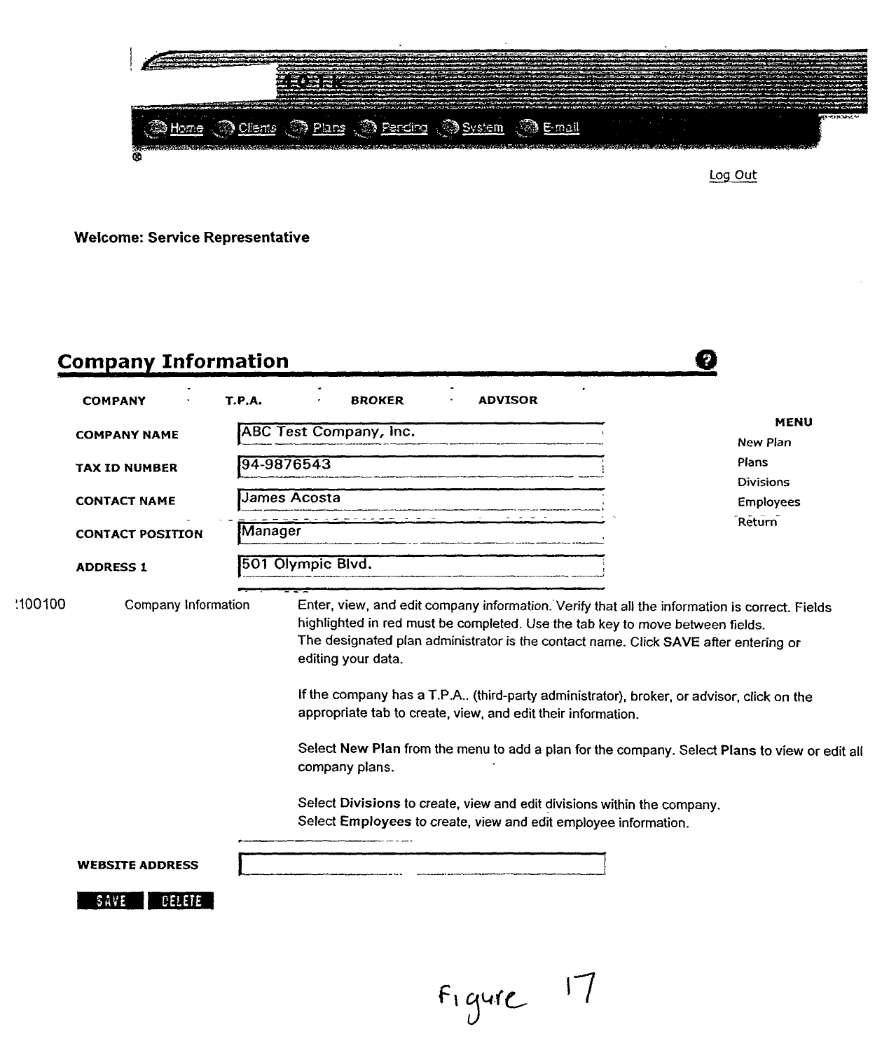

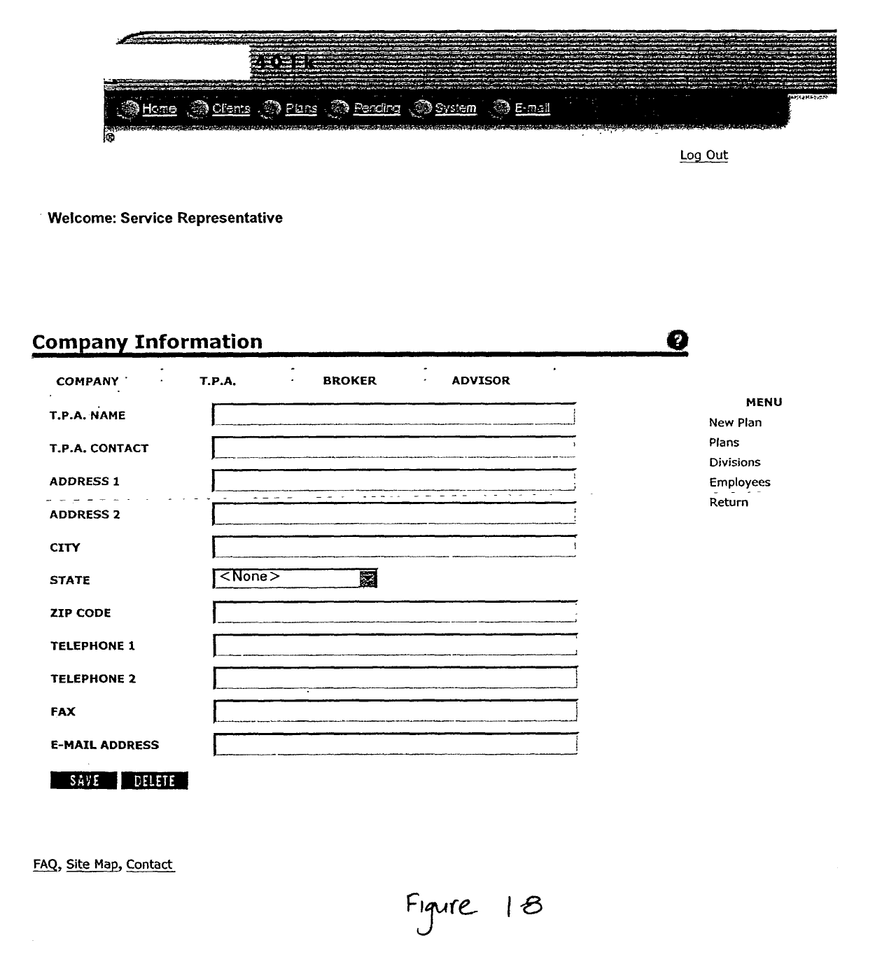

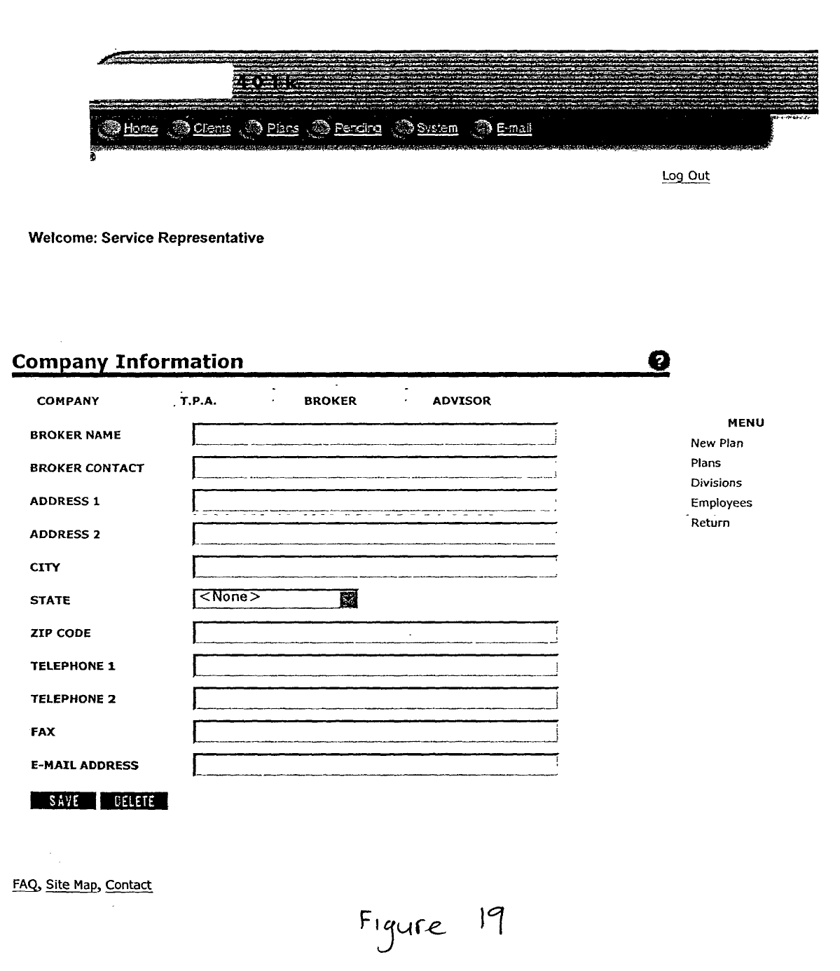

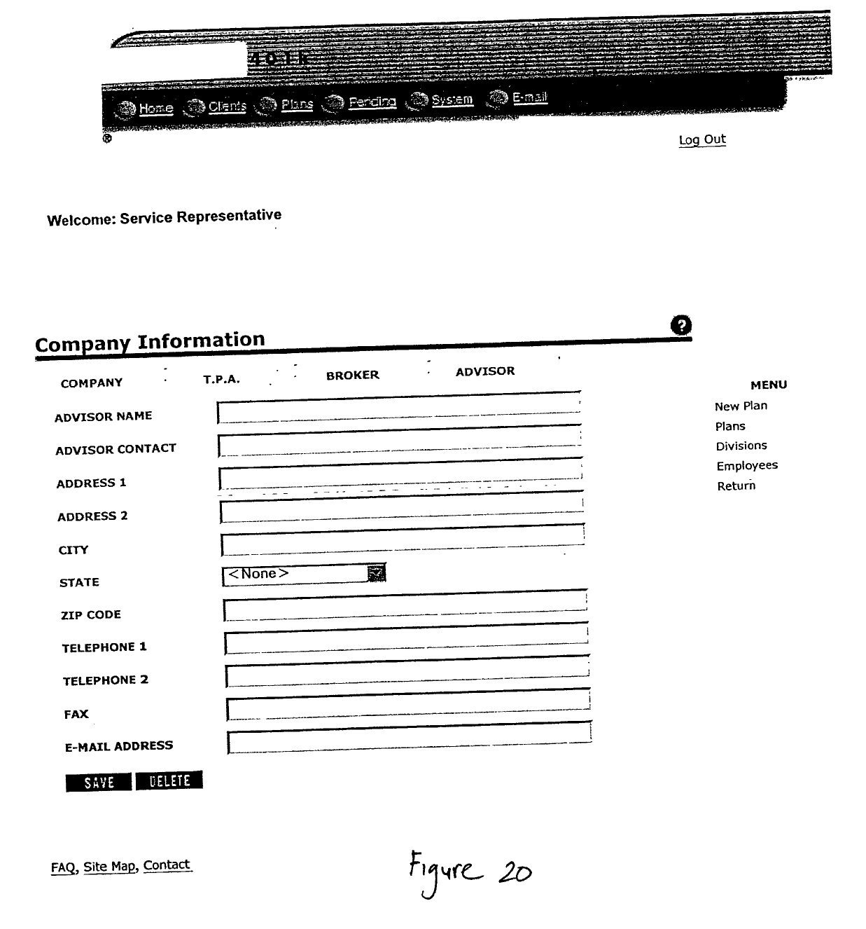

FIGS. 17-20 provide for screenshots showing the variations of the company information interface (718). FIG. 17 allows provider representatives to enter, view, and edit company information and verify the information is correct. If the company has a third-party administrator (TPA), broker, or advisor, provider representatives can view that information via specific interfaces. FIG. 18 illustrates a screenshot showing specific information about a TPA. FIG. 19 illustrates a screenshot showing specific information about a broker. FIG. 20 illustrates a screenshot showing specific information about an advisor.

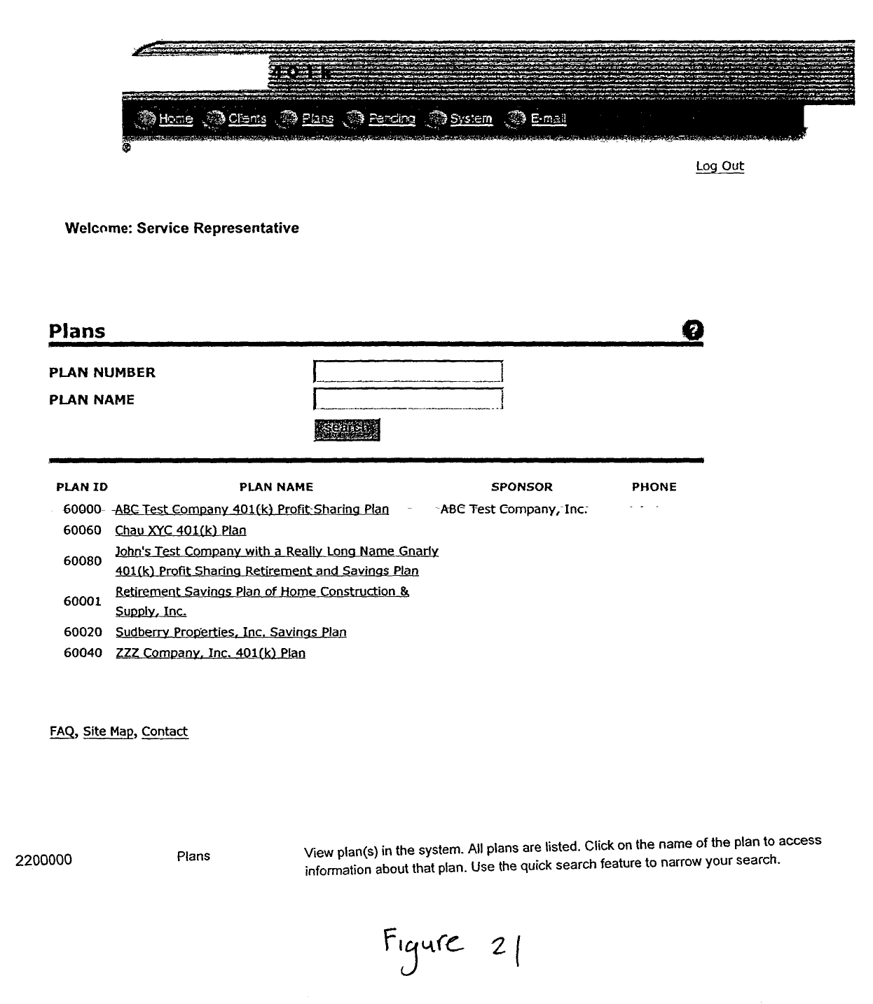

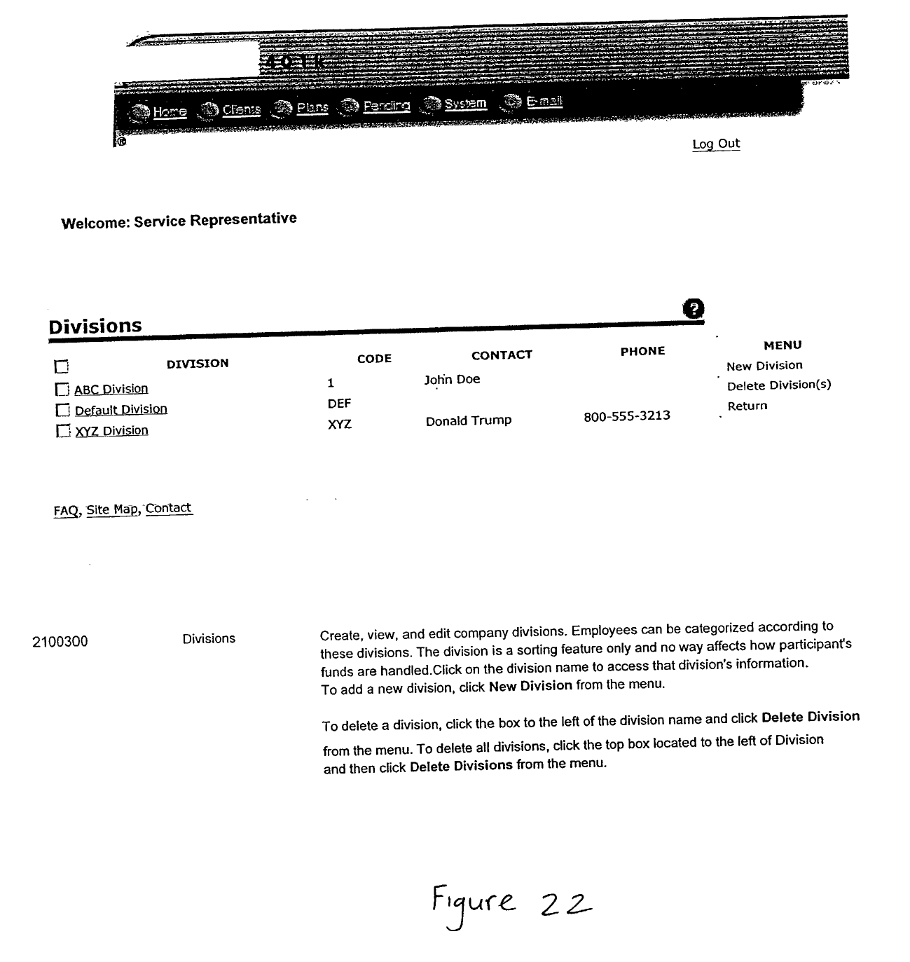

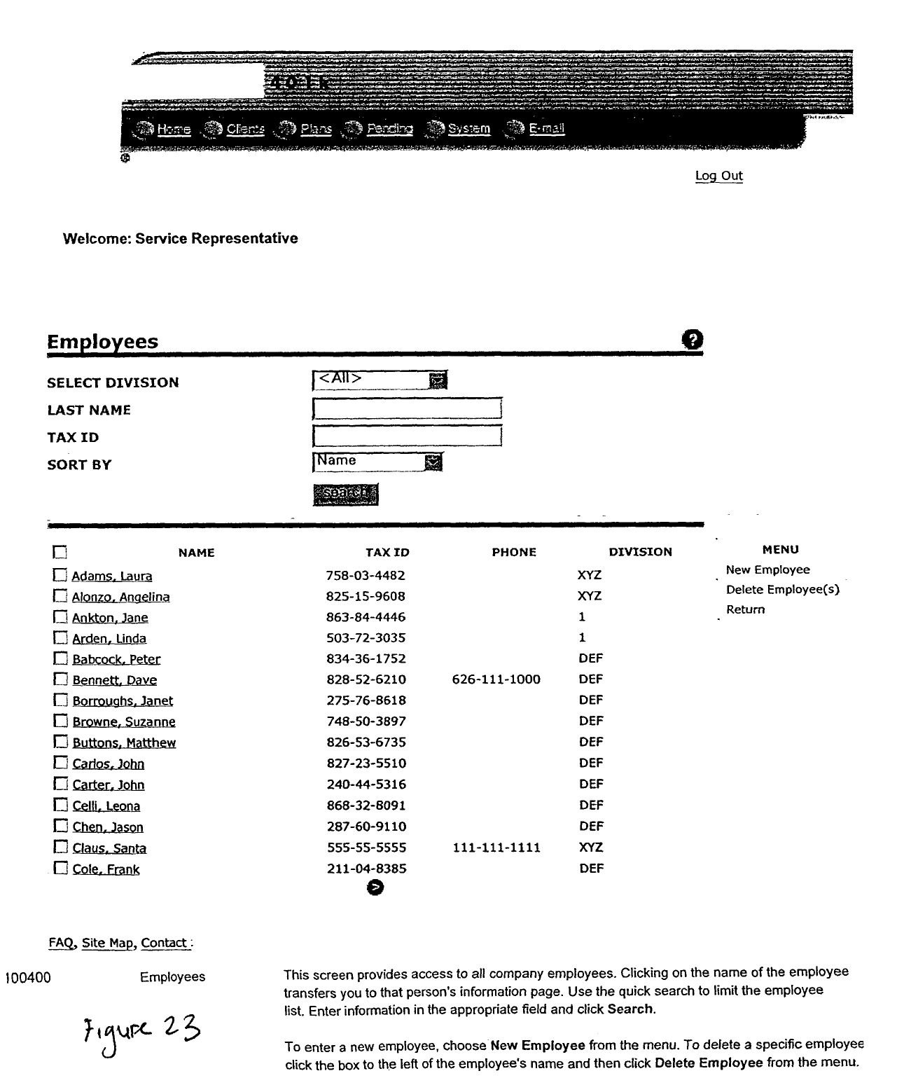

FIG. 21 illustrates a screenshot showing the plans interface (720). The plans interface lists all plans so that a provider representative can click on a particular plan to access more information. FIG. 22 illustrates a screenshot showing the divisions interface (722). The divisions interface (722) allows representatives to create, view, or edit company divisions. The divisions are a sorting feature and are not intended to affect how a participant's funds are handled. FIG. 23 illustrates a screenshot of the employees interface (724). This screen provides access to all company employees, wherein clicking on a particular employee's name sends the representative to an information page associated with that particular employee.

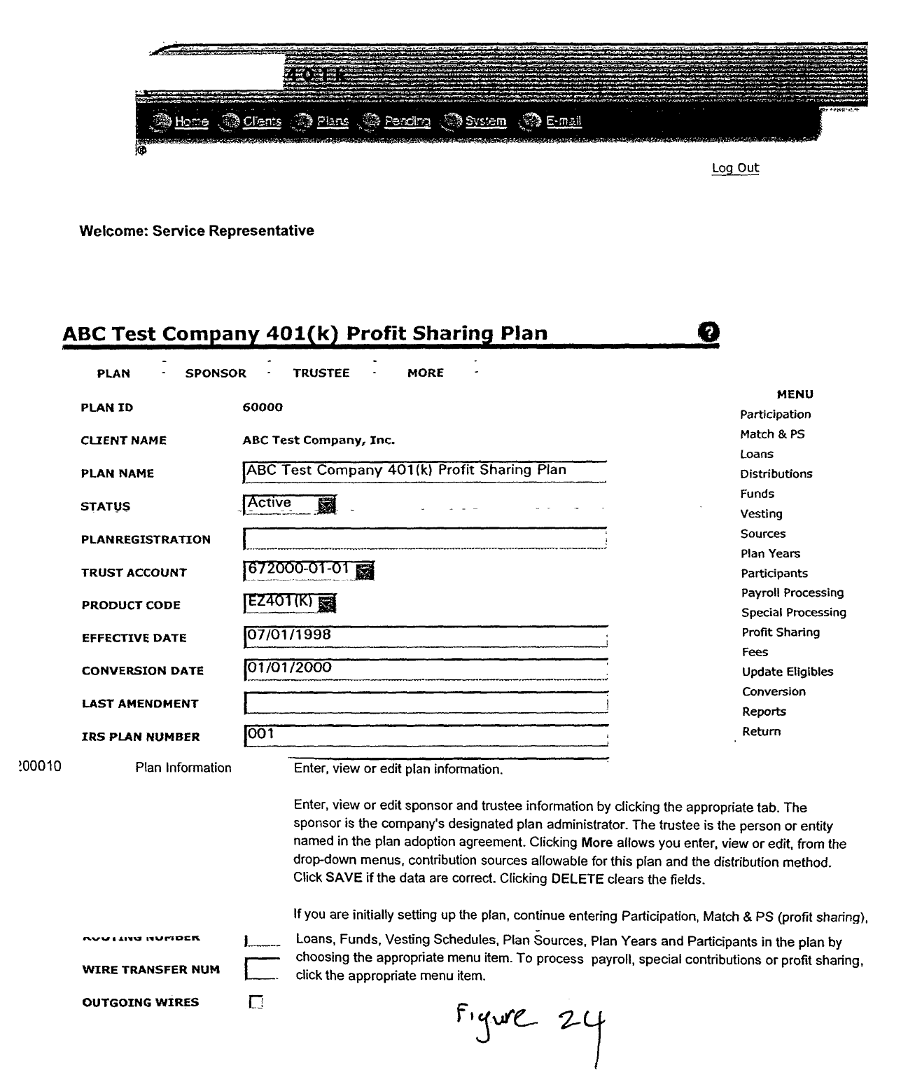

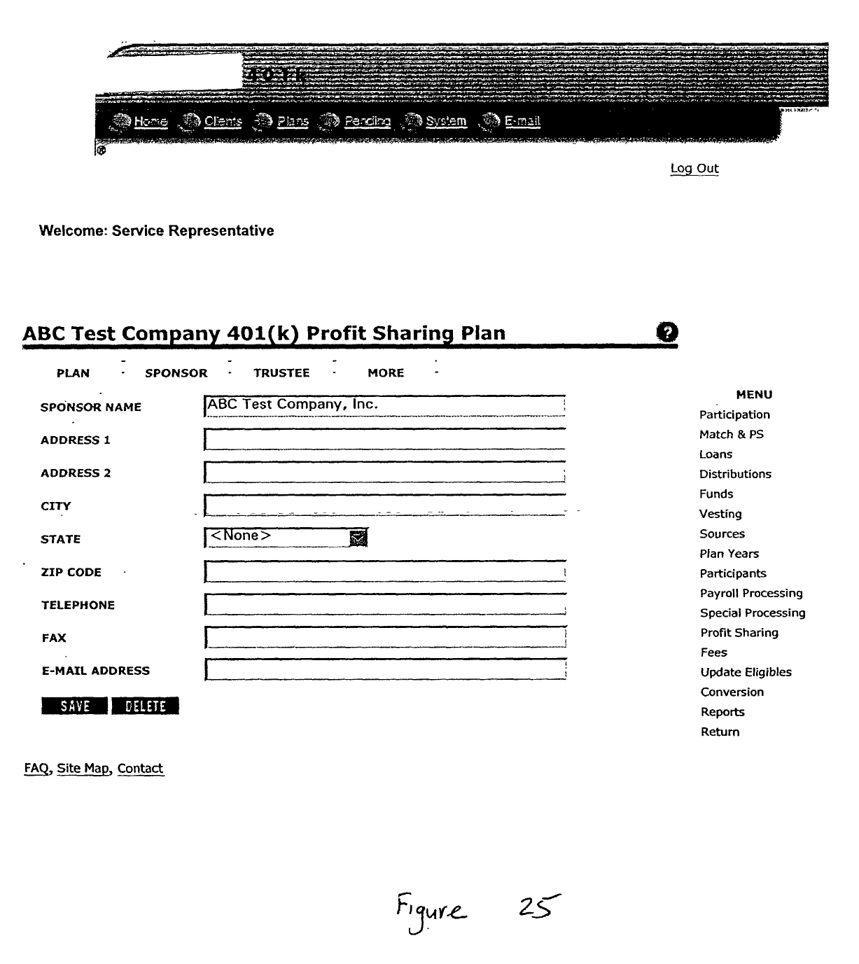

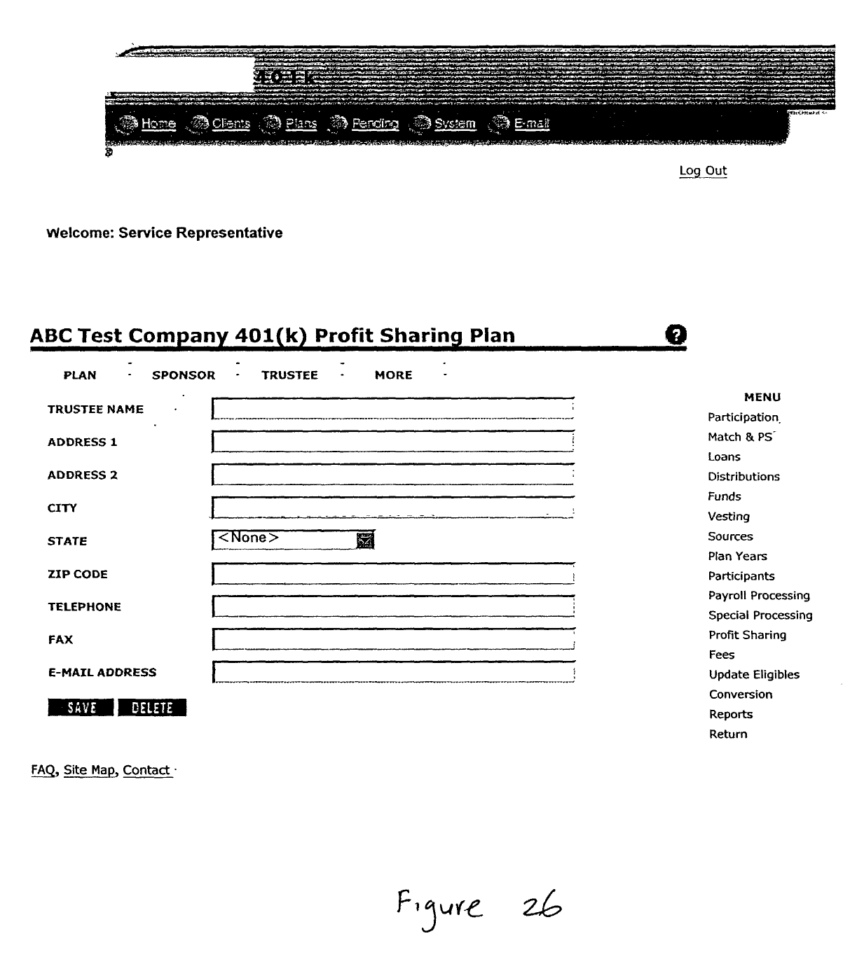

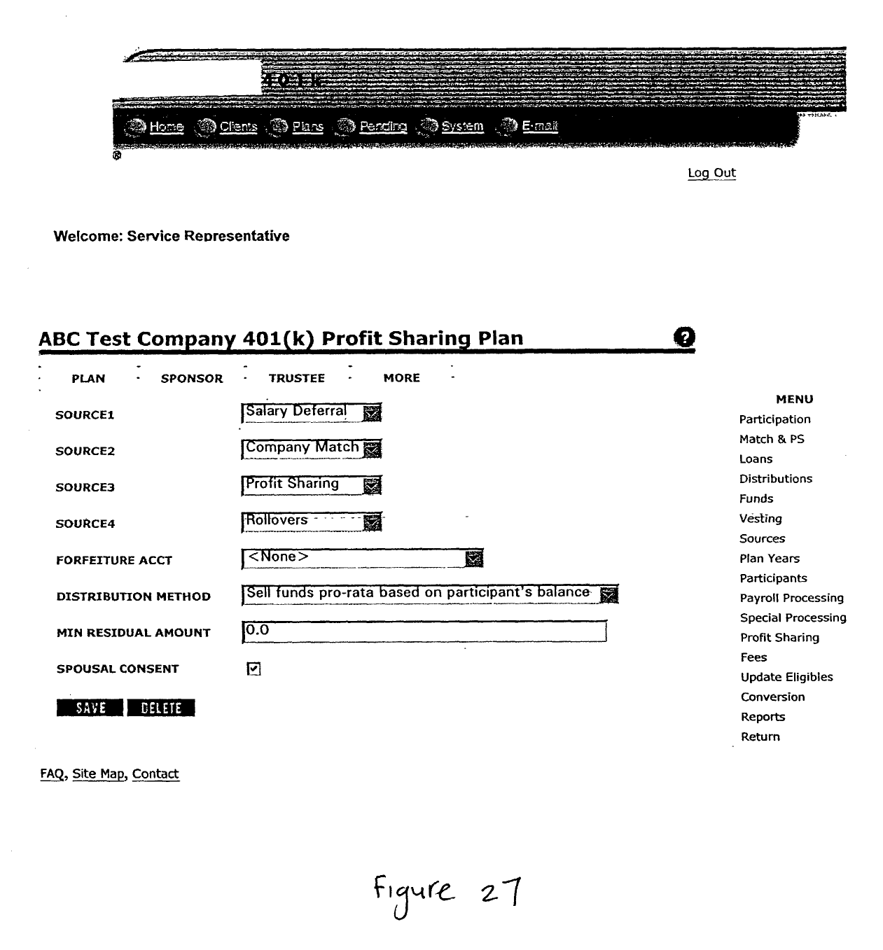

FIGS. 24-27 illustrate screenshots of displayed company plan information (720) based upon plan (FIG. 24), sponsor (FIG. 25), trustee (FIG. 26), and source (FIG. 27) information. Using these interfaces, representatives are able to enter, edit, or view sponsor and trustee information.

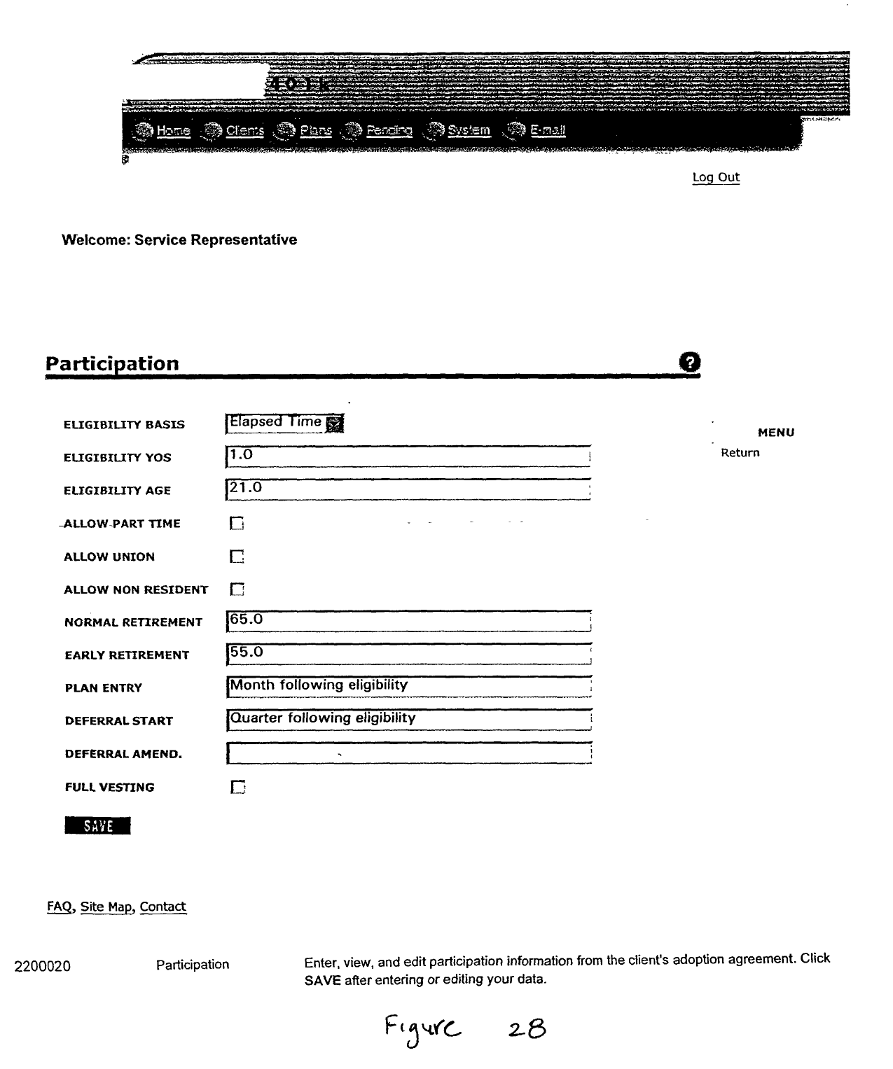

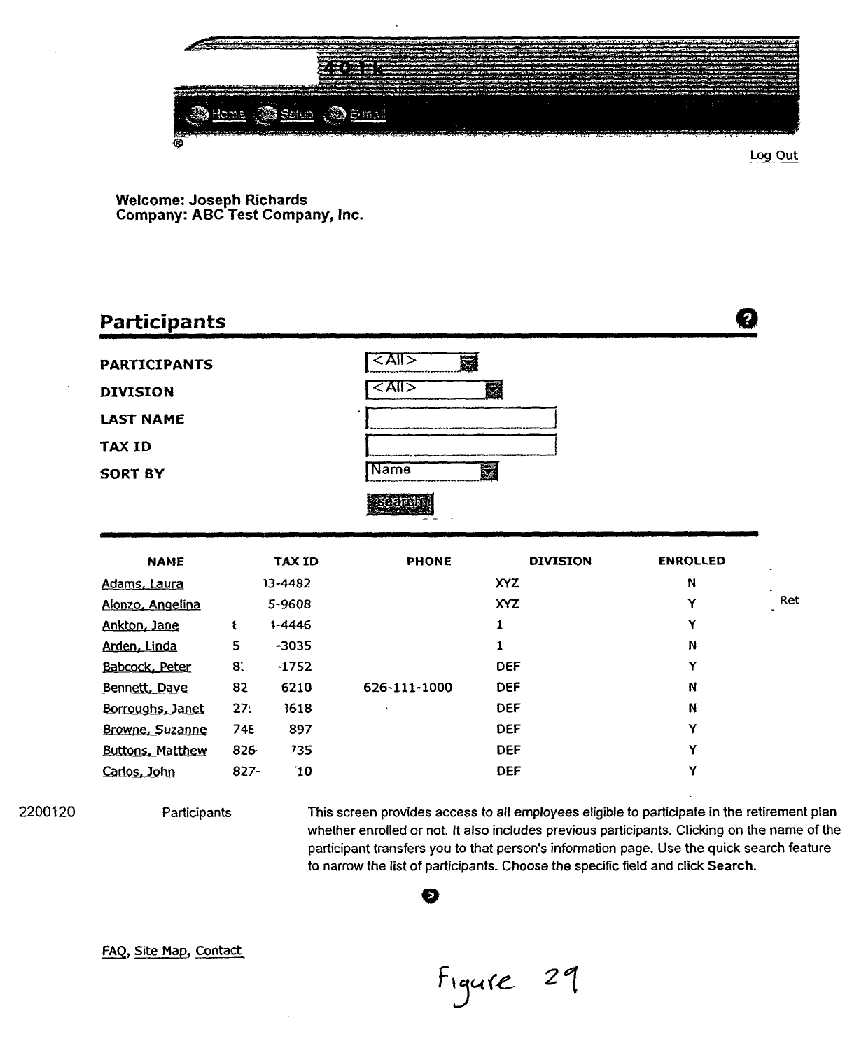

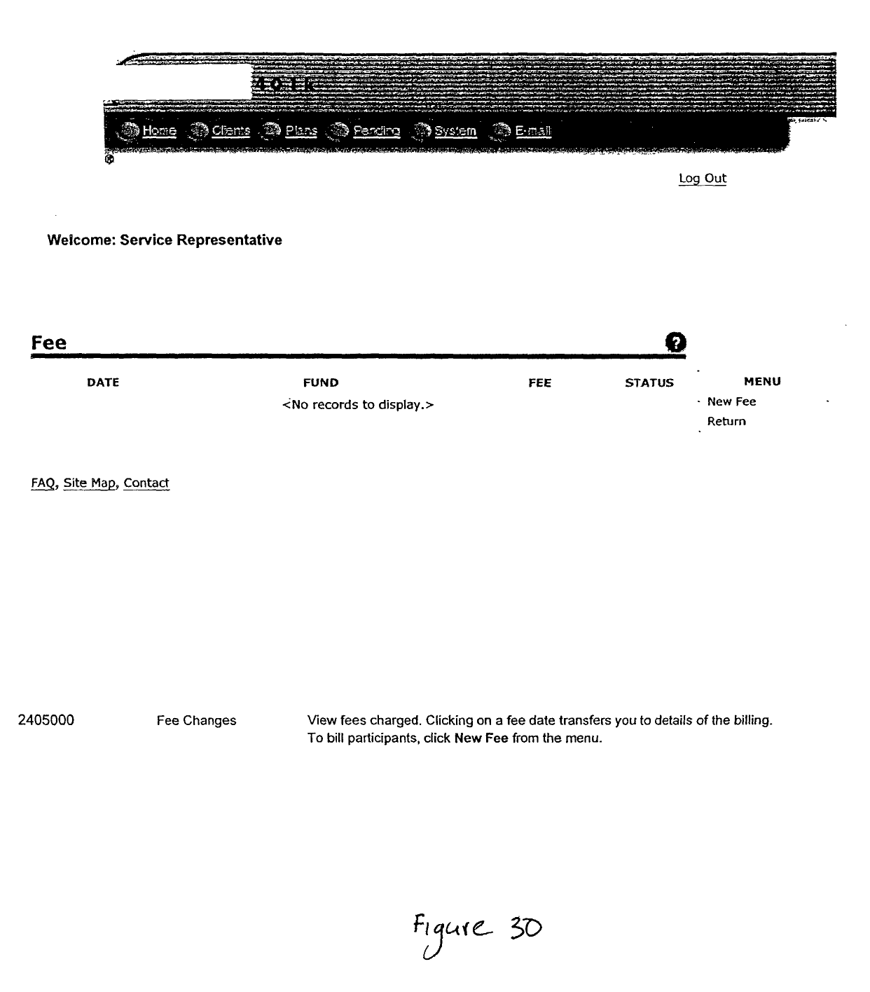

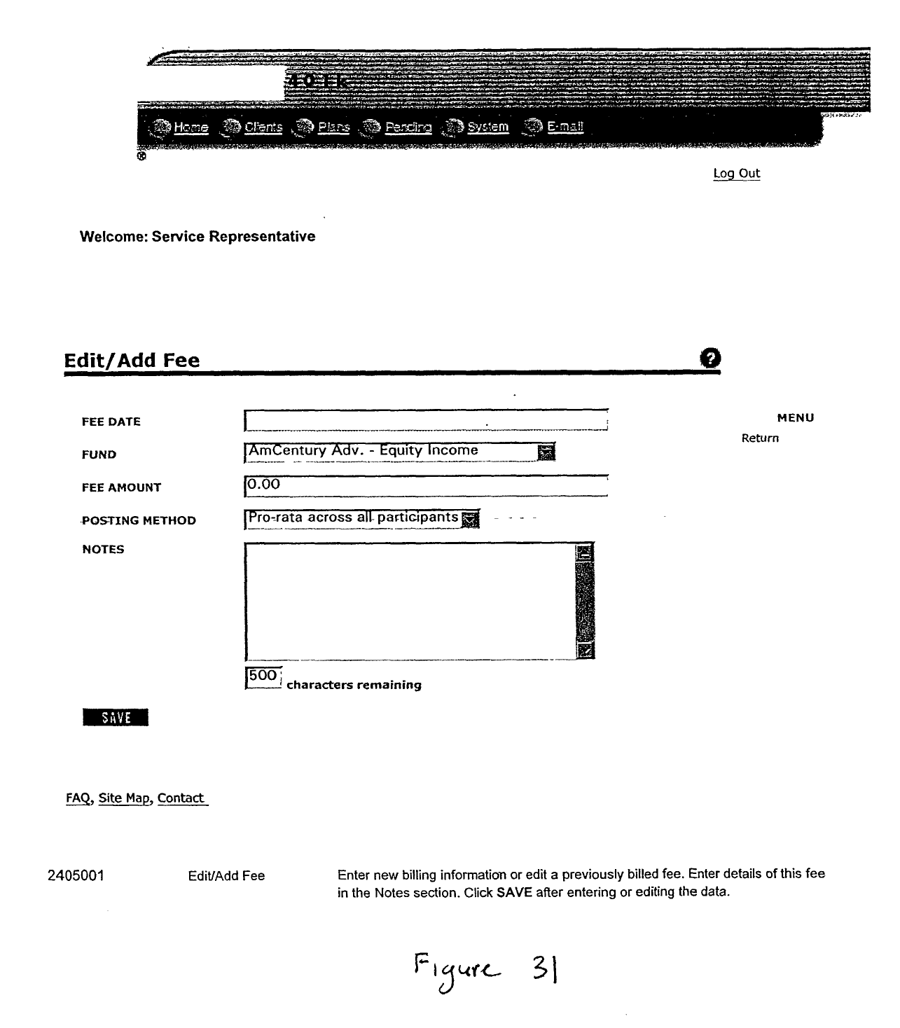

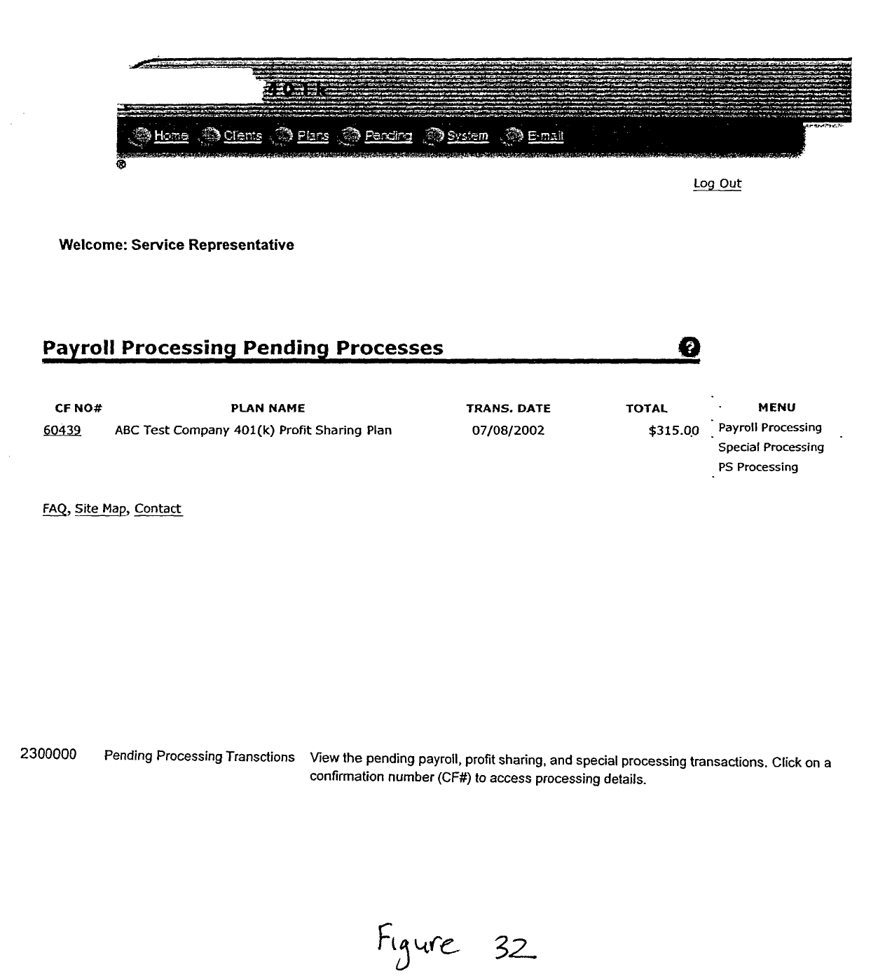

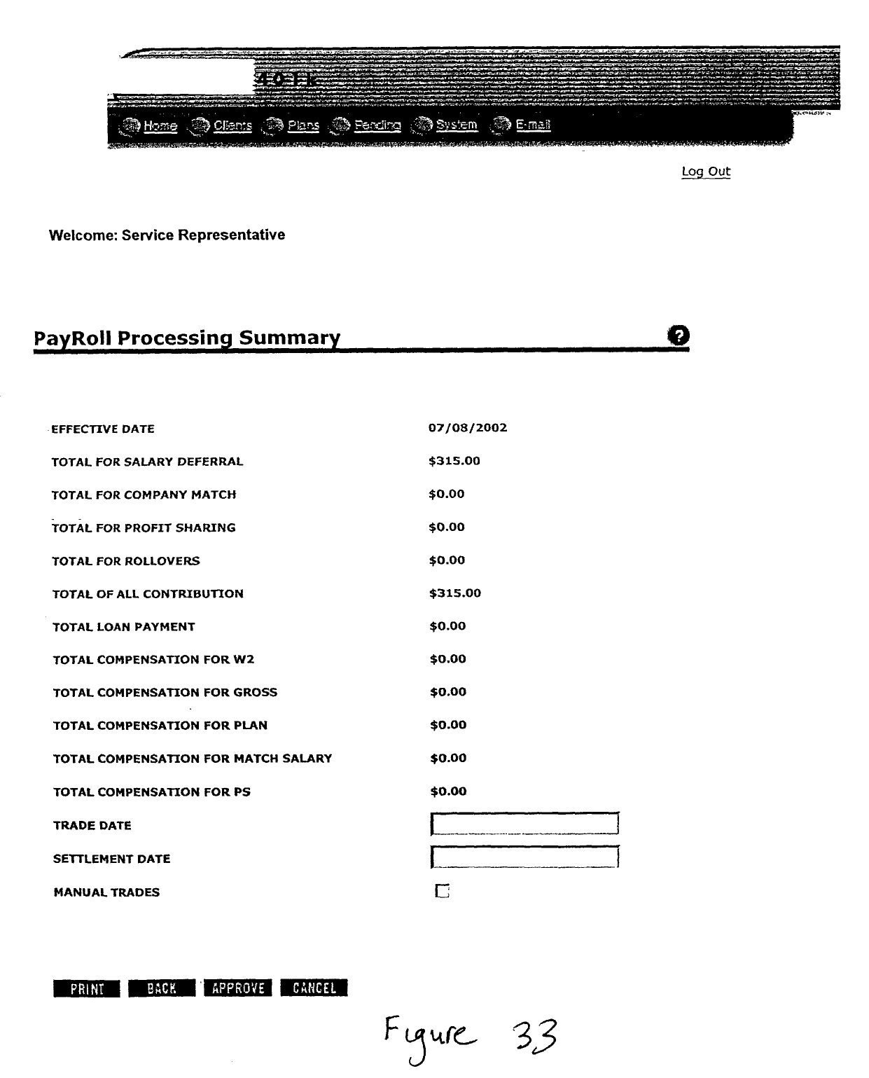

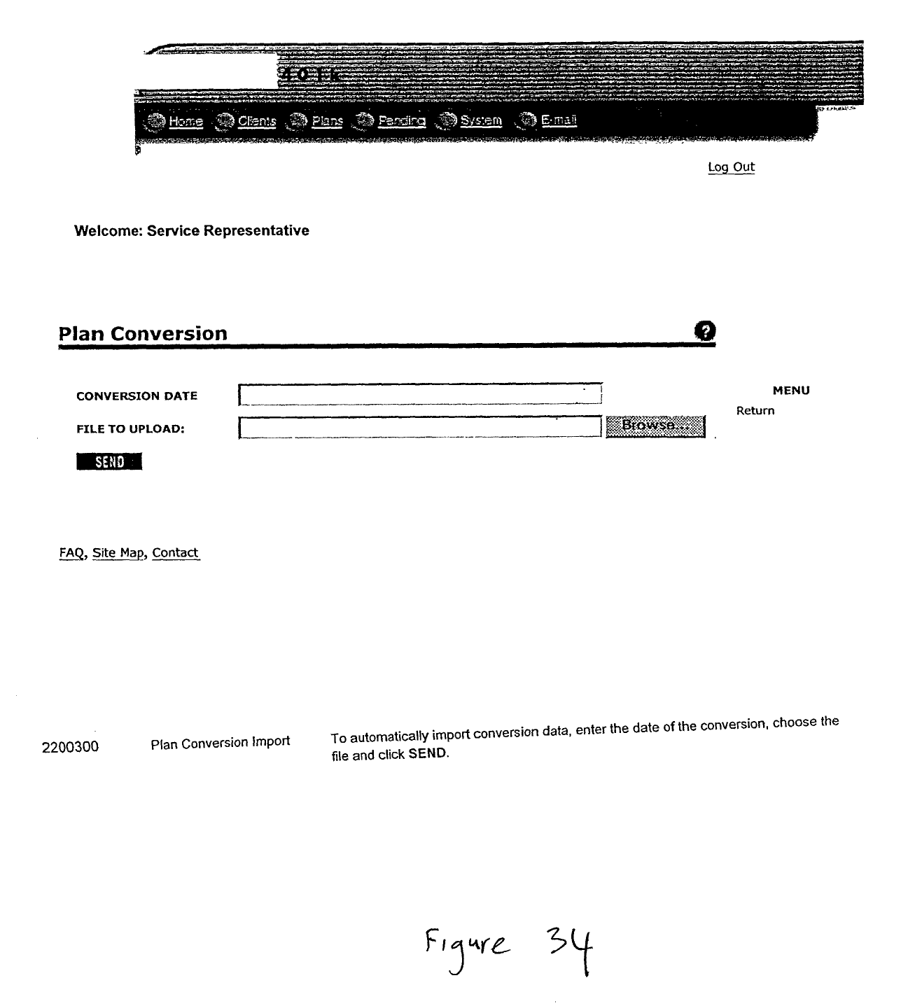

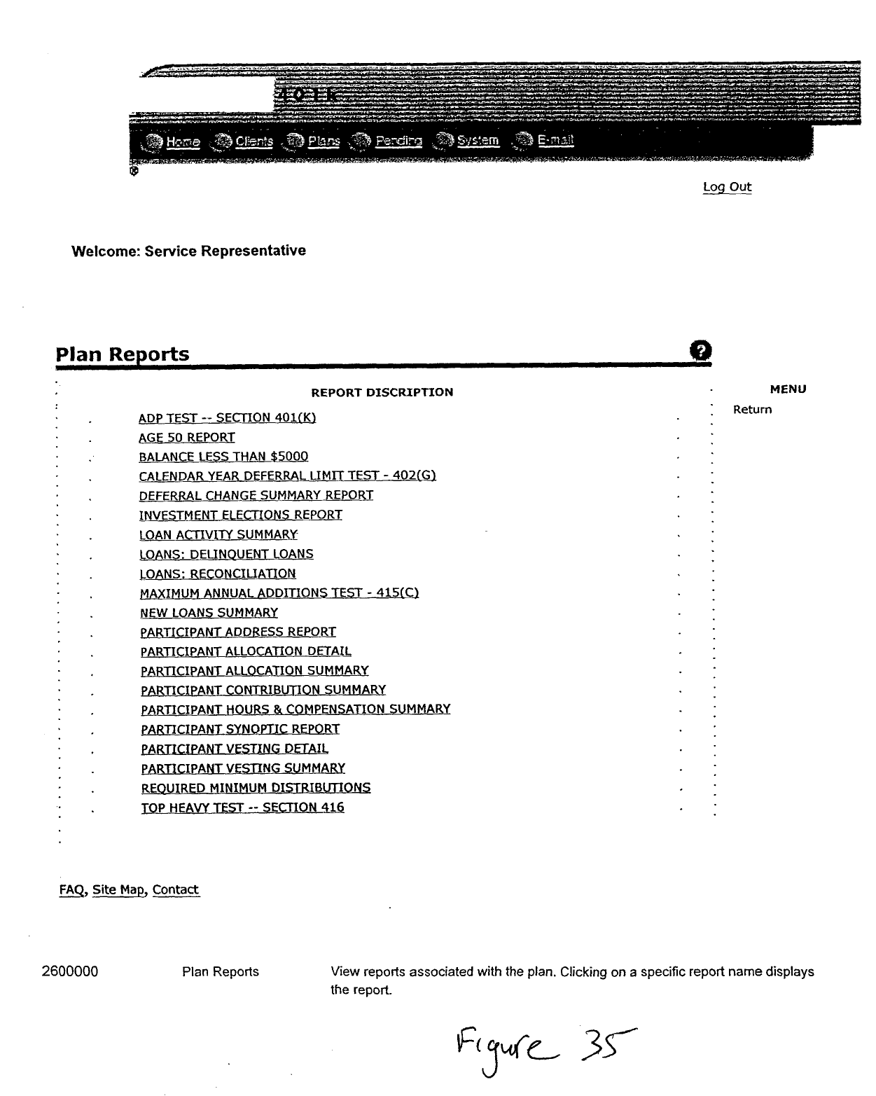

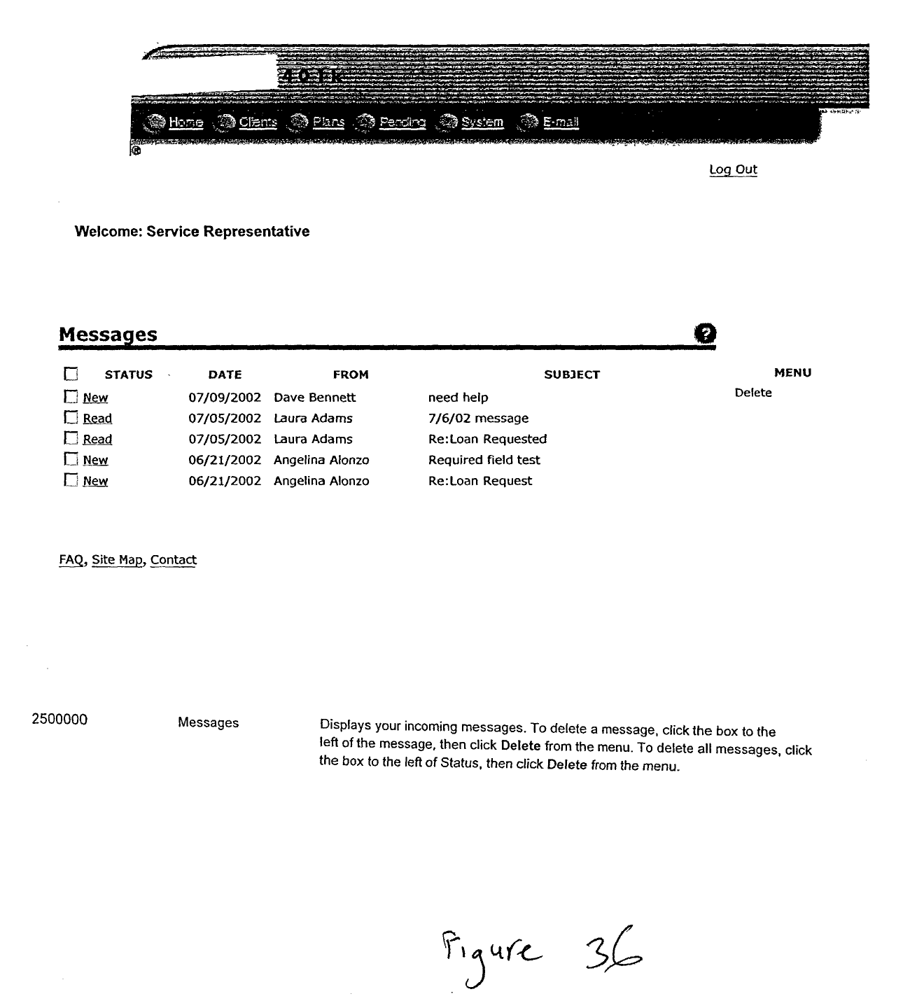

FIG. 28 illustrates a screenshot of the participation interface (726) with which representatives are able to edit, view, or edit participation information from the client's adoption agreement. FIG. 29 illustrates a screenshot of the participants interface (728). This interface provides access to all employees eligible to participate in the retirement plan whether enrolled or not. It also includes previous participants. FIGS. 30 and 31 illustrate screenshots of the fee interface (730) that allows representatives to view fees charged and edit/add fees. FIGS. 32 and 33 illustrate screenshots of the payroll processing interface (732), which allows representatives to view pending payroll, profit sharing, special processing transactions, and the payroll summary. FIG. 34 illustrates a screenshot of the plan conversion interface (734), which allows representatives to automatically import conversion data. FIG. 35 illustrates a screenshot of the plan reports interface (736), which allows representatives to view various reports. FIG. 36 illustrates a screenshot of the messages interfaces (738), which display all incoming messages.

### Interfaces Associated with the Plan Sponsor

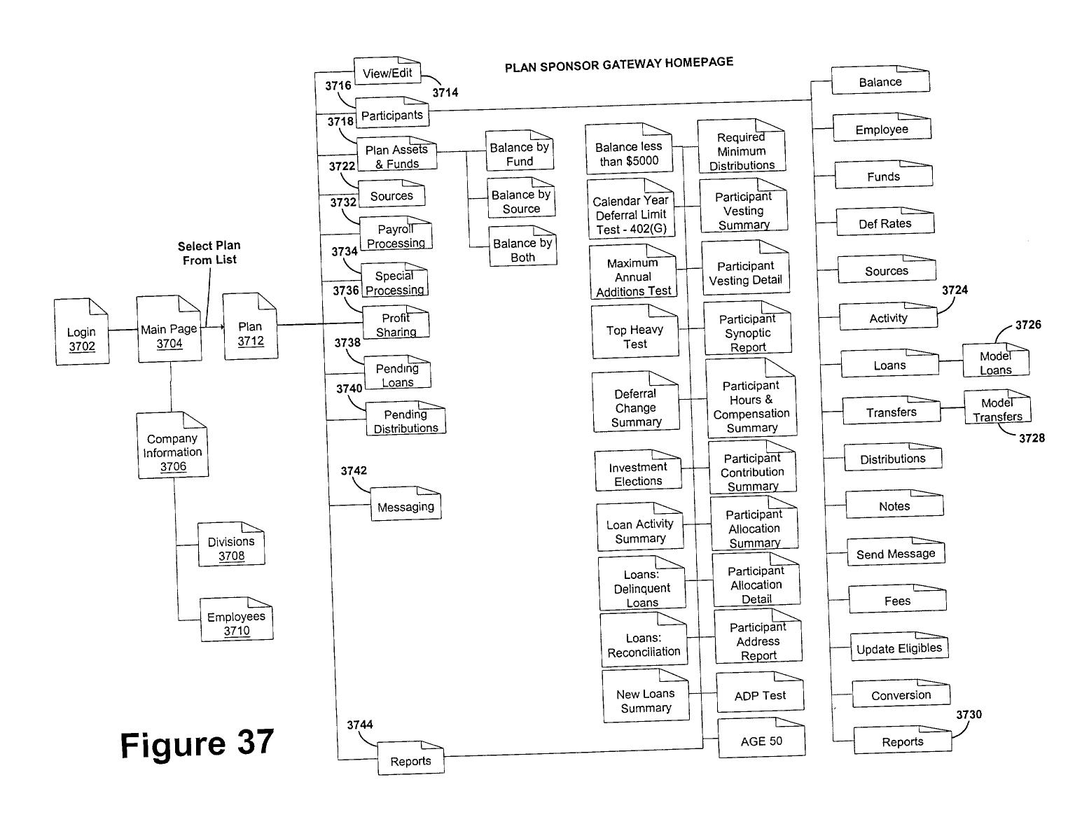

FIG. 37 illustrates the various interfaces associated with the plan sponsor interface. Plan sponsor representatives log in using a login interface (3702) and are directed to the main plan sponsor home page interface (3704). From the main page, representatives are able to view company information via the company information interface (3706) and view plan information via the plan information interface (3708). Representatives are able to navigate from the company information interface to the divisions interface (3708) and the employees interface (3710).

Additionally, representatives are able to navigate from the plan interface (3712) to any of the following interfaces: view/edit interface (3714), participants interface (3716), plan assets and funds interface (3718), sources interface (3722), payroll processing interface (3732), special processing interface (3724), profit sharing interface (3736), pending loans interface (3738), pending distributions interface (3740), messaging interface (3742), and reports interface (3744). The participant interface, in turn, can be used to navigate to any one of the following interfaces: balance interface, employee interface, funds interface, deferral rates interface, sources interface, activity interface (3724), loans interface (which can be navigated to model loans via the model loans interface (3726)), transfers interface (which can be navigated to model transfers via the model transfers interface (3728)), distributions interface, notes interface, send message interface, fees interface, update eligibles interface, conversion interface, and reports interface (3730).

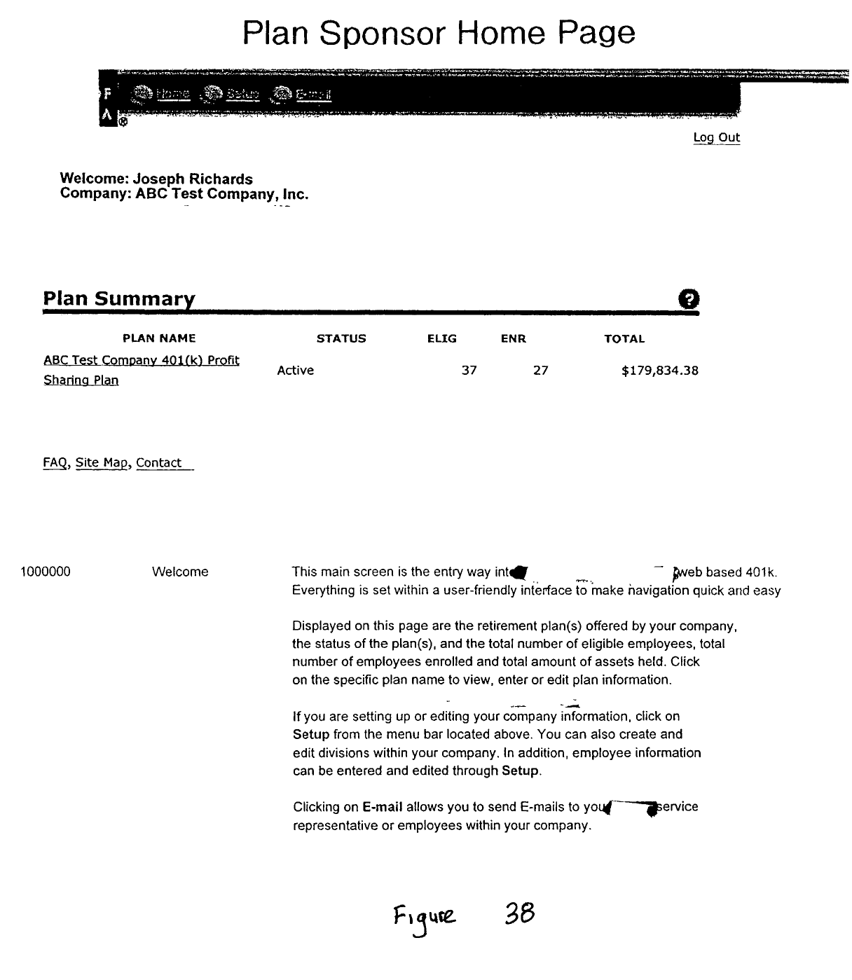

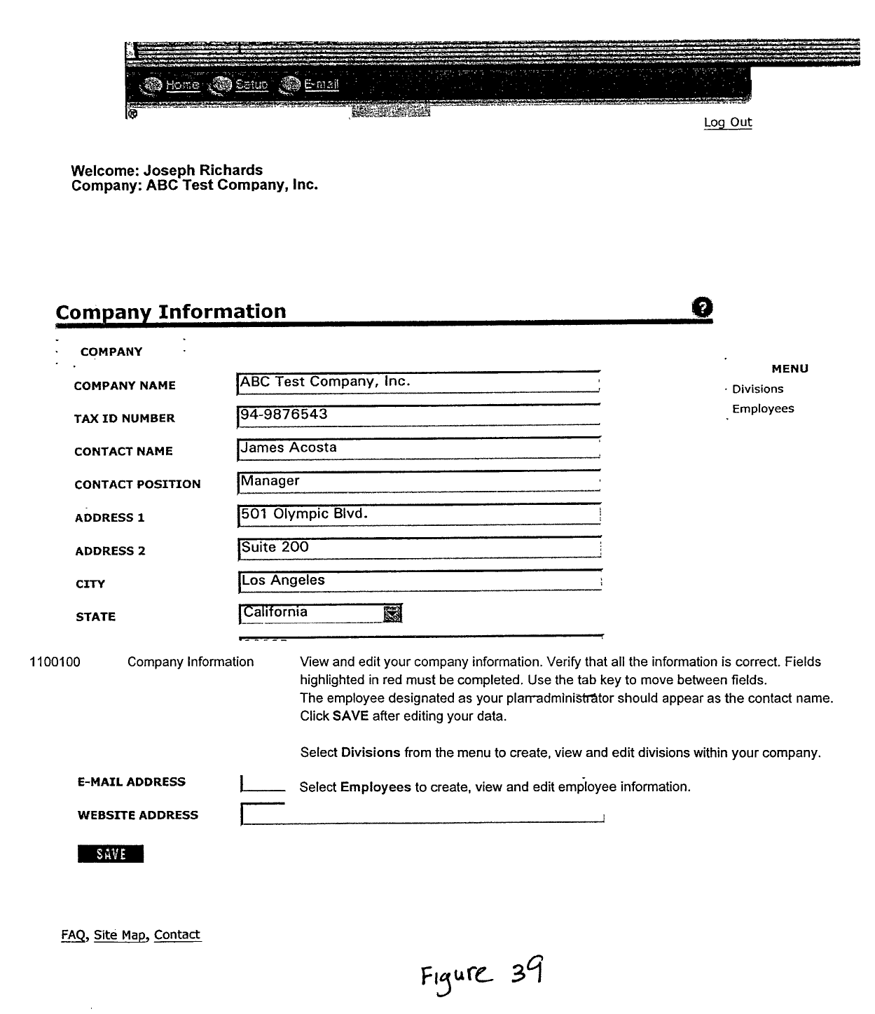

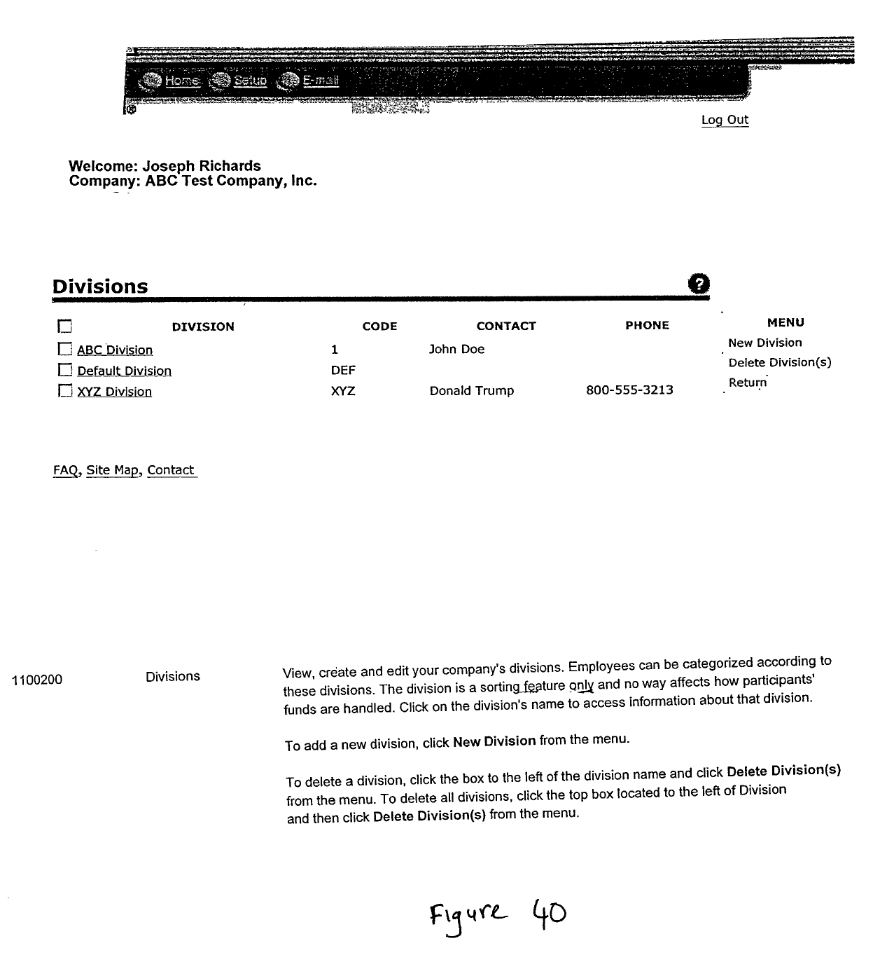

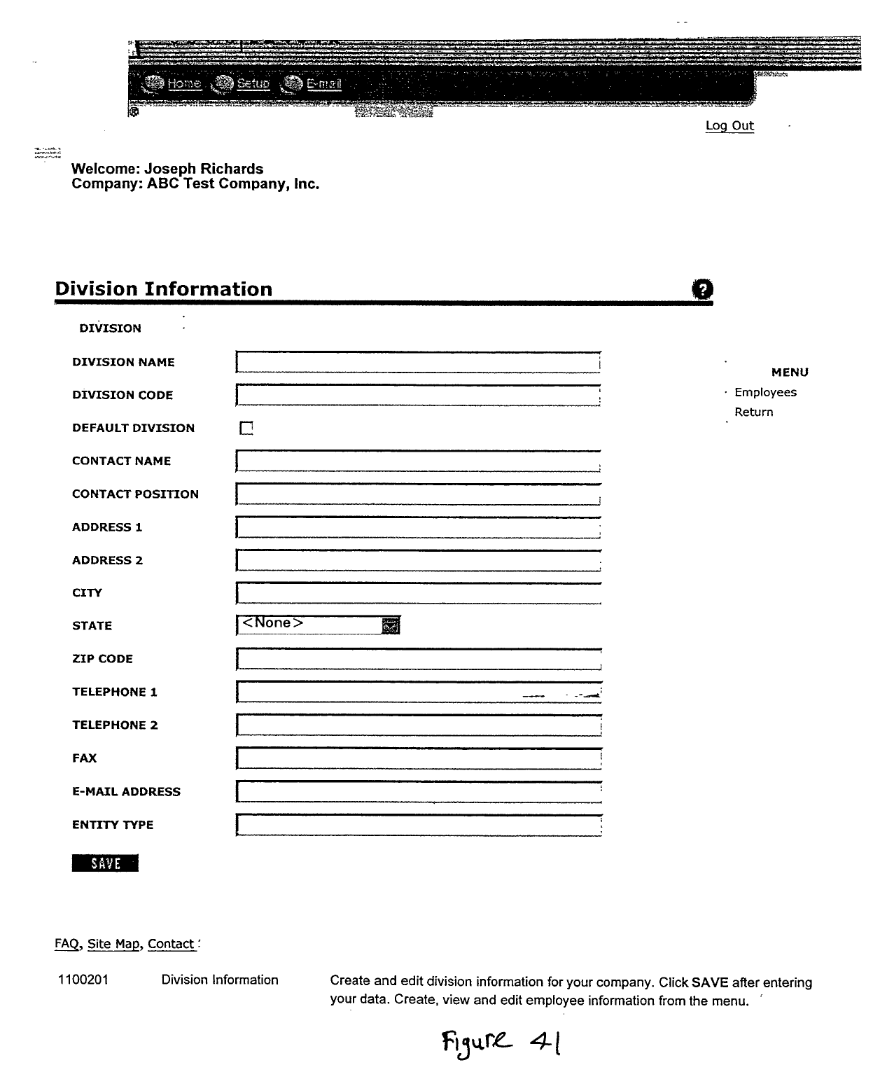

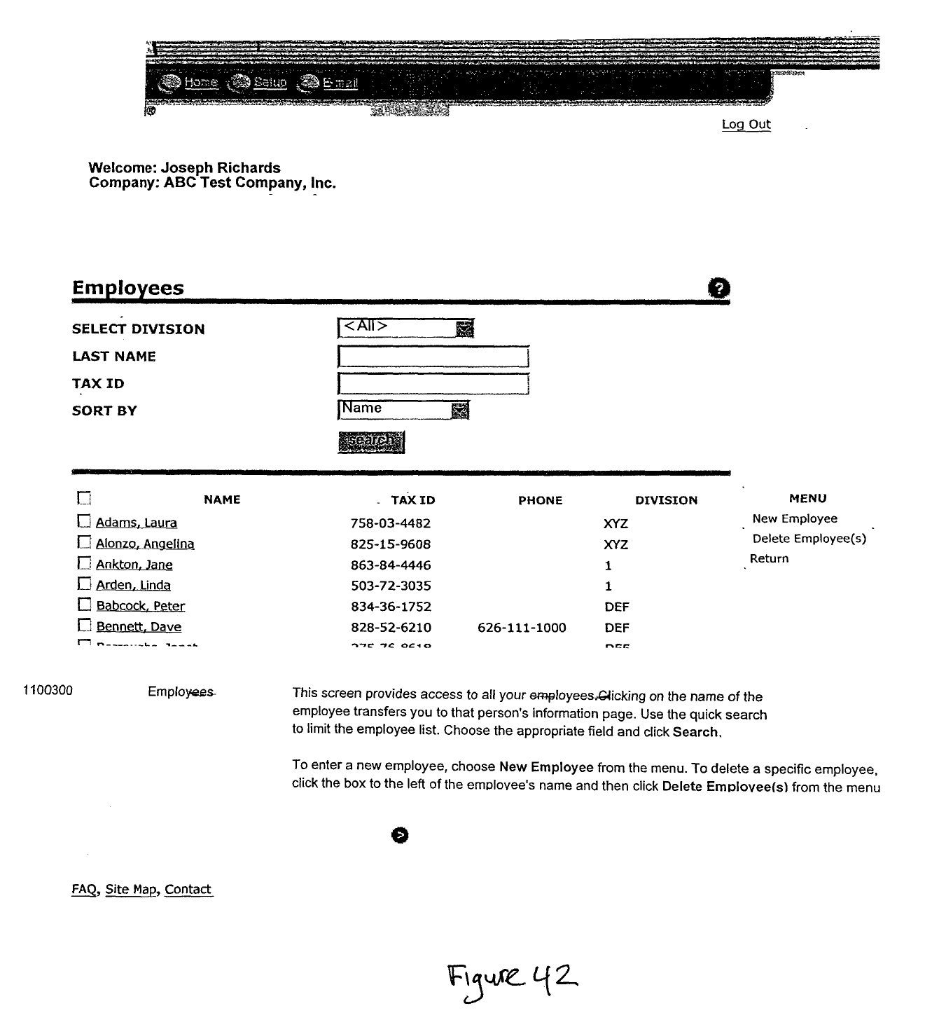

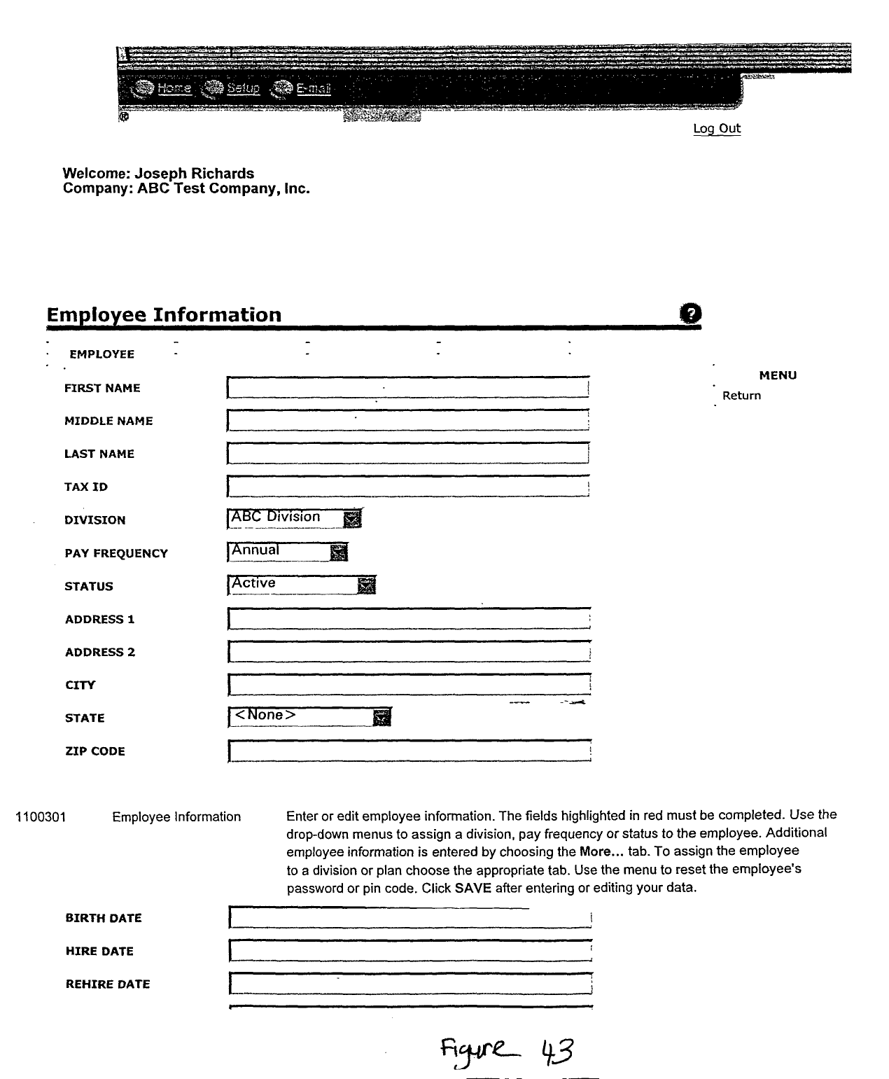

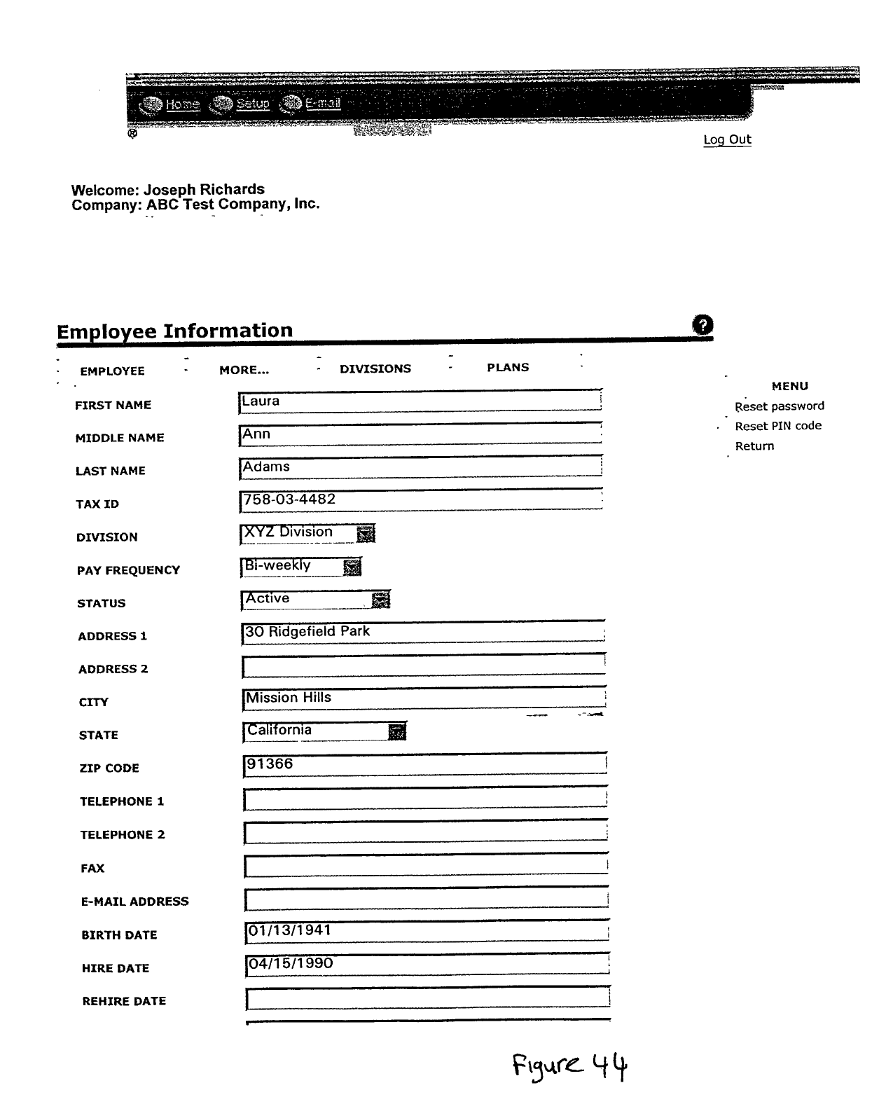

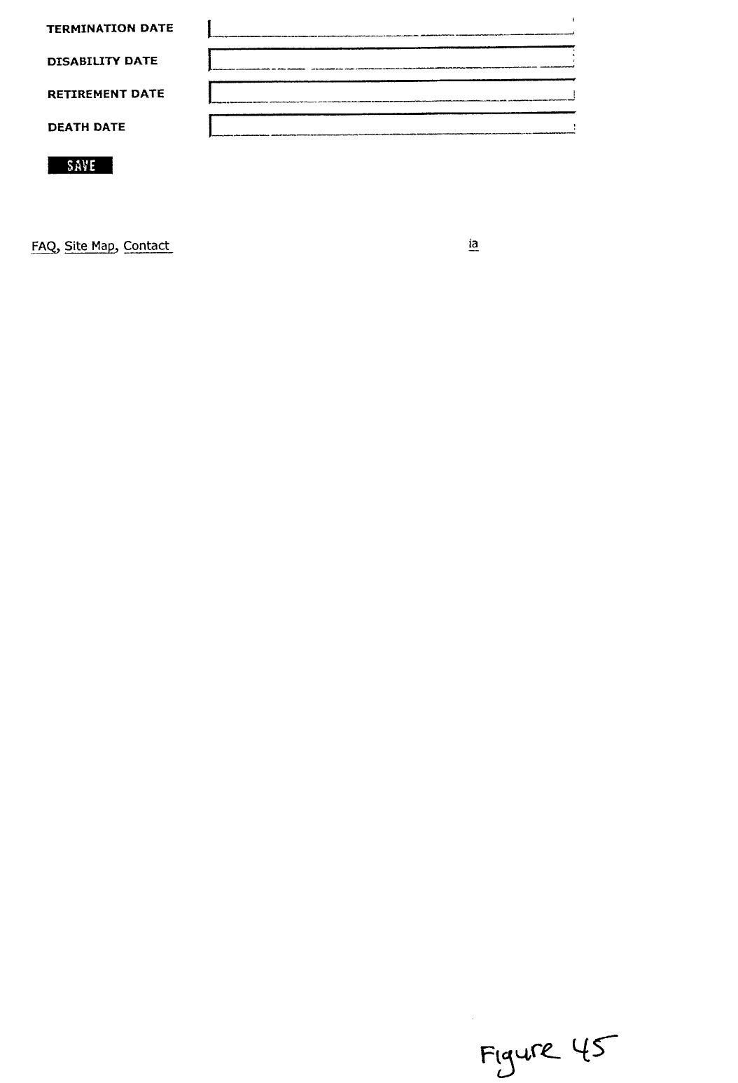

FIG. 38 illustrates a screenshot of the plan sponsor home page interface (3704). This interface allows plan sponsor representatives to access the web-based 401(k) system. The interface of FIG. 38 is a user-friendly interface that makes navigation quick and easy. Displayed in the interface (3704) are the various retirement plan(s) offered, status of the plan(s), total number of eligible employees, total number of employees enrolled, and total amount of assets held. Clicking on a specific plan allows representatives to view, enter, or edit plan information. FIG. 39 illustrates a screenshot of the company information interface (3706) that allows representatives to view and edit company information. FIG. 40 illustrates a screenshot of the divisions interface (3708) that allows representatives to view, create, and edit a company's divisions. Additionally, employees can be categorized according to these divisions. It should be noted that the divisions are strictly used as a sorting feature and are not intended to affect how the participants' funds are handled. Representatives are able to add or delete a division or delete all divisions. Clicking on the division name allows representatives to view division information associated with that particular division. A screenshot of the division information interface is provided in FIG. 41. FIG. 42, on the other hand, illustrates a screenshot of the employees interface (3710) that provides representatives with access to all employees. Clicking on a particular employee's name transfers the representative to that employee's personal information page. Additionally, representatives are able to limit the employee list based upon a quick search feature. FIGS. 43-45 illustrate the employee information interface that allows representatives to enter or edit employee information.

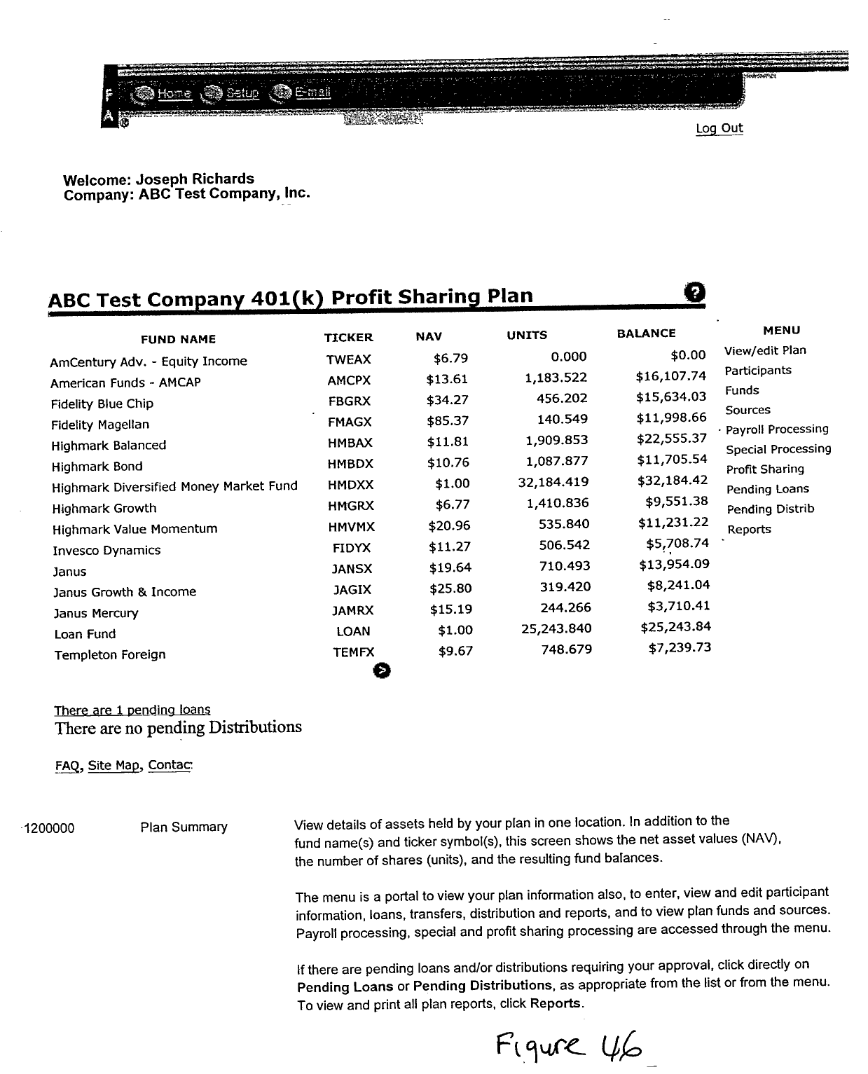

FIG. 46 illustrates a screenshot of the plan interface (3712) that can be used by representatives to view details of assets held by a plan in one location. In addition to the fund name(s) and ticker symbol(s), this screen shows the net asset value (NAV), the number of shares (units), and the resulting fund balances. Thus, this interface provides for a portal to: view plan information; view/edit participant information, loans, transfers, distributions, and reports; view plan funds and sources, payroll processing, special and profit sharing processing, pending loans, and pending distributions.

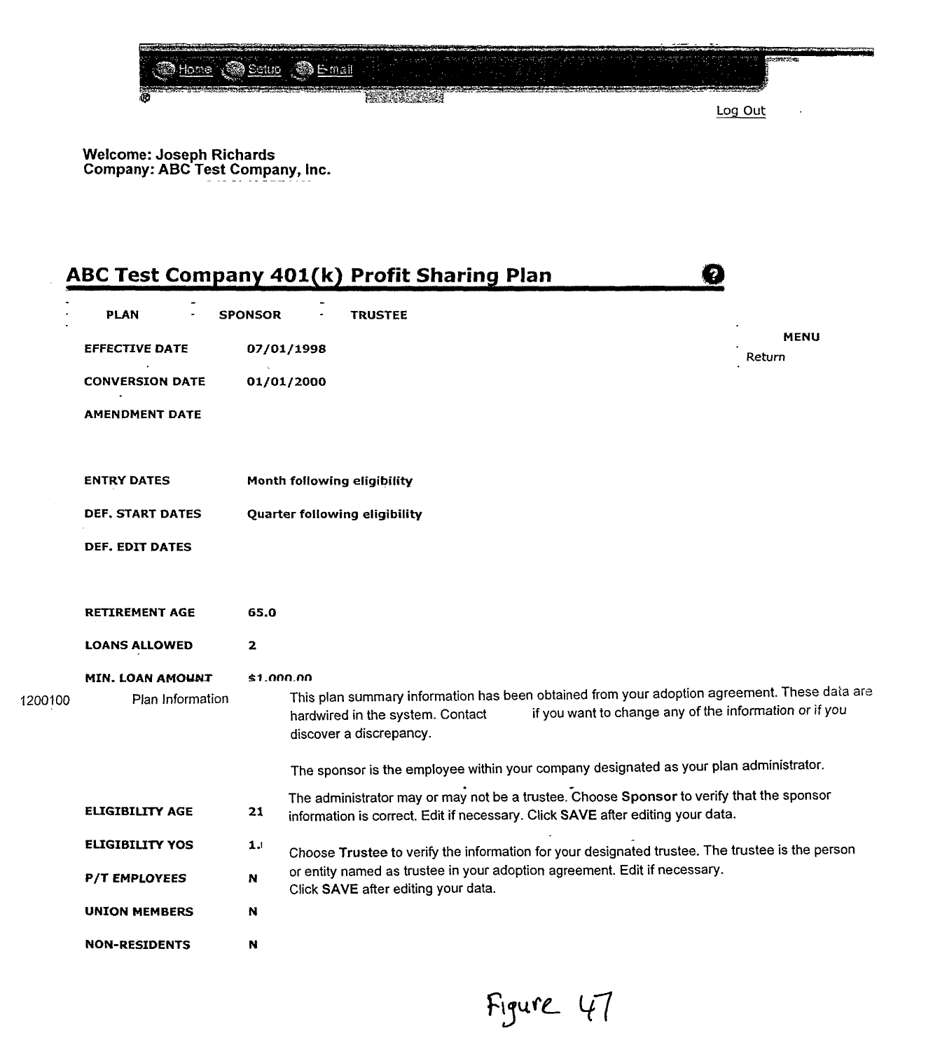

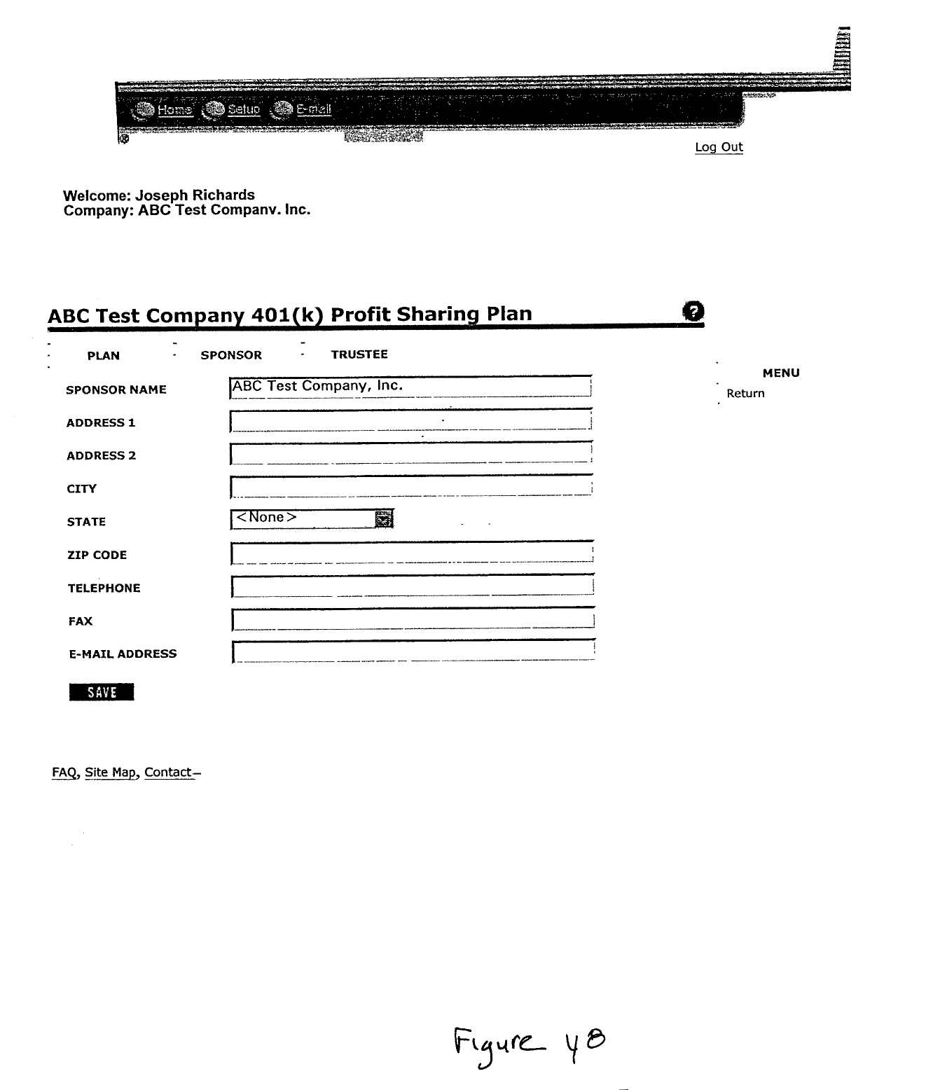

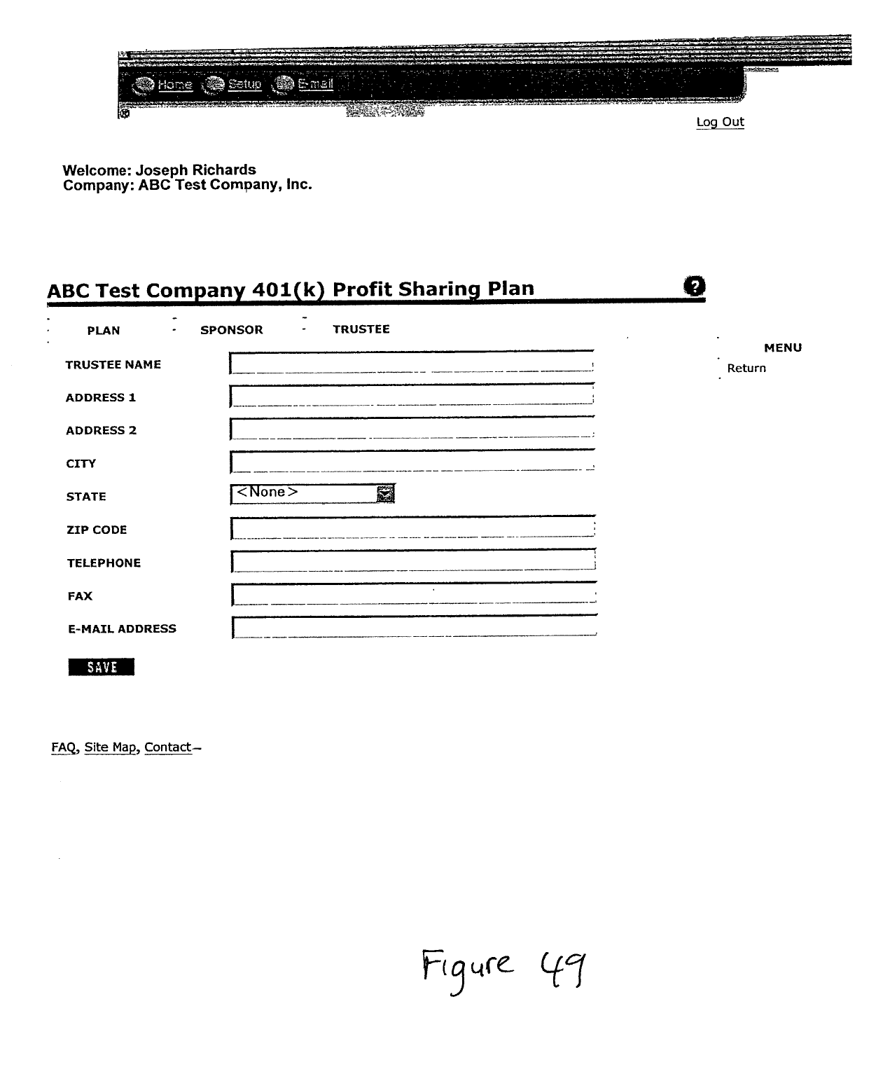

FIG. 47 illustrates a screenshot of the view/edit interface (3714) that shows a plan summary based on the adoption agreement. The sponsor is the employee within the company designated as the plan administrator. It should be noted that the sponsor may or may not be a trustee. FIG. 48 illustrates a screenshot of the sponsor information interface, which can be accessed by clicking on the sponsor link in FIG. 47. FIG. 49 illustrates a screenshot of the trustee information interface, which can be accessed by clicking on the trustee link in FIG. 47.

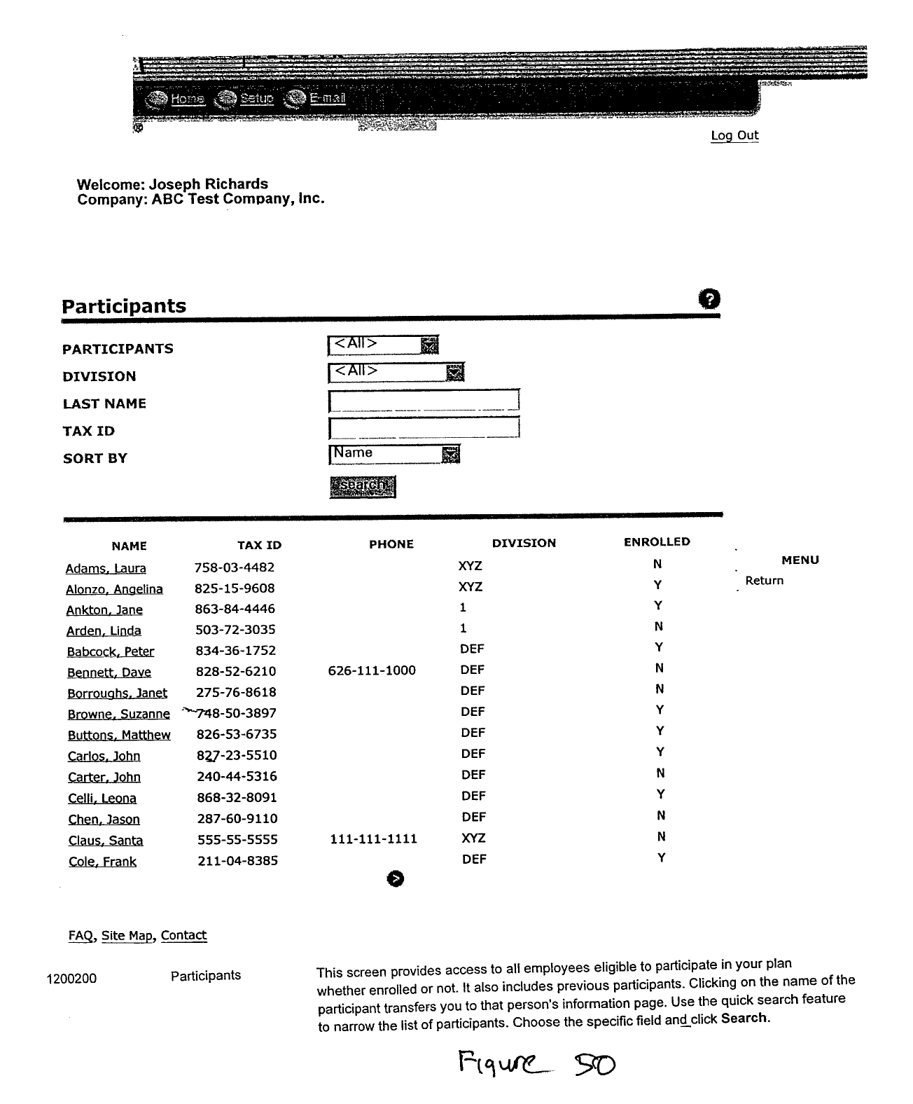

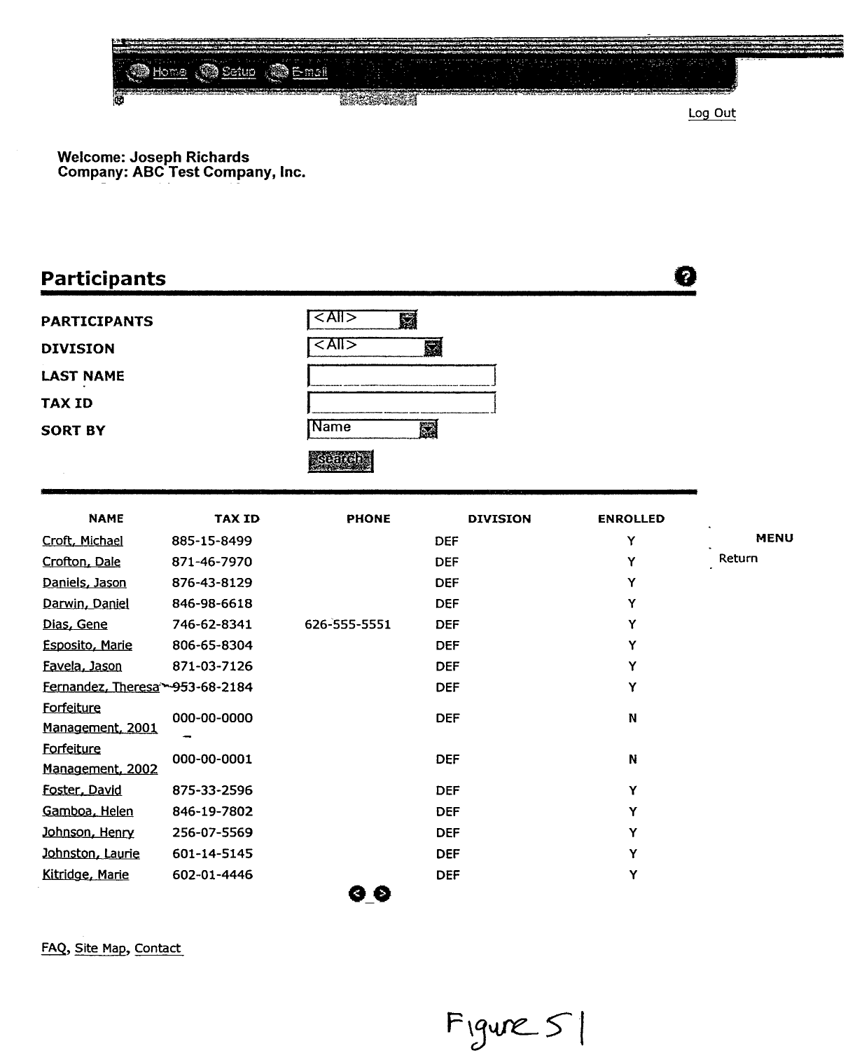

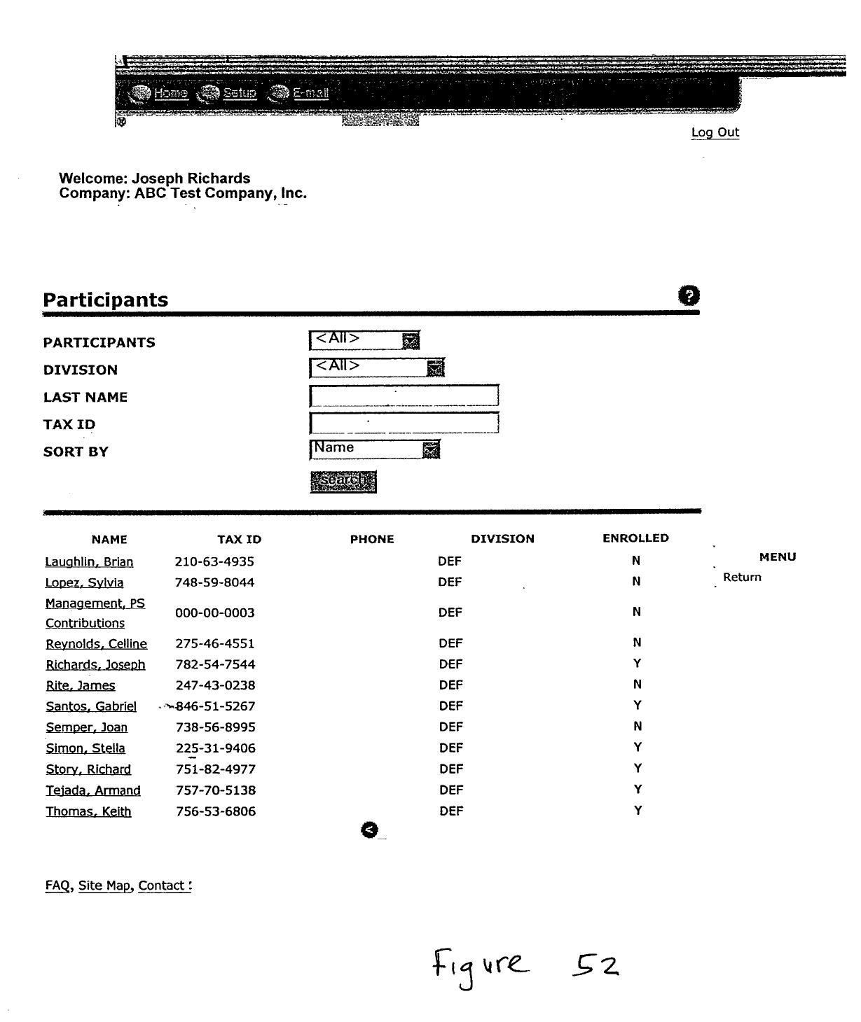

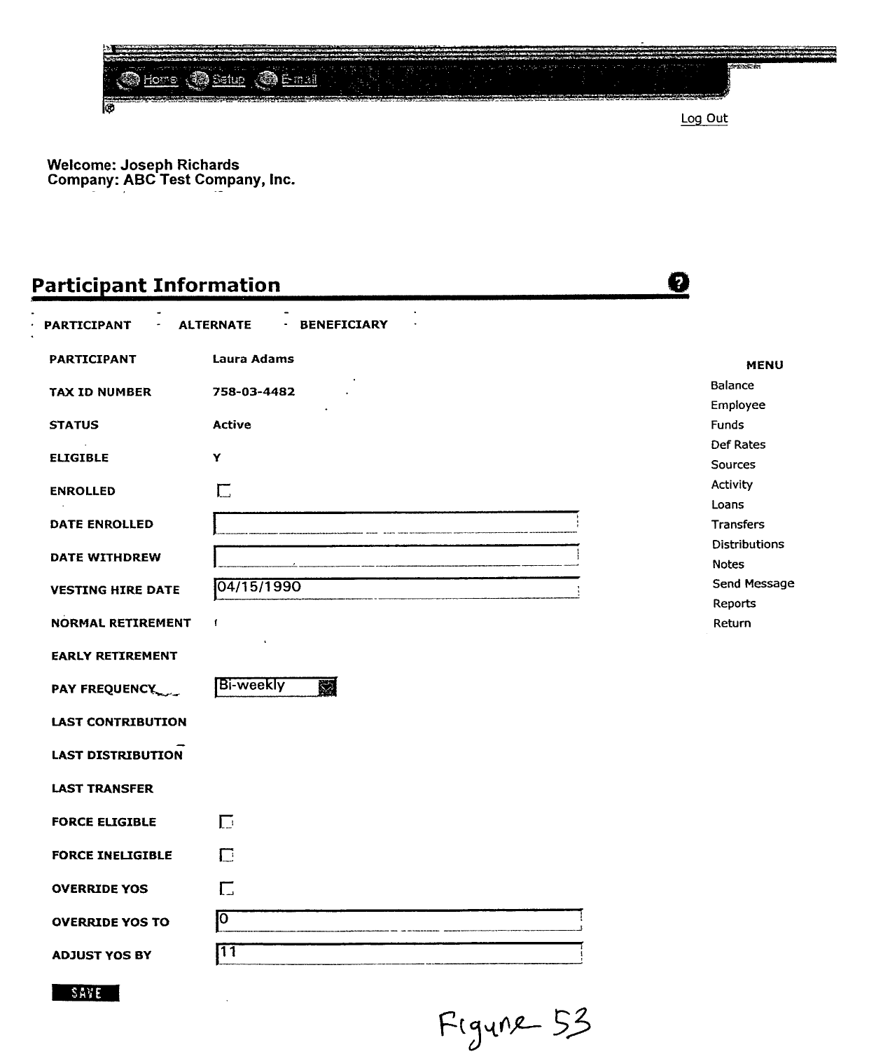

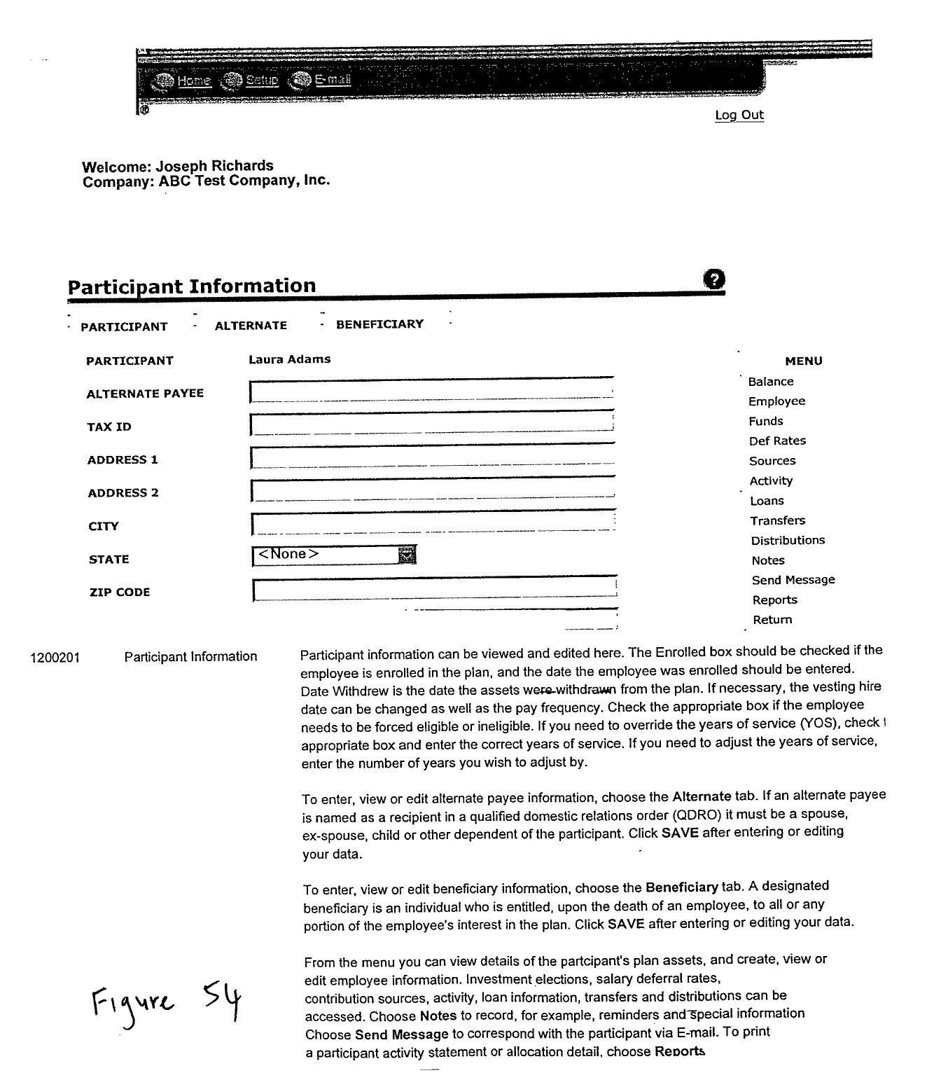

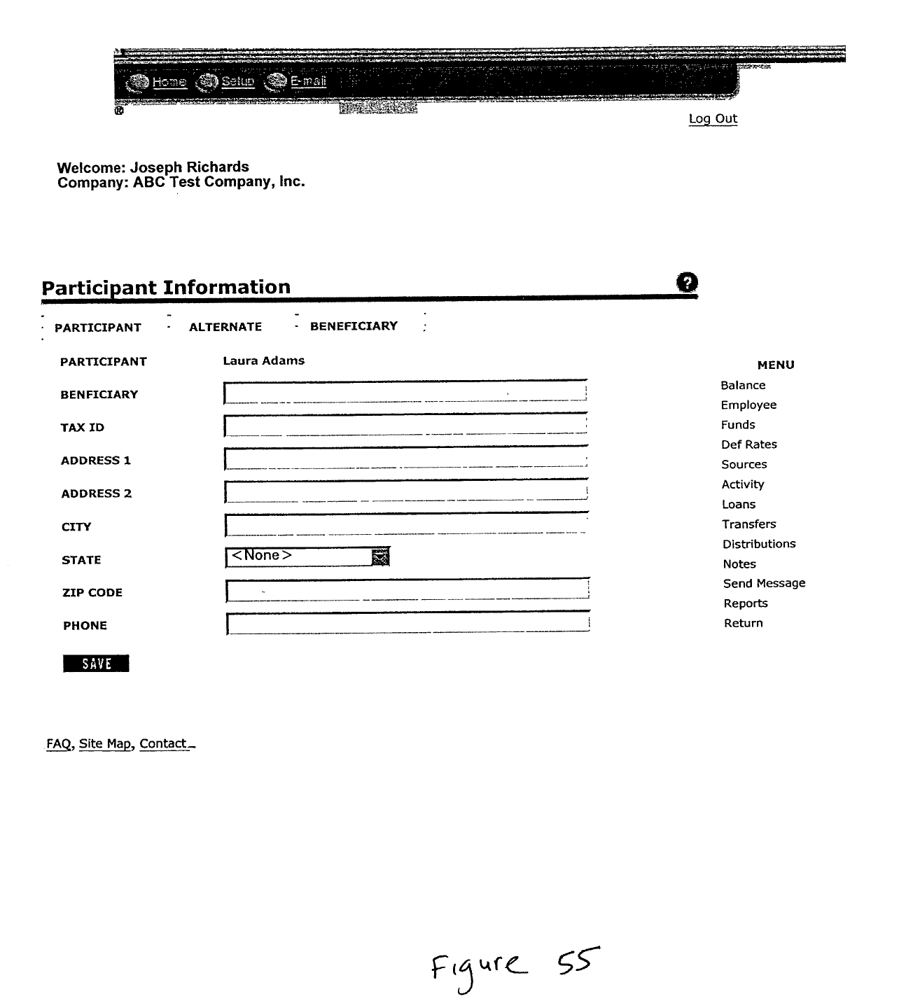

FIGS. 50-52 illustrate a screenshot of the participants interface (3716), which allows representatives with access to all employees eligible to participate in the plan, whether enrolled or not. It should be noted that this interface (3716) also shows previous participants. Clicking on a particular employee's name transfers the representative to that employee's information page. Additionally, a quick search feature is implemented to narrow the list of participants. FIG. 53 illustrates a screenshot showing the participant information page wherein participant information can be viewed and edited. The enrolled box should be checked if the employee is enrolled in the plan, and the date the employee was enrolled should also be entered. If necessary, the vesting hire date can be changed, as well as pay frequency. Appropriate boxes need to be checked if the employee needs to be forced eligible or ineligible. Additionally, the years of service can be overridden to allow for entering the correct years of service. FIG. 54 illustrates a screenshot of the participant information page wherein alternate payee information can be entered if an alternate payee is named as a receipt in a QDRO. An alternate payee is typically a spouse, ex-spouse, child, or other dependents of the participant. FIG. 55 illustrates a screenshot of the participant information page, wherein beneficiary information can be entered. A designated beneficiary is an individual who is entitled, upon death of an employee, to all or a portion of the employee's interest in a plan.

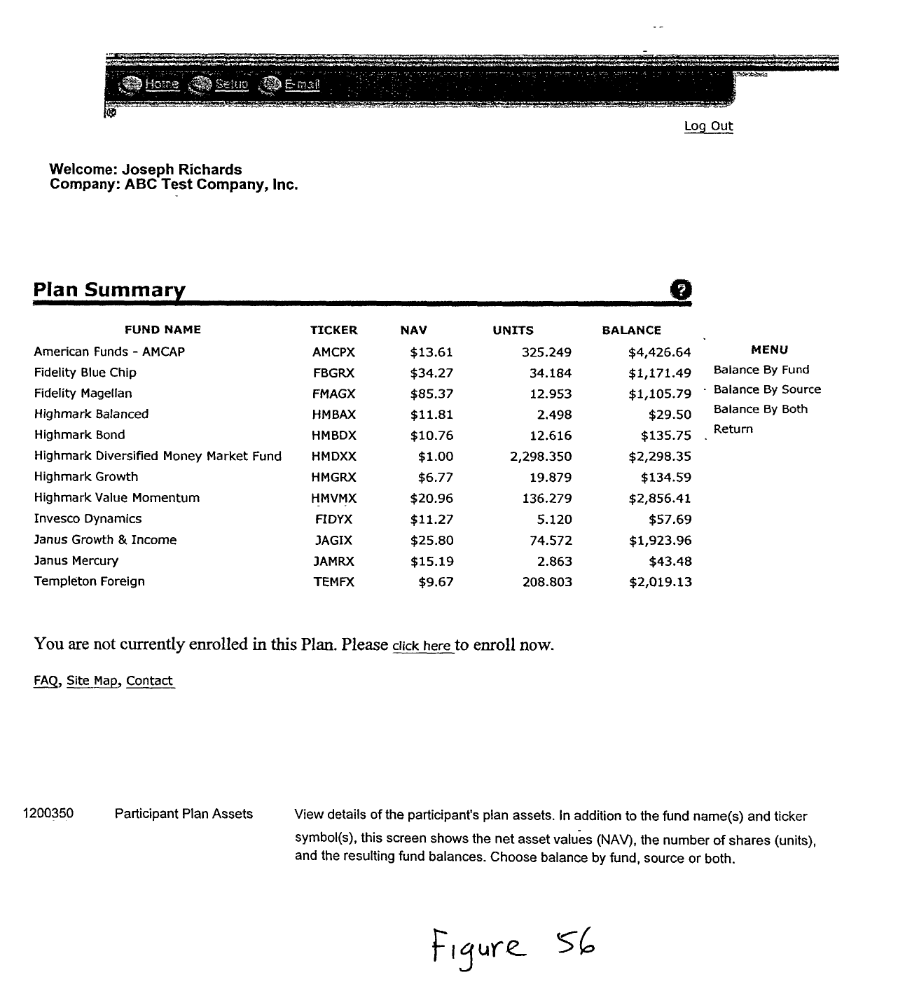

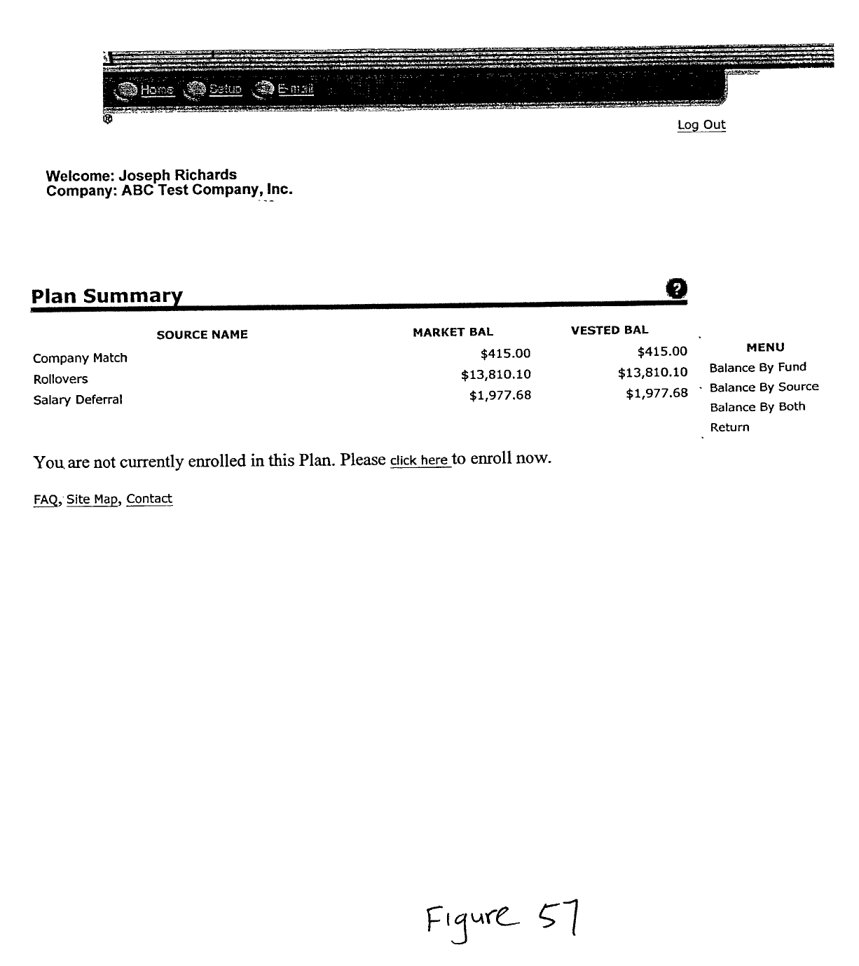

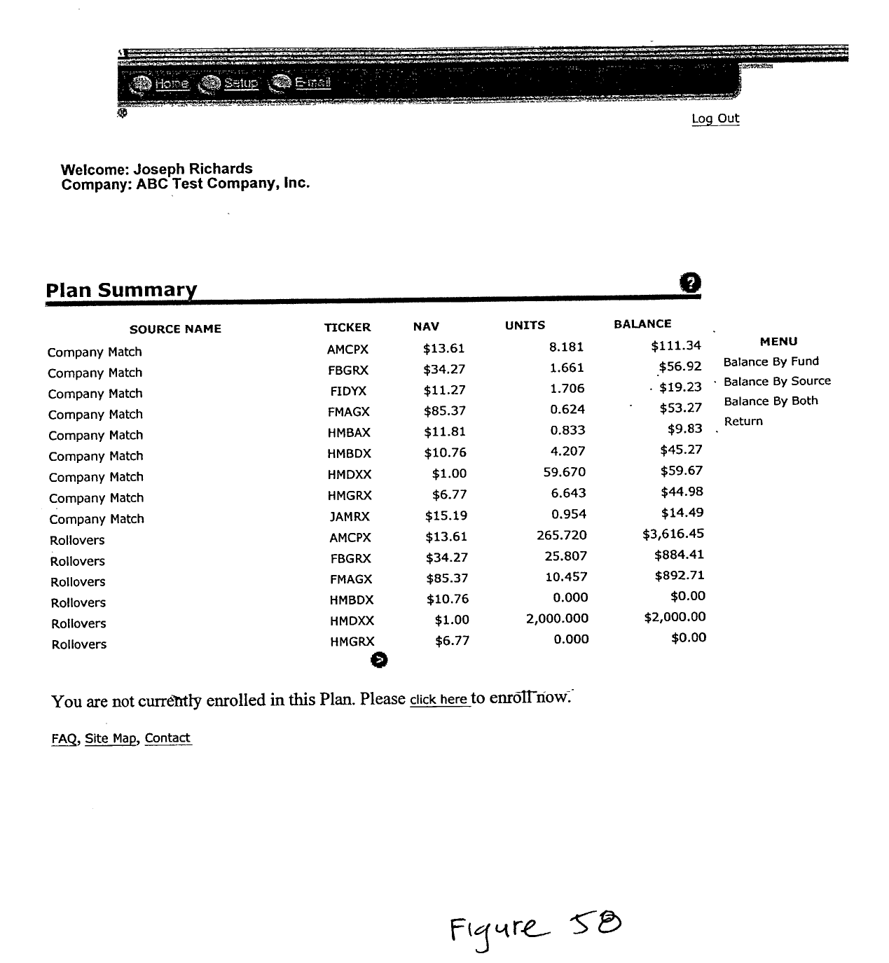

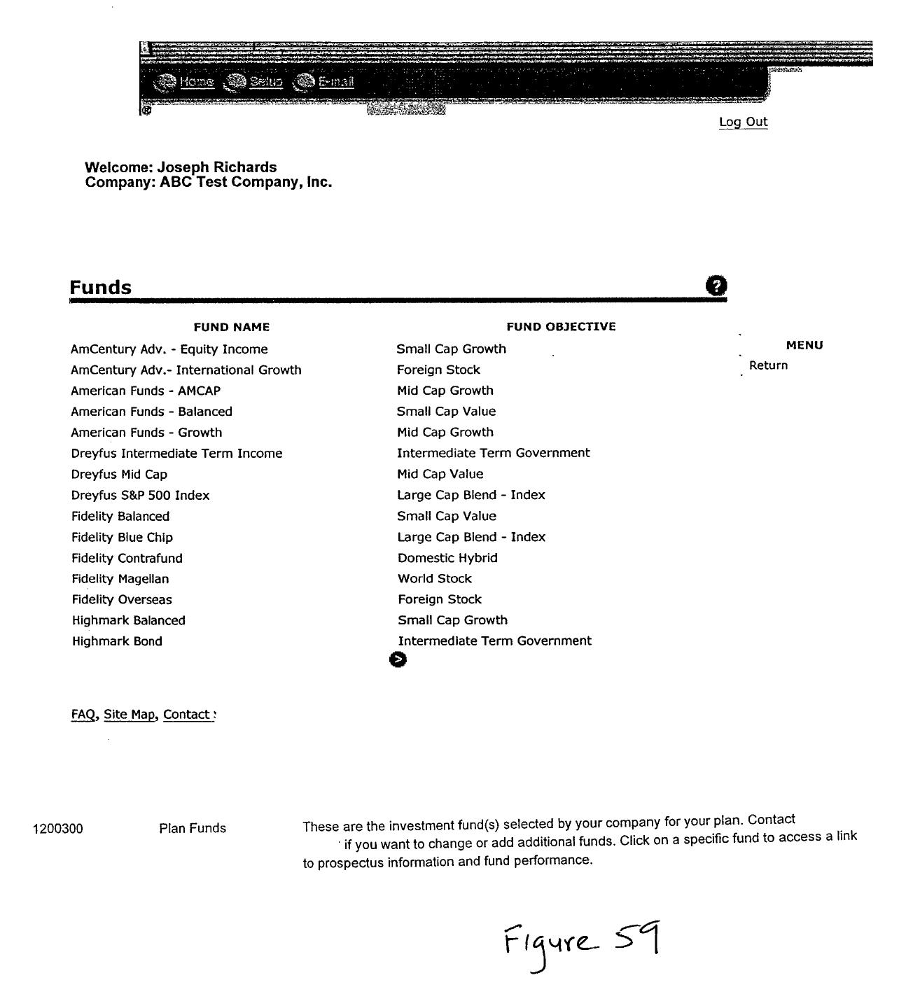

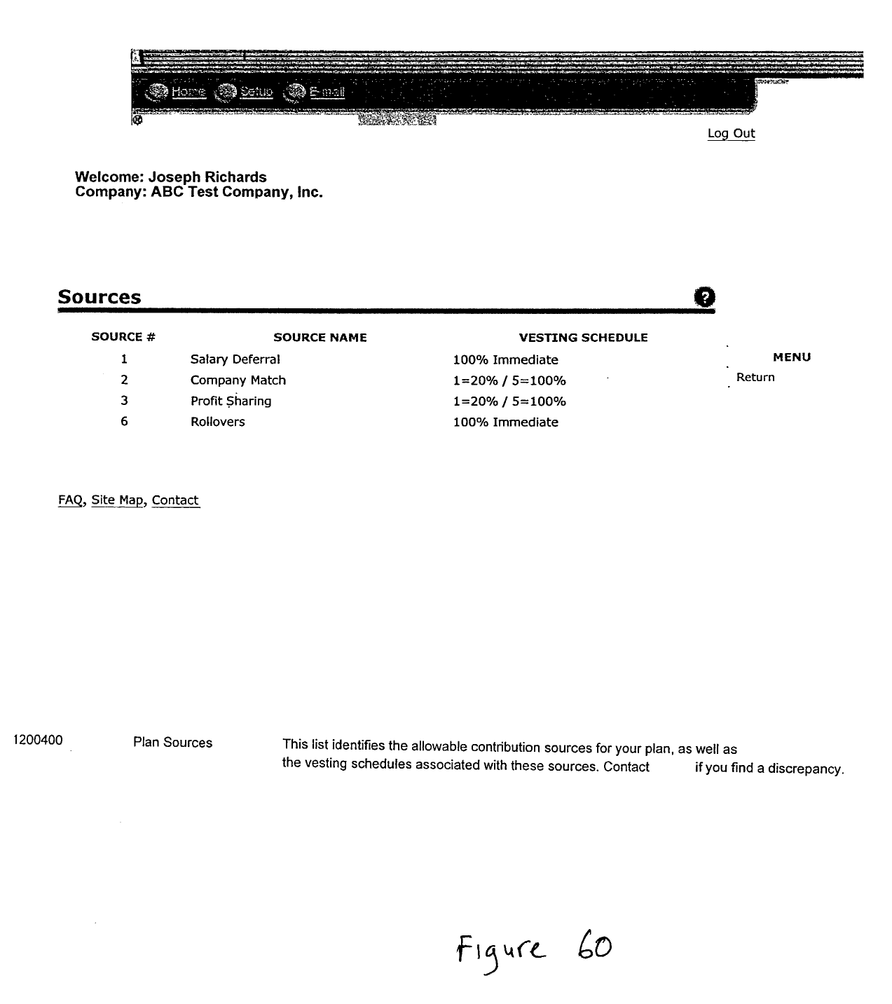

FIGS. 56-58 illustrate various interfaces associated with the plan assets and funds interface (3718). These interfaces allow representatives to view details of the participant's plan assets. In addition to the fund name(s) and ticker symbol(s), this screen shows the NAV, number of shares (units), and resulting fund balances. Additionally, the plan summary can be shown via three options: balanced by fund, source, or fund and source. FIG. 59 illustrates the plan funds interface, which shows investment fund(s) selected by the company for a particular plan. FIG. 60 illustrates the plan sources interface (3722), which identifies the allowable contribution sources for a particular plan, including the vesting schedules associated with the sources.

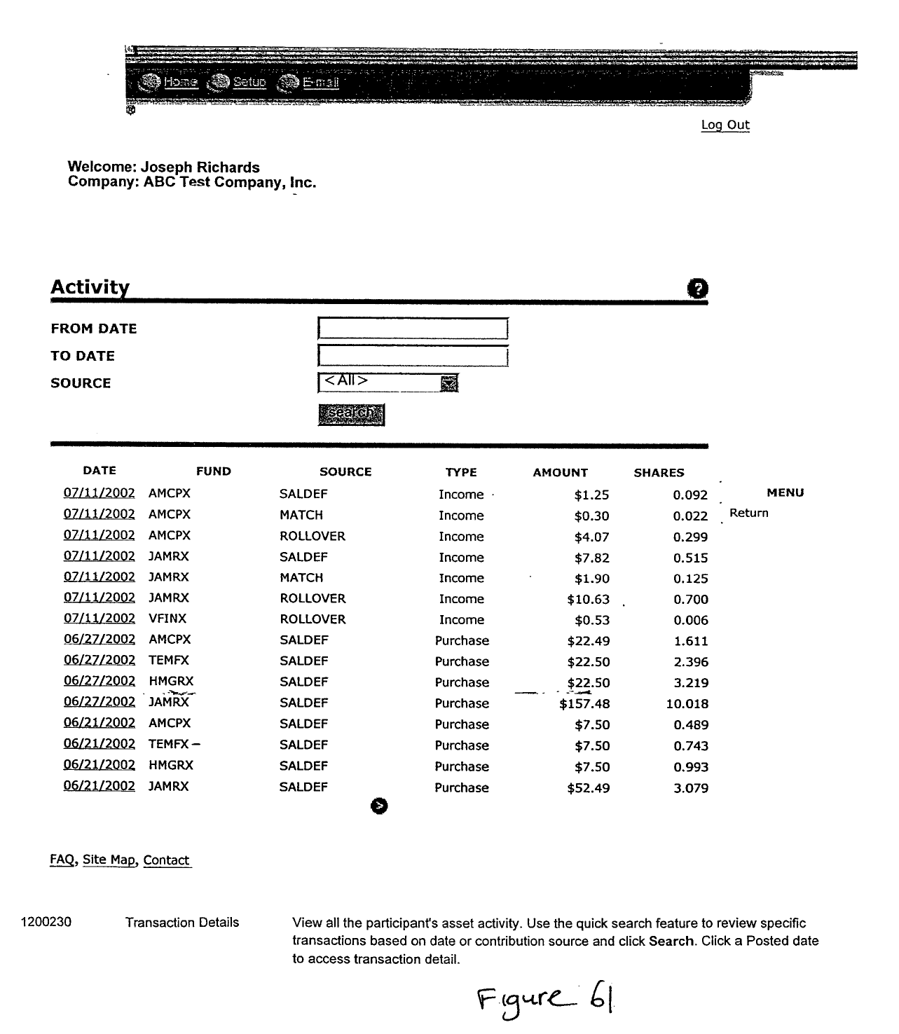

FIG. 61 illustrates a screenshot of the activities interface (3724), which allows representatives to view all of a participant's asset activity. Additionally, a quick search feature is provided for reviewing specific transactions based on date or contribution source. Moreover, clicking on a posted date allows representatives to access transactional detail.

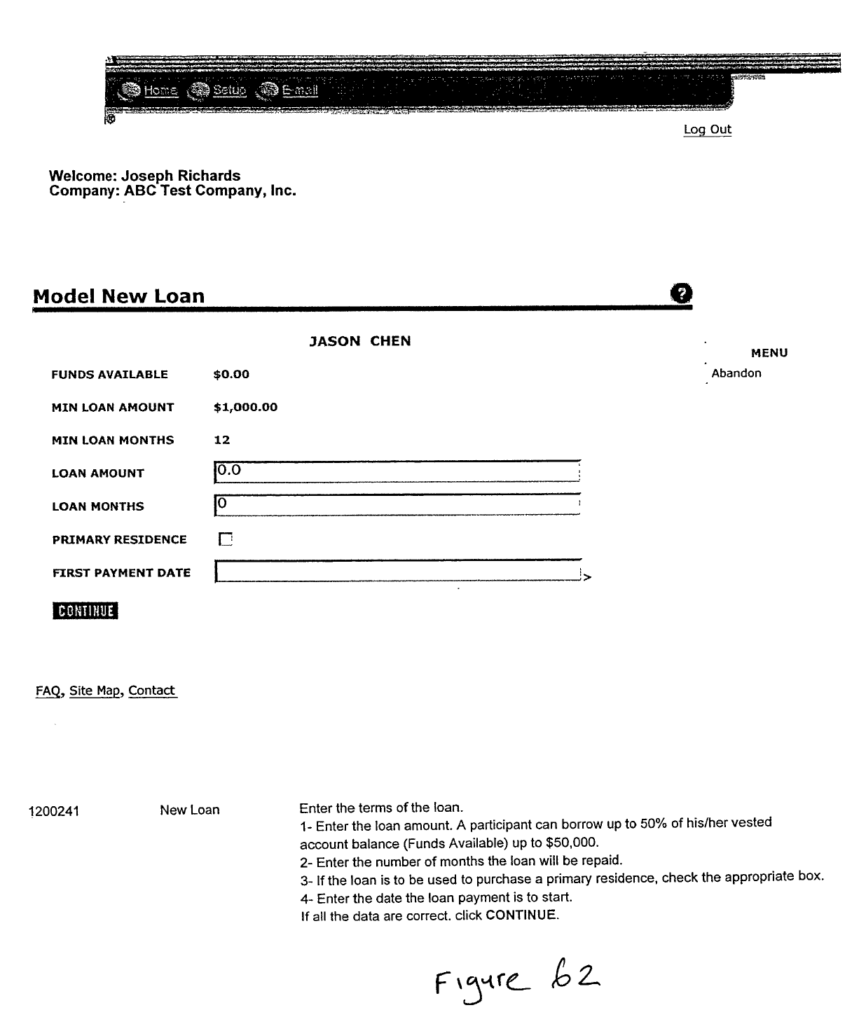

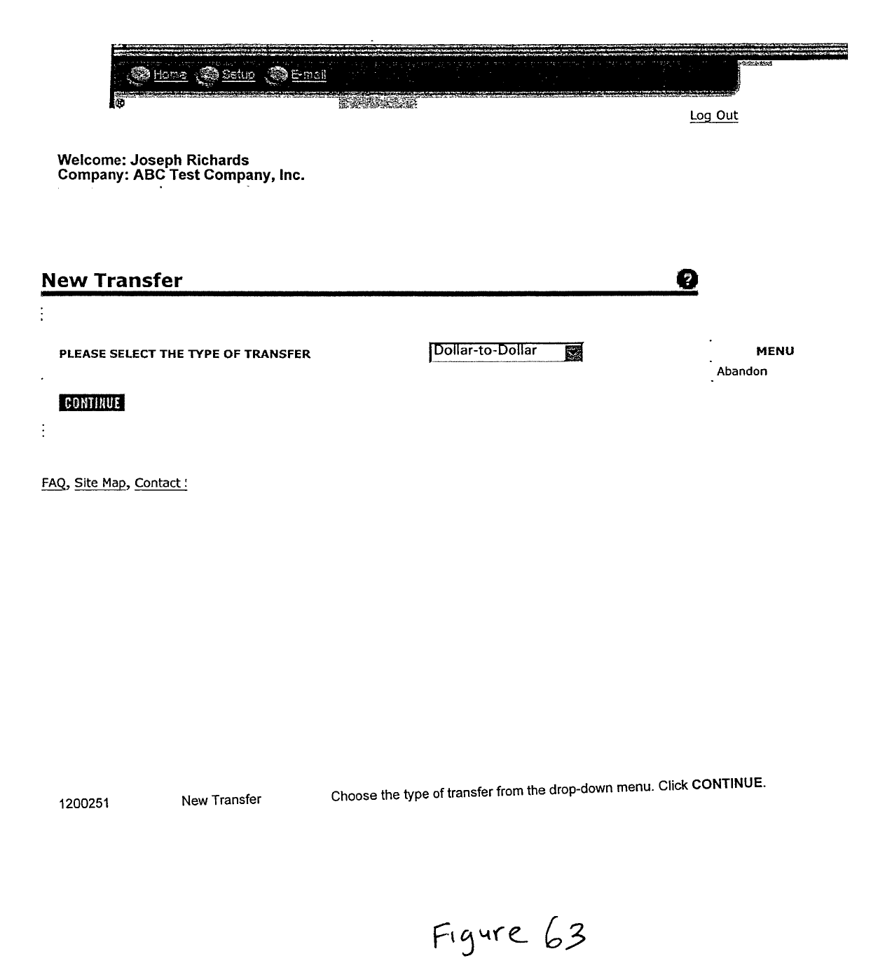

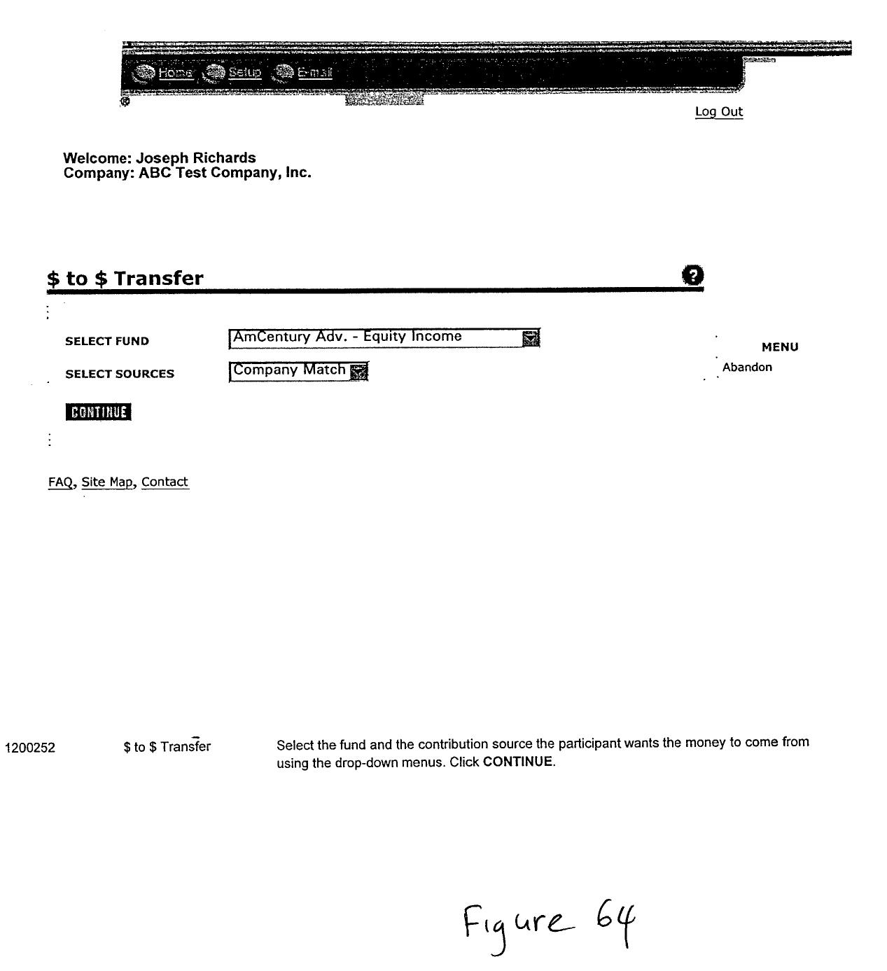

FIG. 62 illustrates a screenshot of the interface for modeling loans (3726). FIG. 63 illustrates a screenshot of the interface for modeling transfers (3728). FIG. 64 illustrates a screenshot of the interface for performing a $-to-$ transfer.

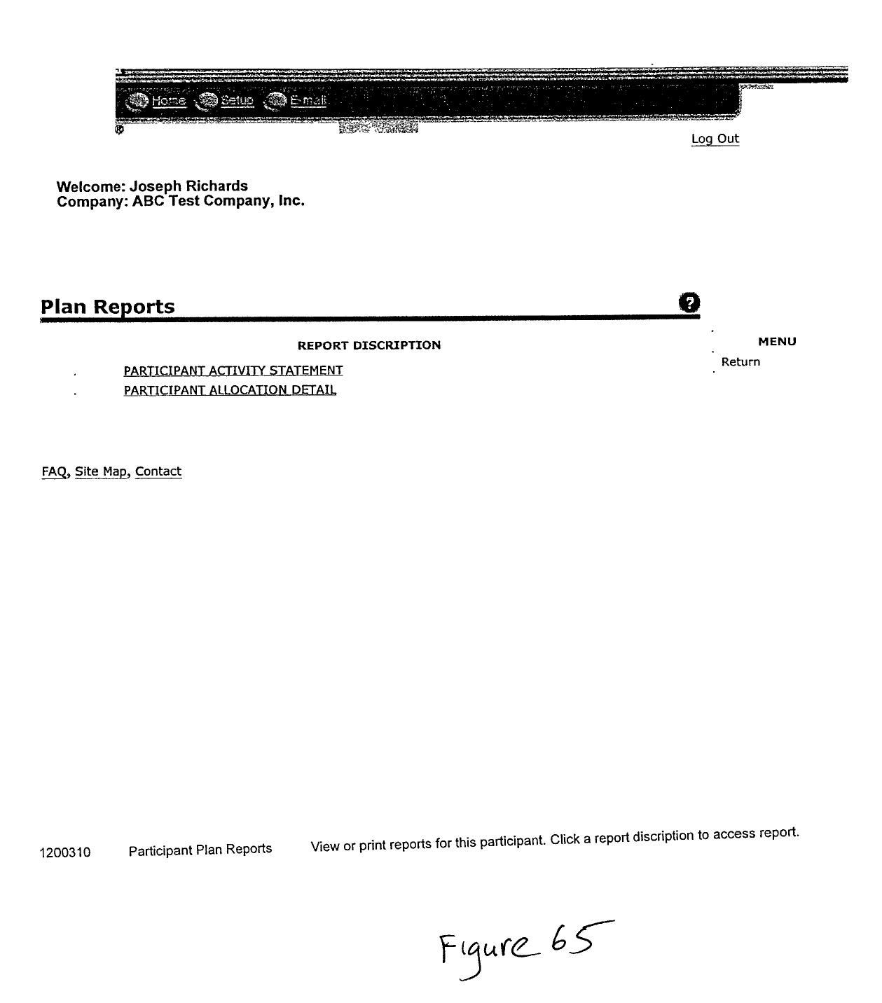

FIG. 65 illustrates a screenshot of the interface for viewing plan reports (3730). This interface allows representatives to view or print reports for a particular participant or, alternatively, to click on a report description to access a particular report.

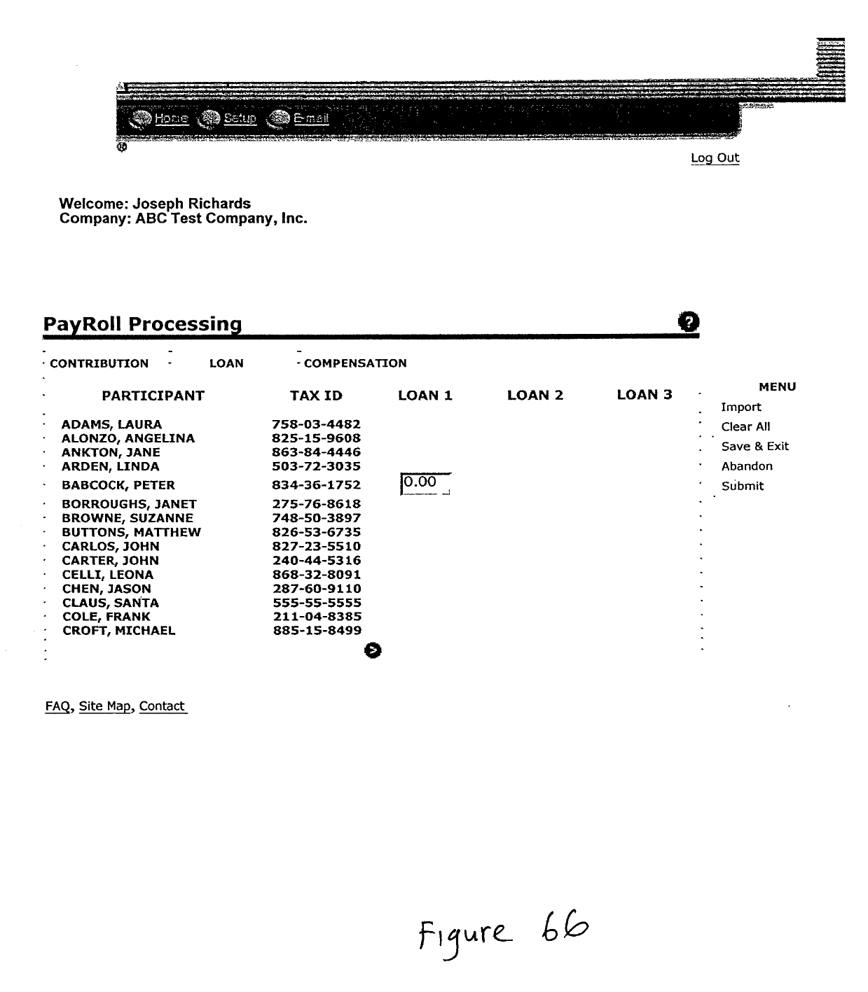

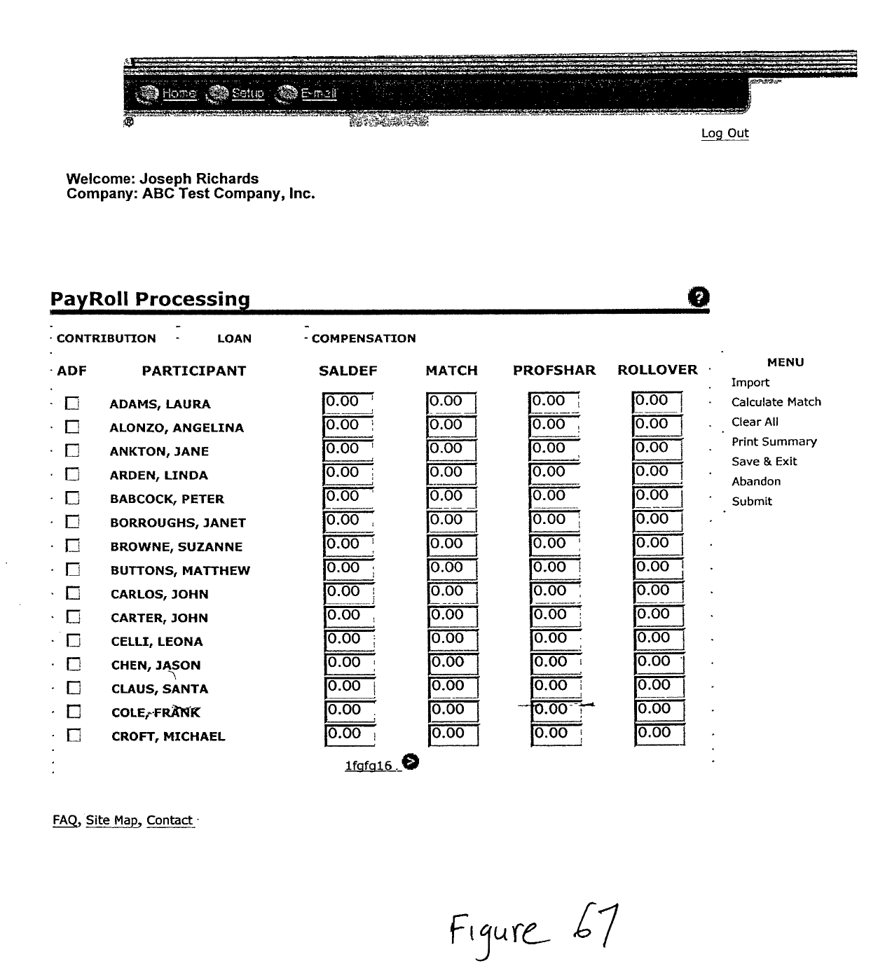

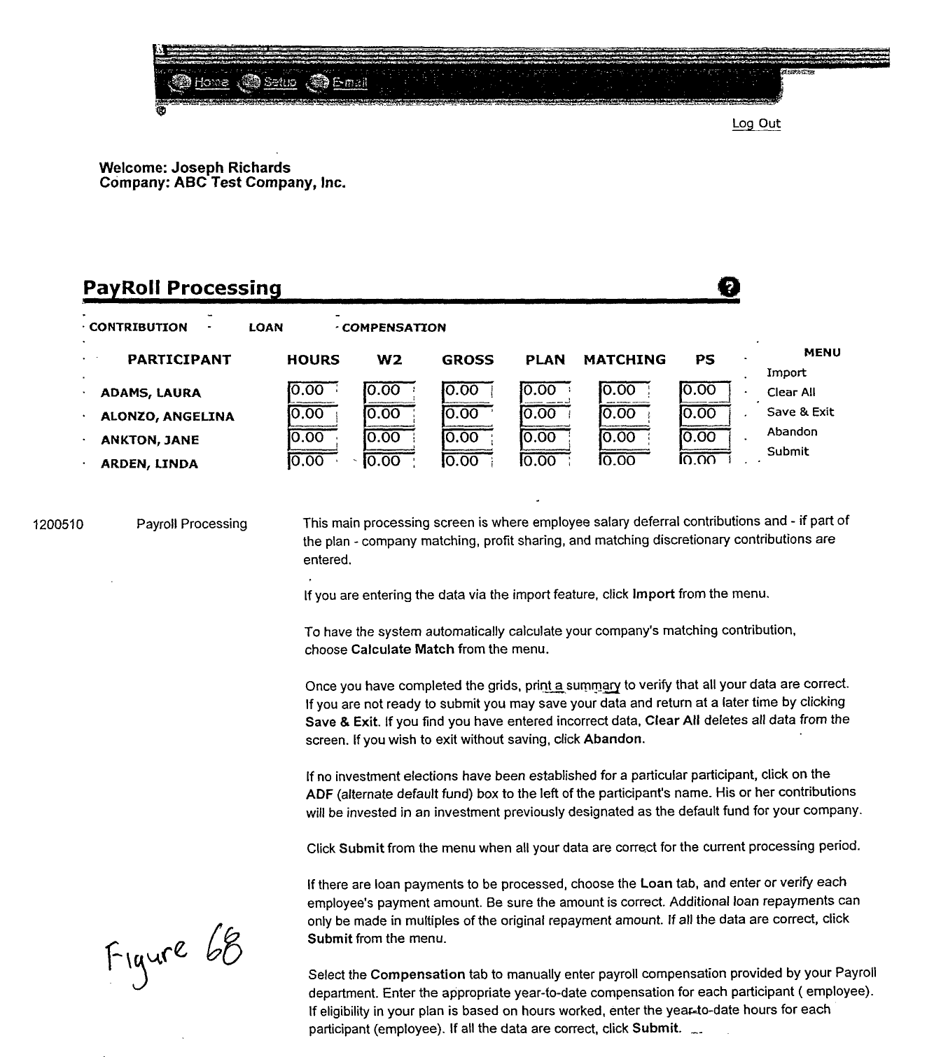

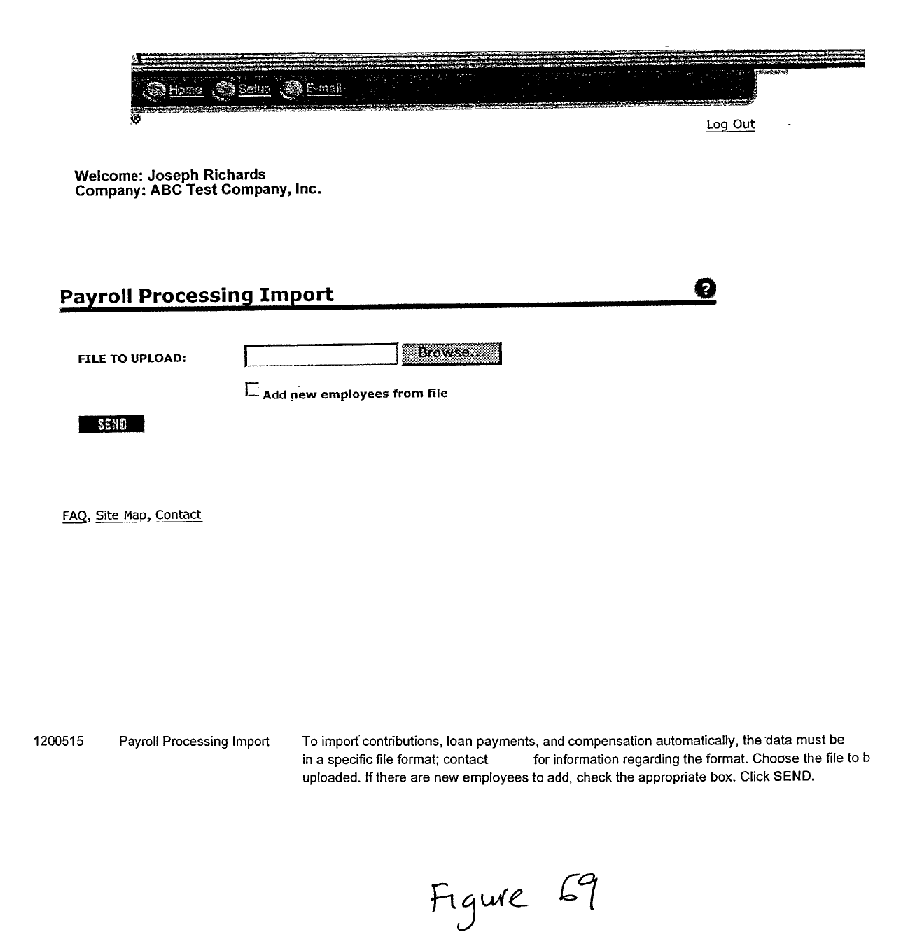

FIGS. 66-69 illustrate screenshots of the various payroll processing interfaces (3732) that allow for entering employee salary deferral contributions and, if part of the plan, company matching, profit sharing, and matching discretionary contributions. Additionally, the company's matching contributions can be calculated via these interfaces. Furthermore, data can also be entered via an import feature.

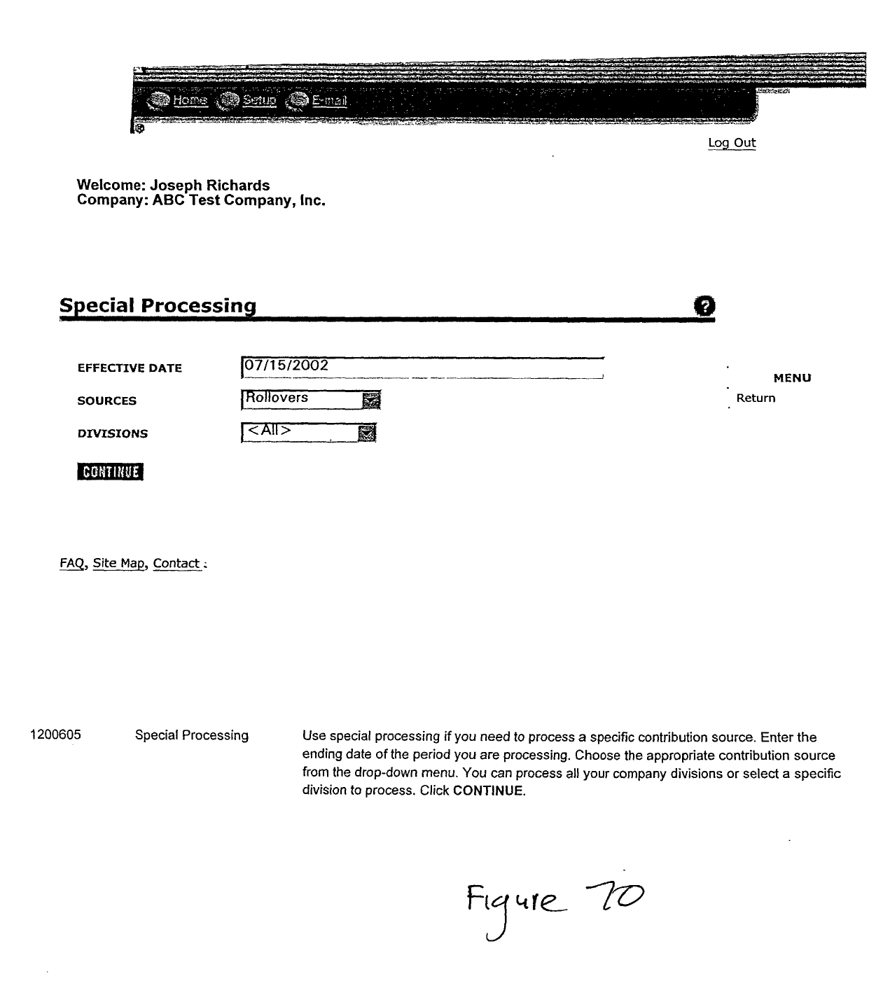

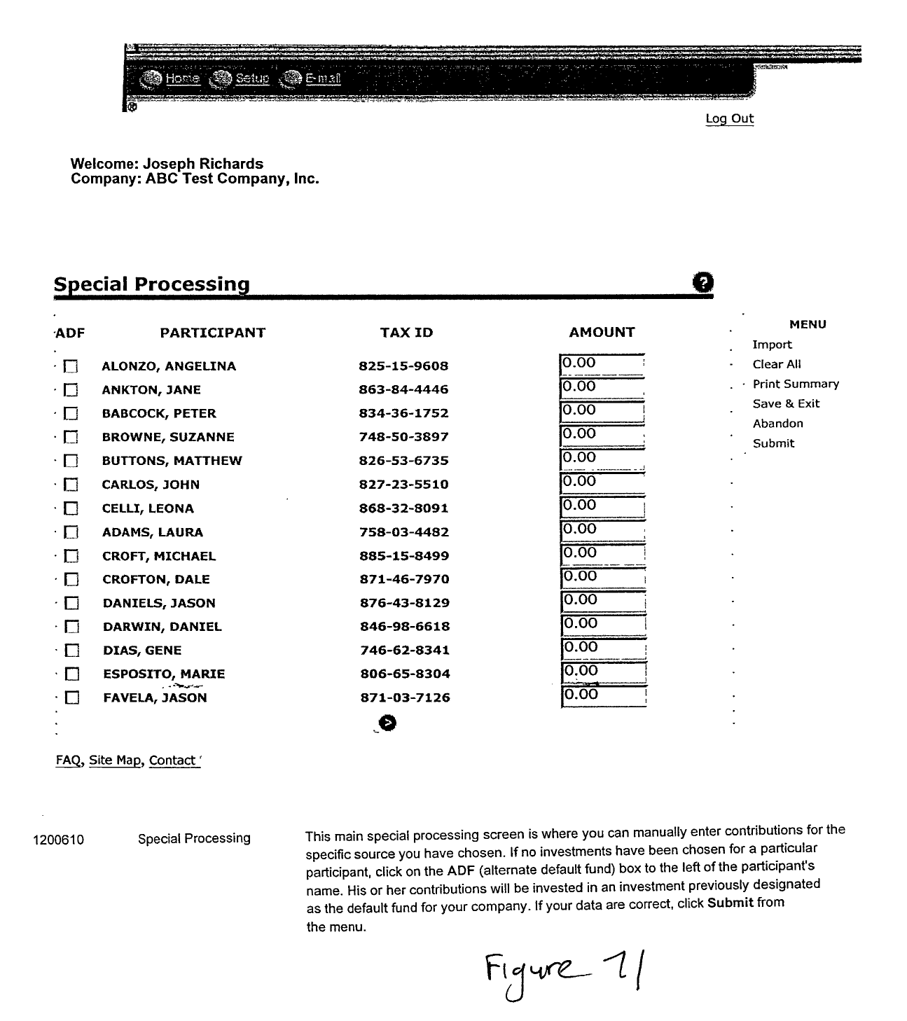

FIGS. 70-71 illustrate various screenshots of the special processing interface (3734), which can be used to process a special contribution source. The main special processing screen (FIG. 71) allows for the manual entry of contributions for the special source selected.

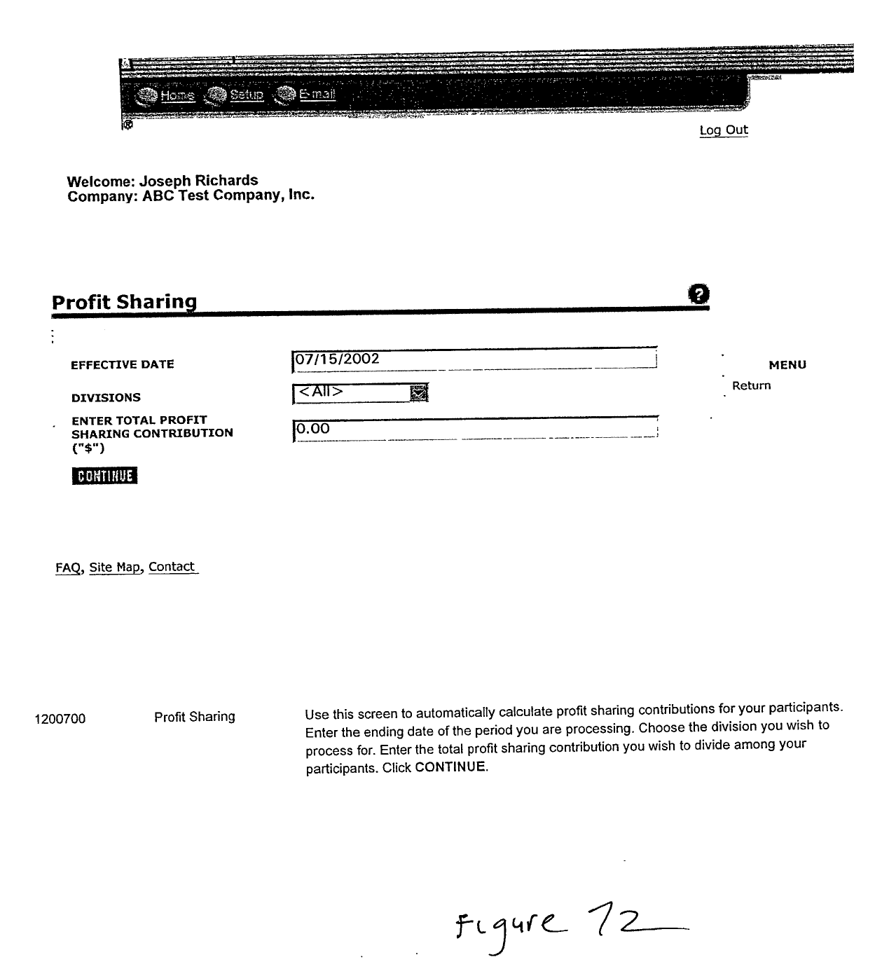

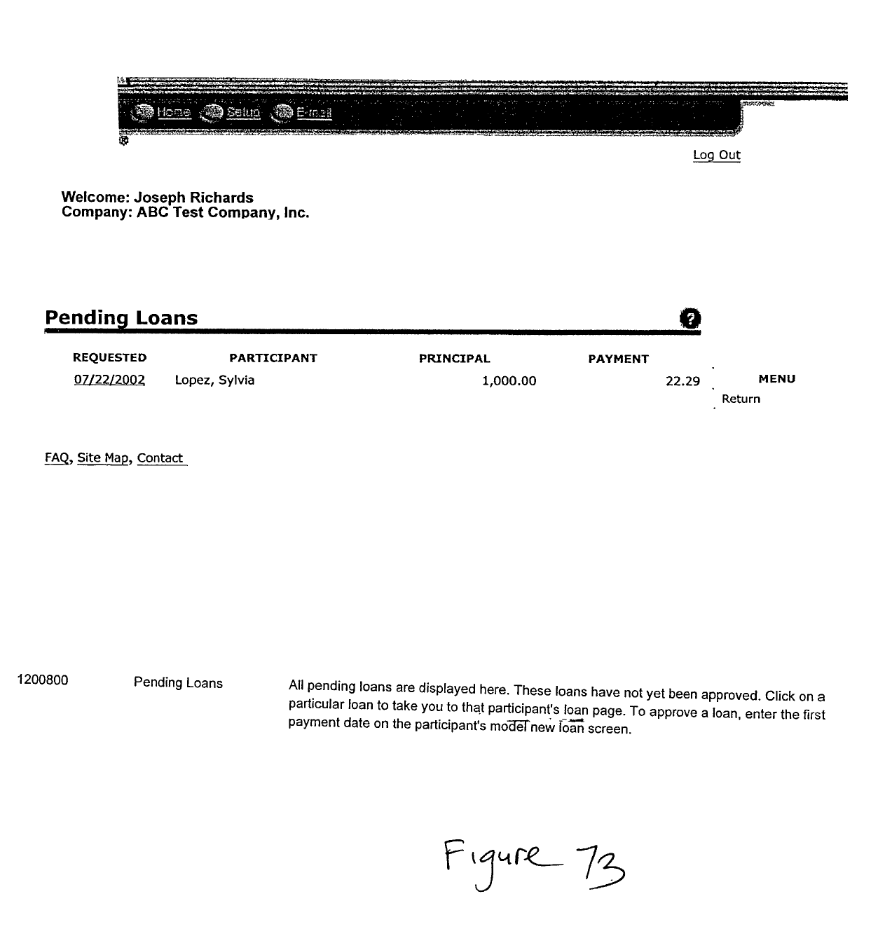

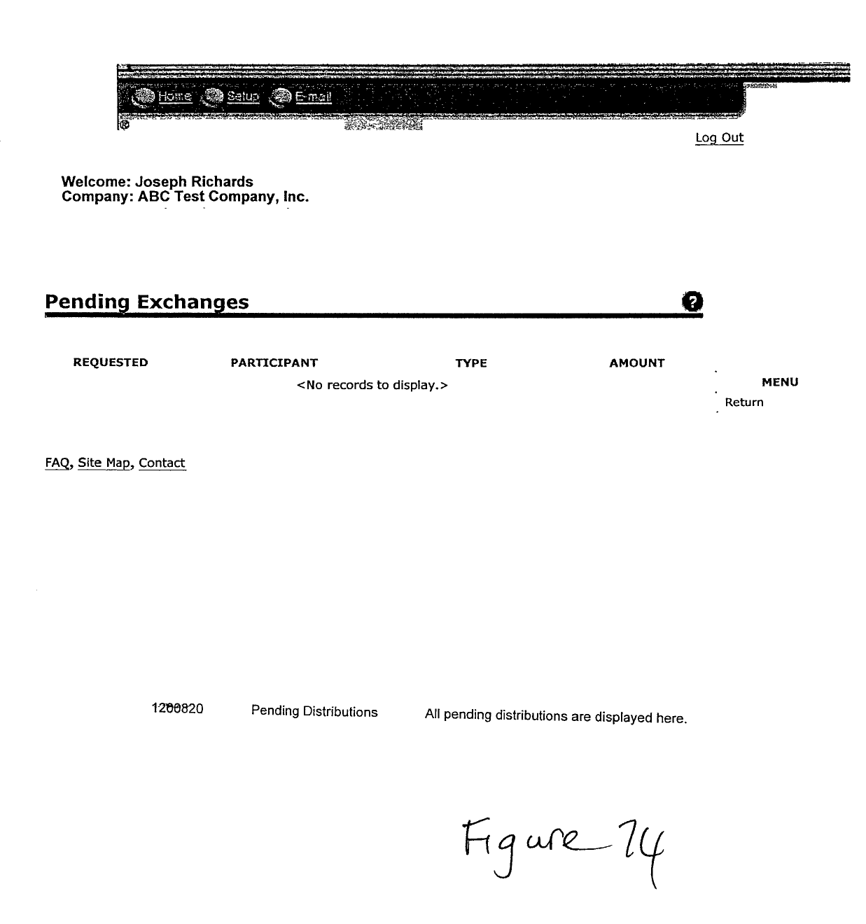

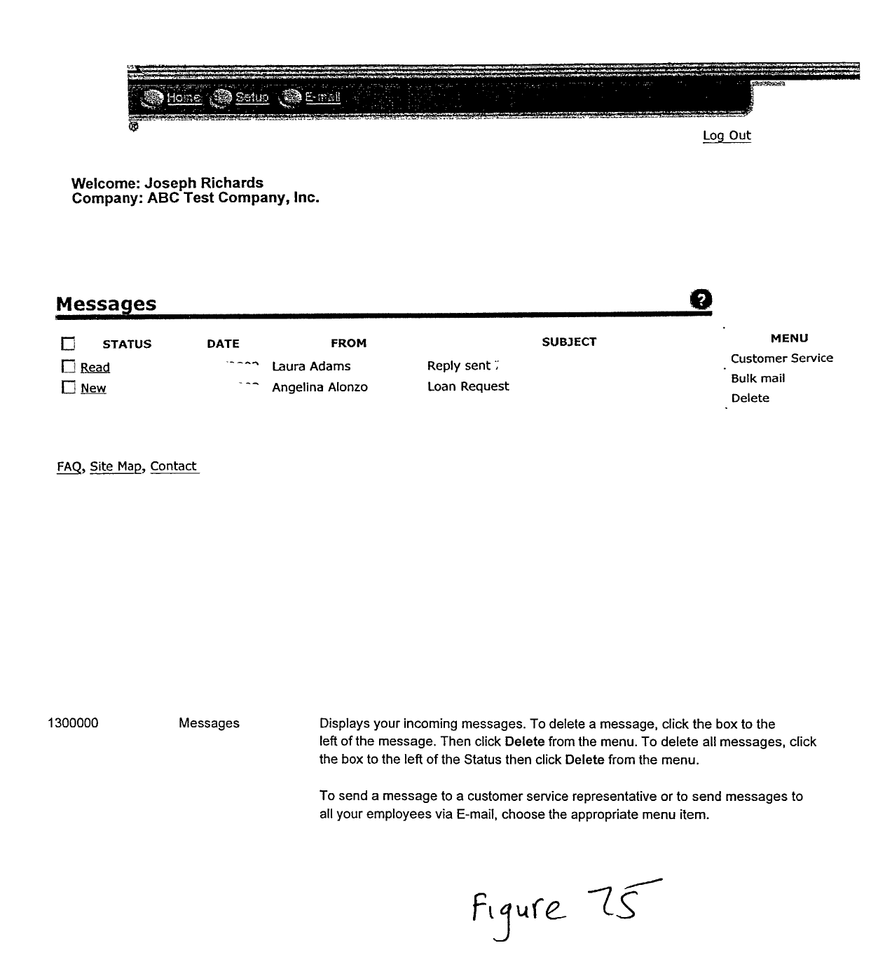

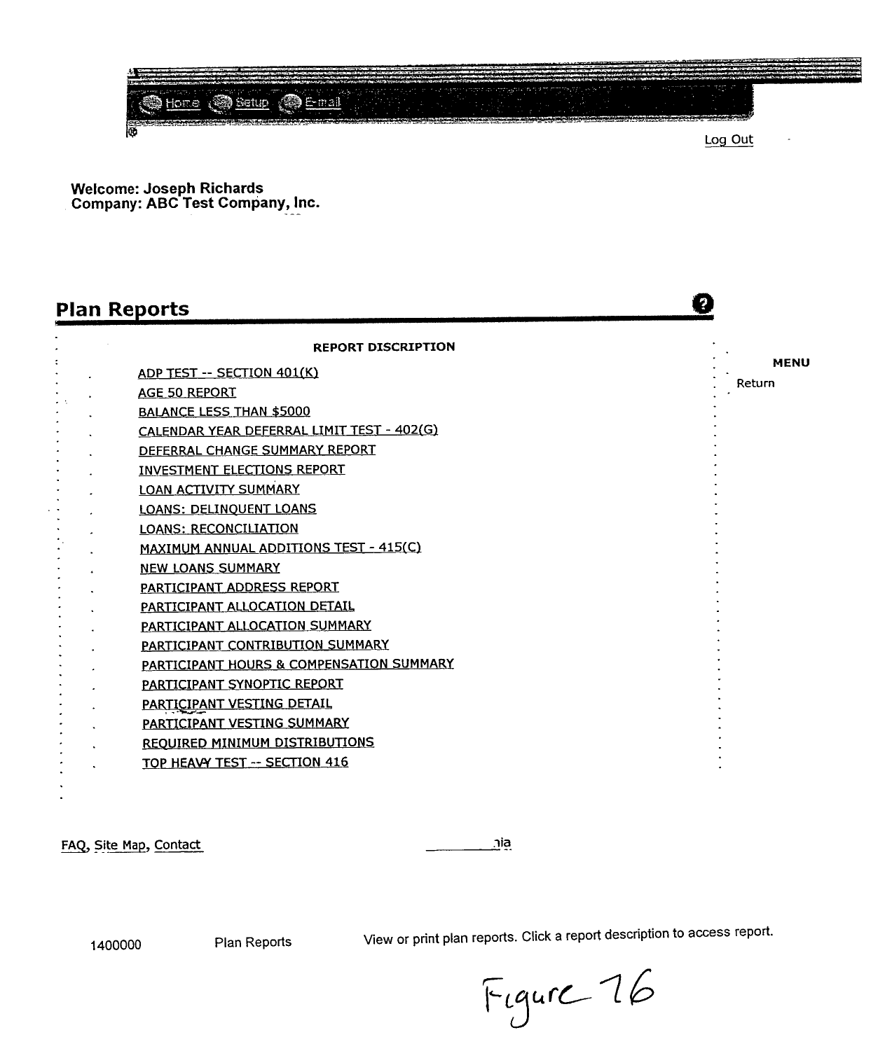

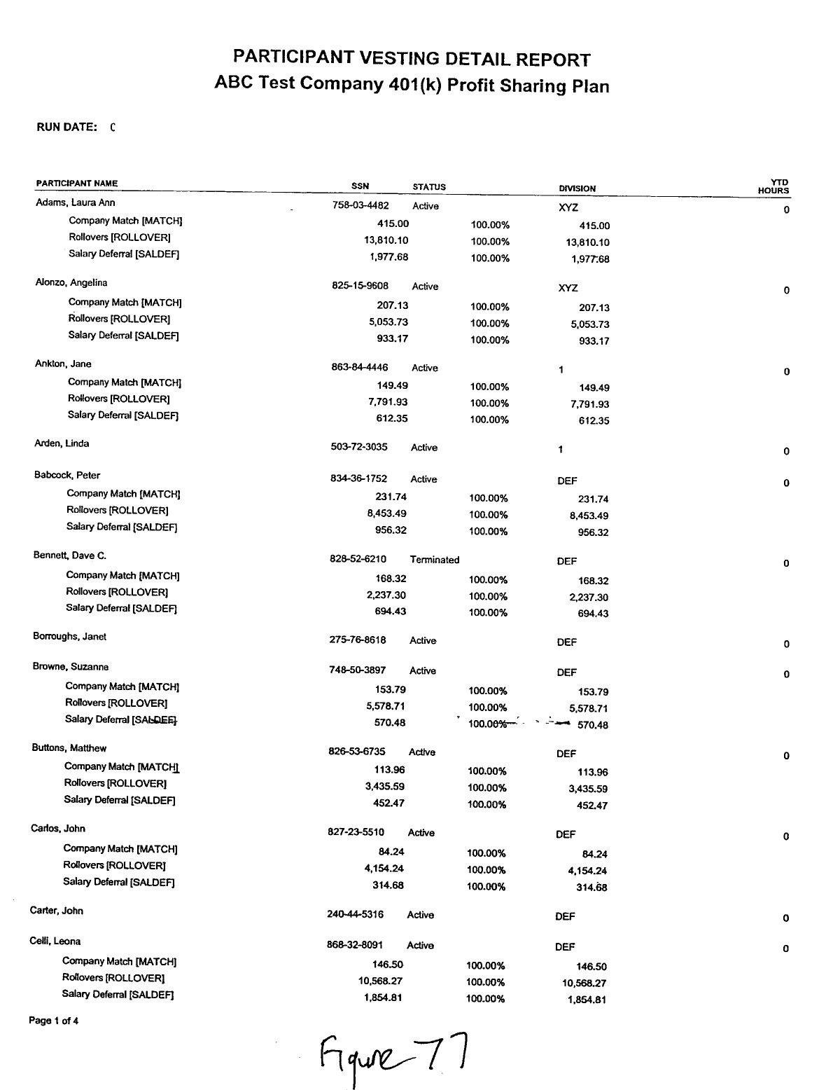

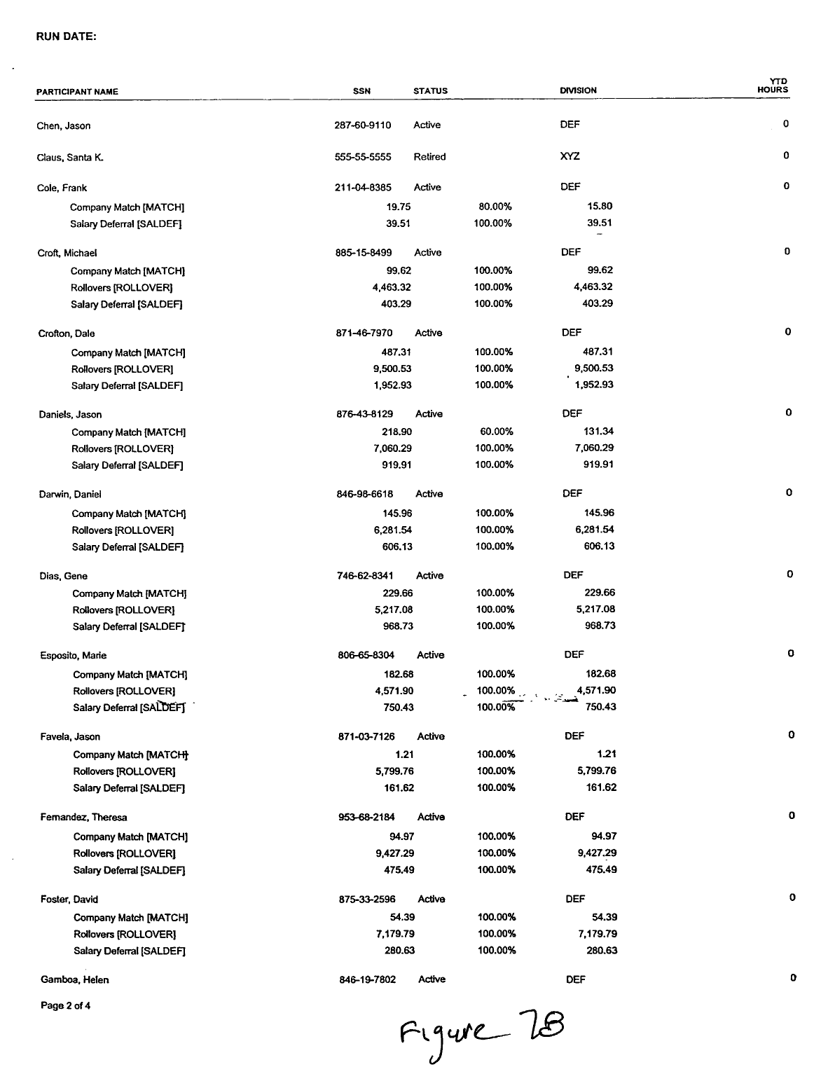

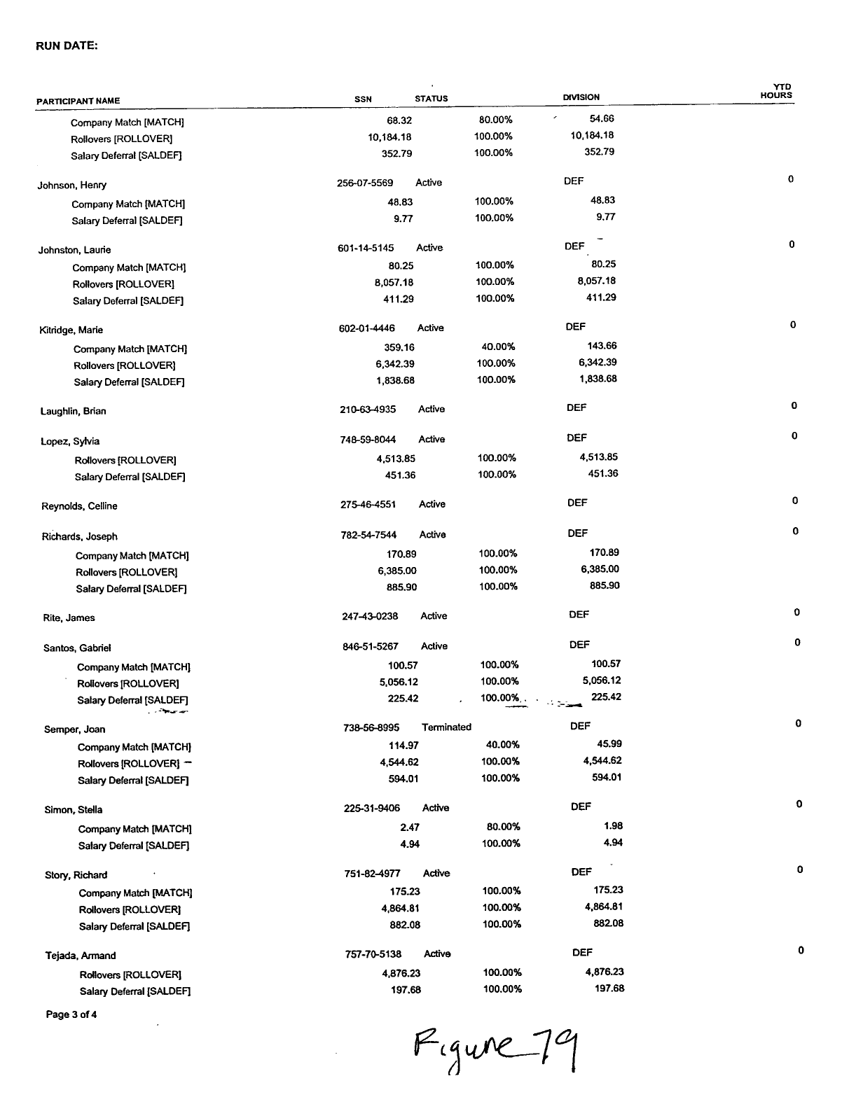

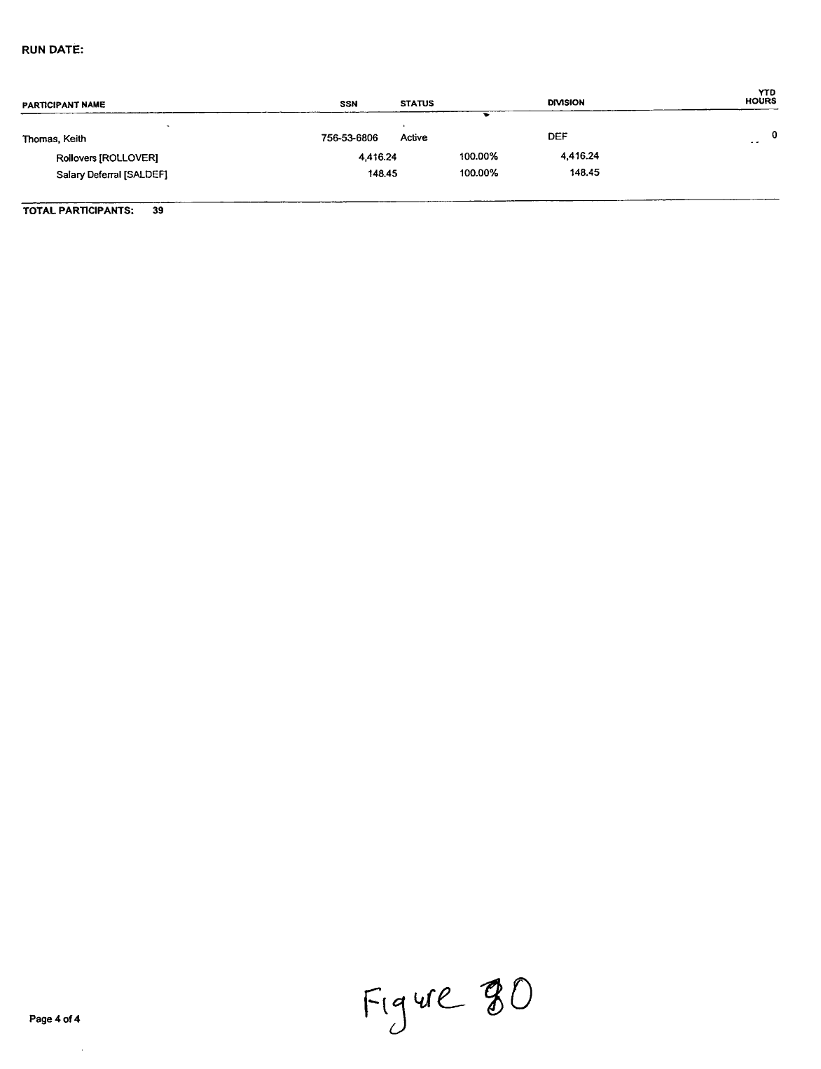

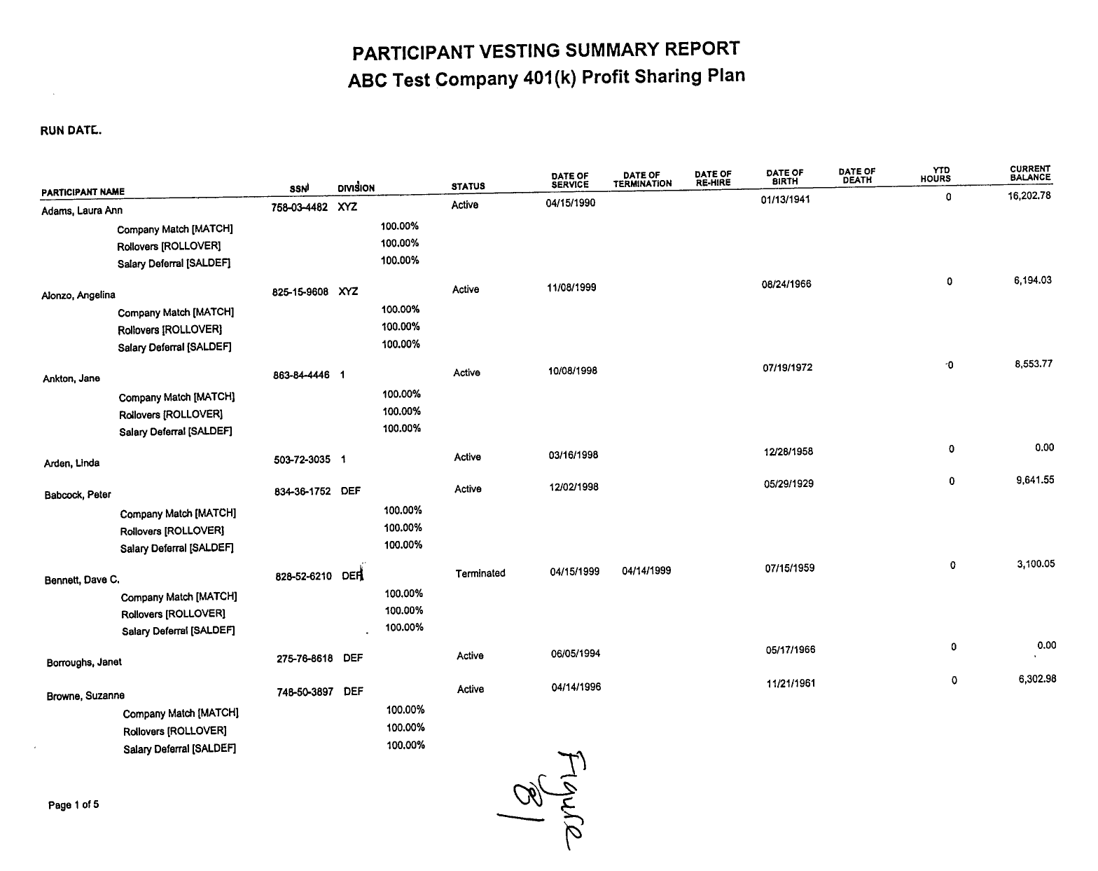

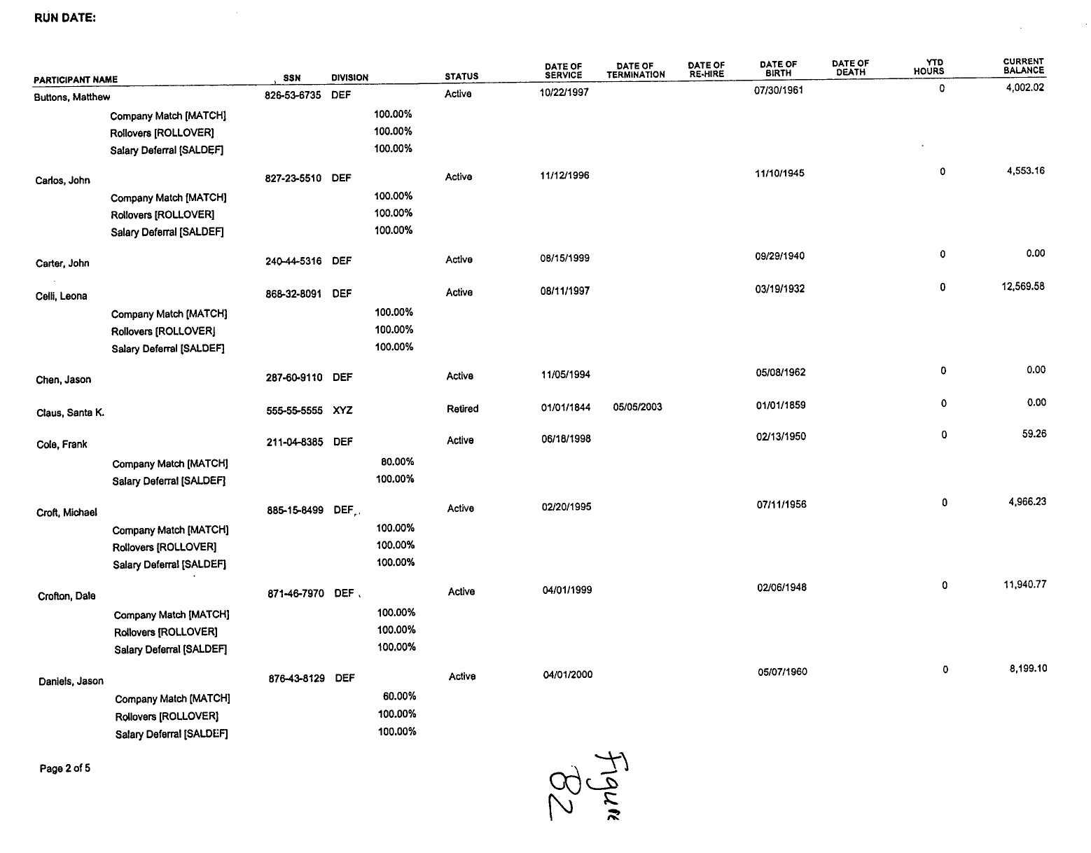

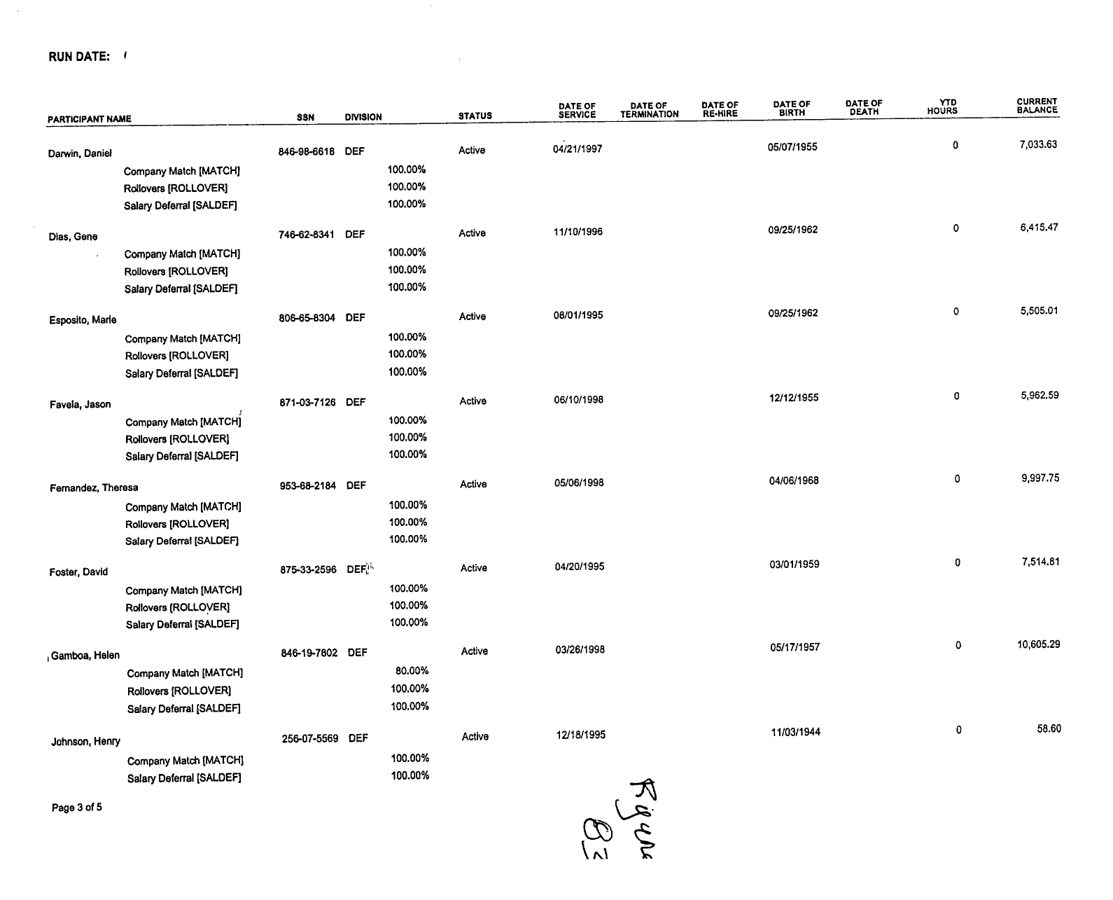

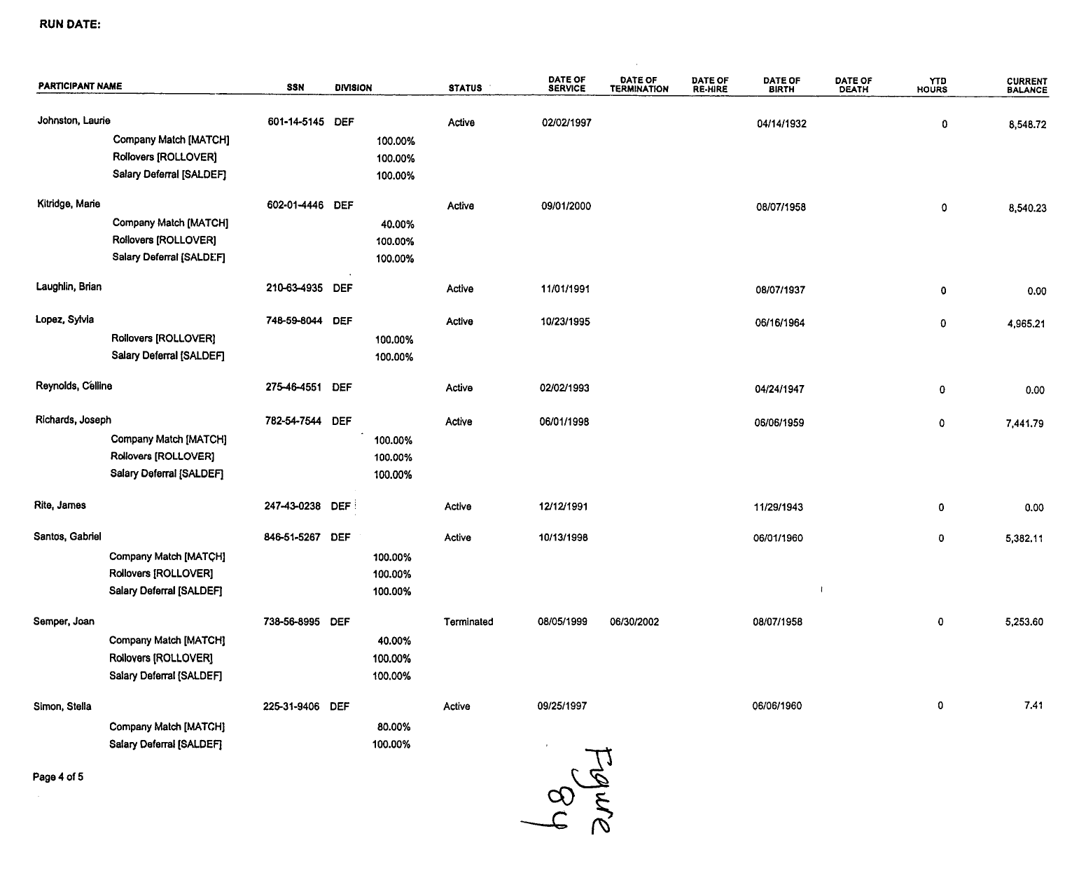

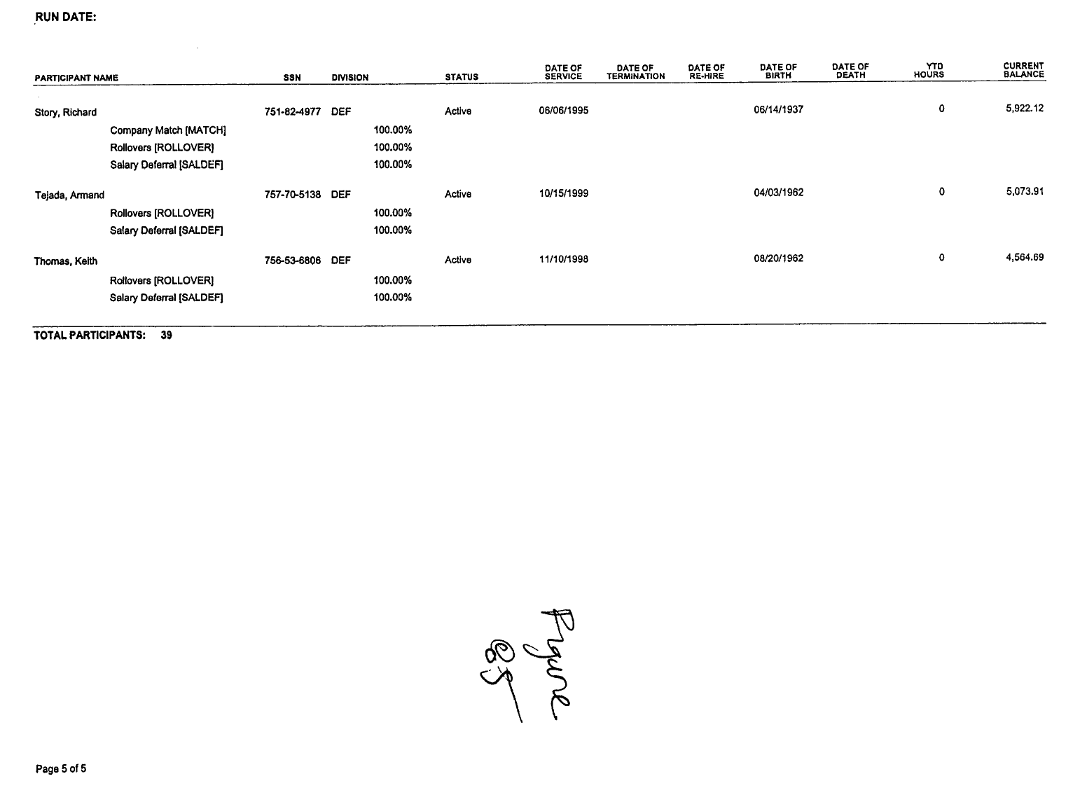

FIG. 72 illustrates a screenshot of the profit sharing interface (3736) for automatically calculating profit sharing contributions for participants. FIGS. 73 and 74 illustrate a screenshot of the pending loans interface (3738) and pending exchanges interface (3740). FIG. 75 illustrates a screenshot of the message interface (3742) for displaying incoming messages. FIGS. 76-85 collectively illustrate various screenshots of reports accessible via the reports interface (3744).

### Interfaces Associated with Employee/Participant

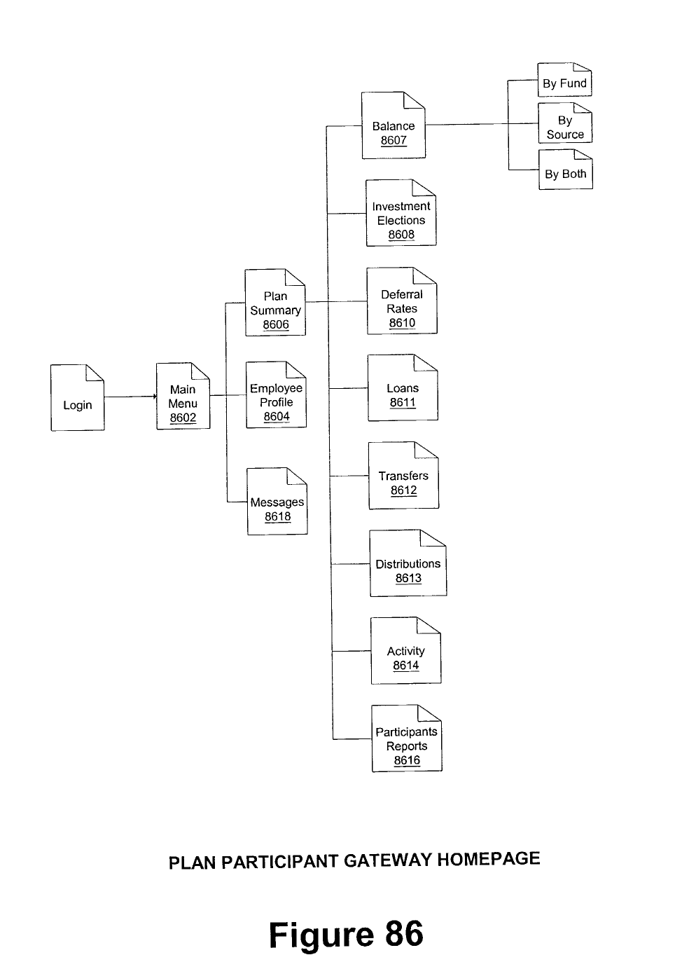

FIG. 86 illustrates the various interfaces associated with the employee/participant interface. The employee/participant log in via an initial login interface (8601) using his/her log in name and pin code. Upon authentication, he/she is directed to the plan participant home page (8602), whereupon participants are able to navigate to any of the following interfaces: plan summary interface (8606), employee profile interface (8604), and messages interface (8618). From the plan summary interface (8606), participants are able to navigate to any of the following interfaces: balance interface (8607), investment elections interface (8608), deferral rates interface (8610), loans interface (8611), transfers (8612), distributions interface (8613), activity interface (8614), and participant reports interface (8616).

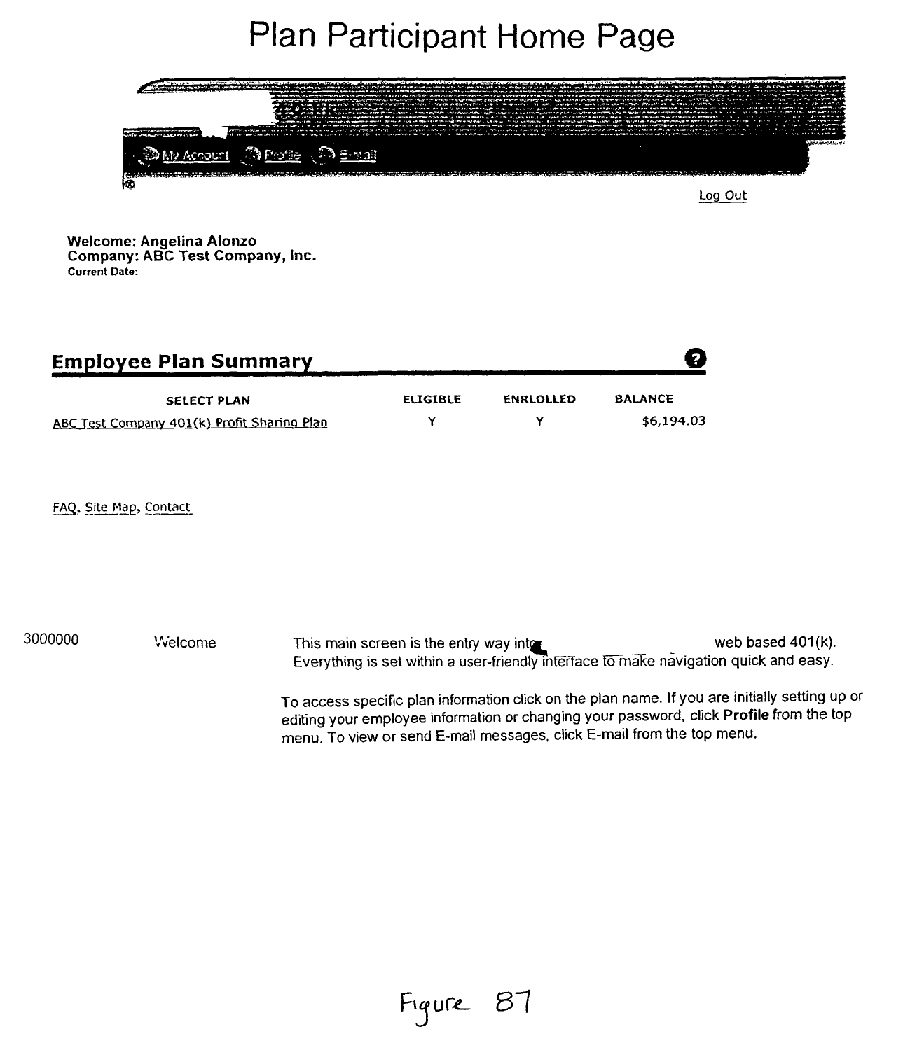

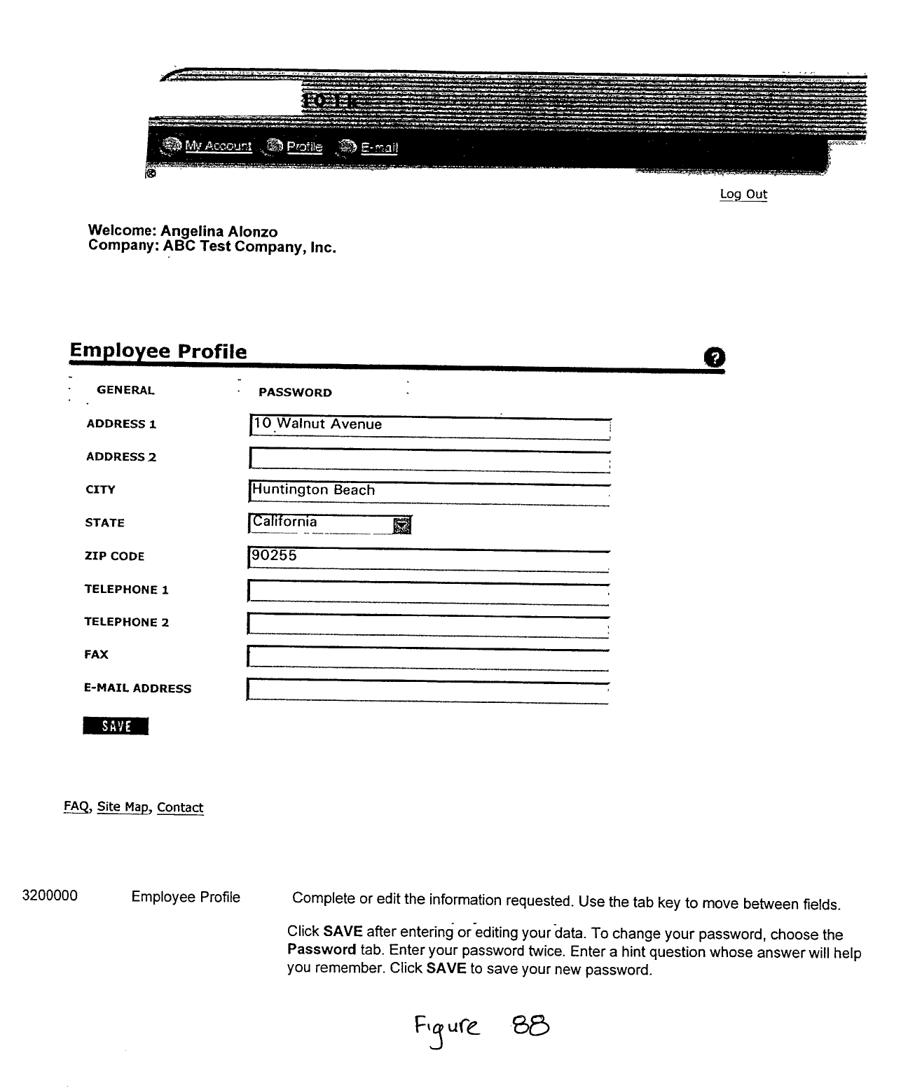

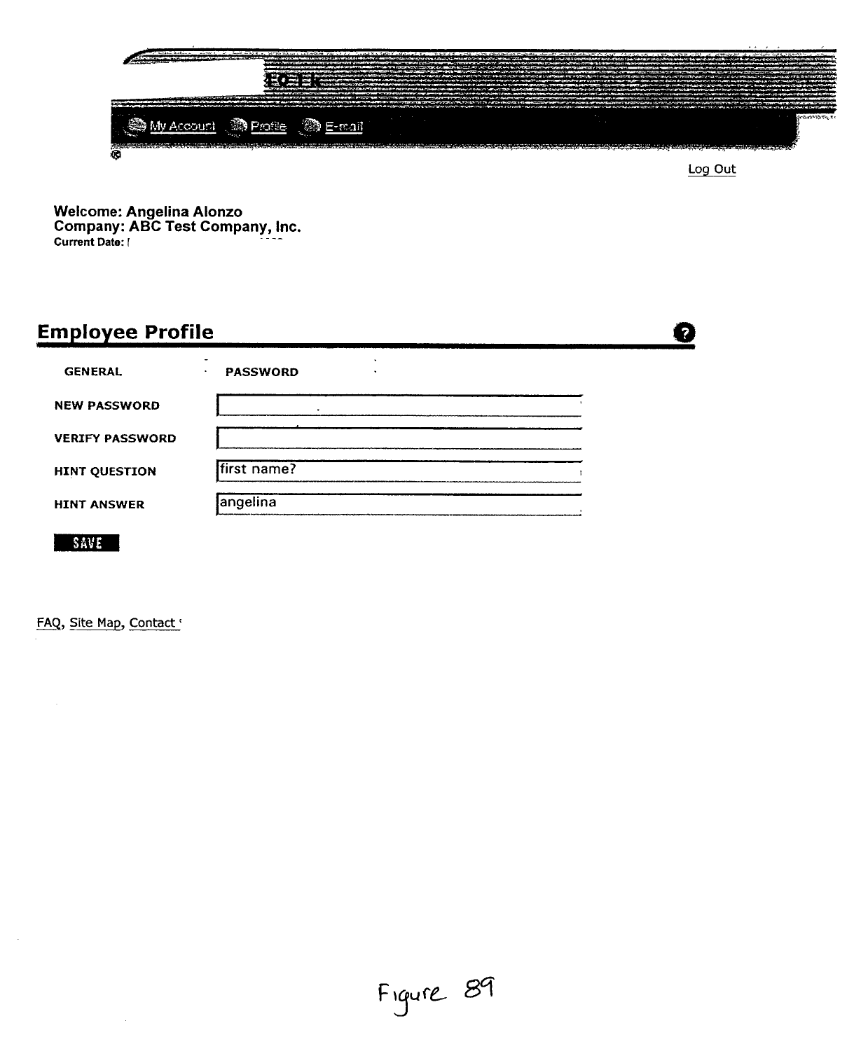

FIG. 87 illustrates a screenshot of the employee/participant main interface (8602). The main interface (8602) provides participants with an entryway to the web-based 401(k) system. The plan name can be clicked to access specific plan information. FIGS. 88-89 provides for a screenshot of the employee profile interface (8604). Using this interface, an employee's profile can be updated.

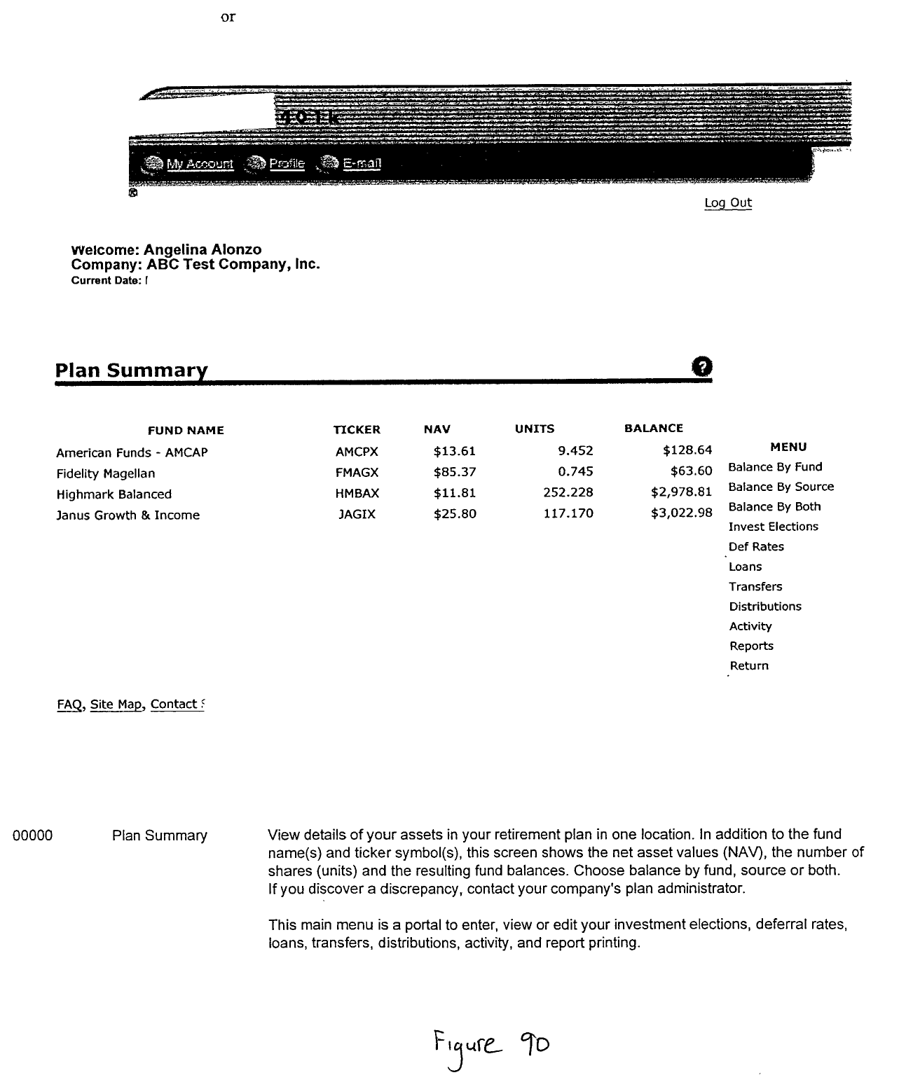

FIG. 90 illustrates a screenshot of the plan summary interface (8606). This interface (8606) allows participants to view details of assets in their retirement plan. In addition to the fund name(s) and ticker symbol(s), this screen shows the NAV, the number of shares (units), and the resulting fund balances. Additionally, the plan can be viewed via three options: balanced by fund, balanced by source, or balanced by both. Thus, the plan summary interface (8606) acts as a portal to enter, view, or edit investment elections, deferral rates, loans, transfers, distributions, activity, and report printing.

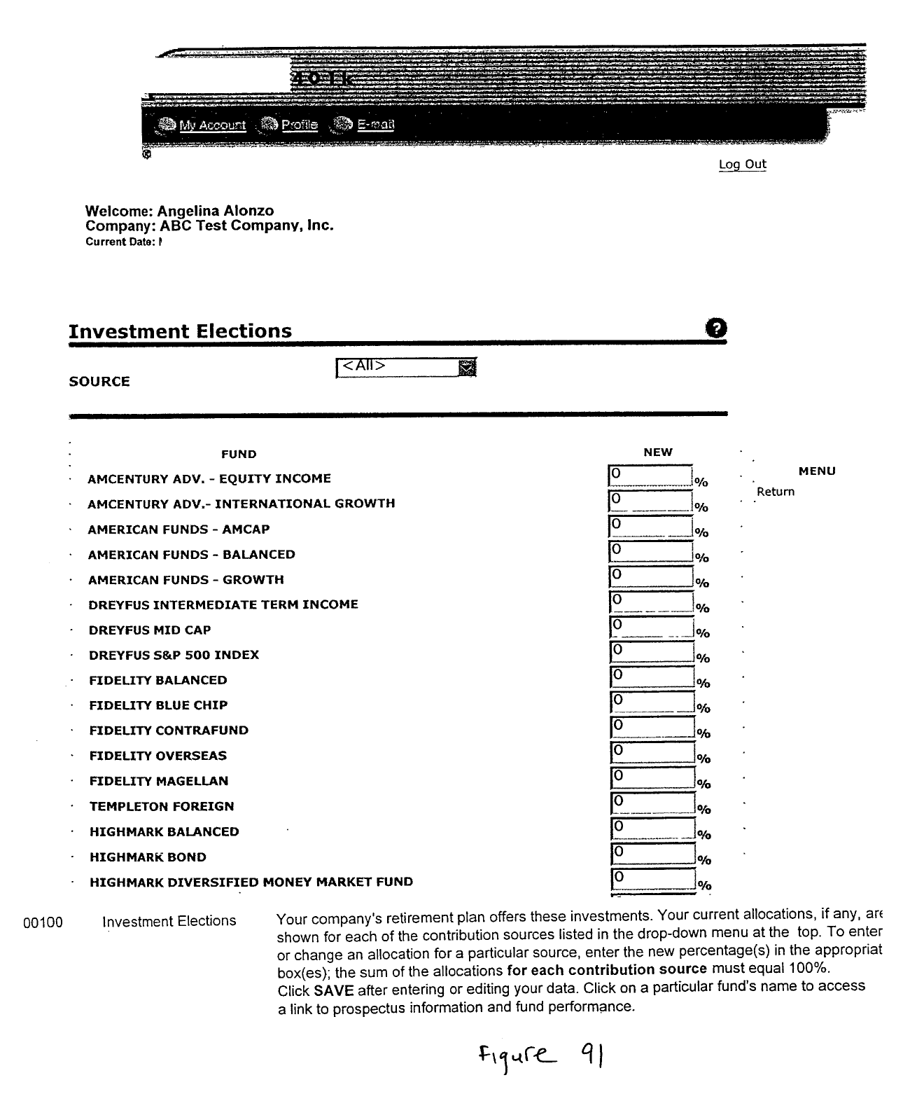

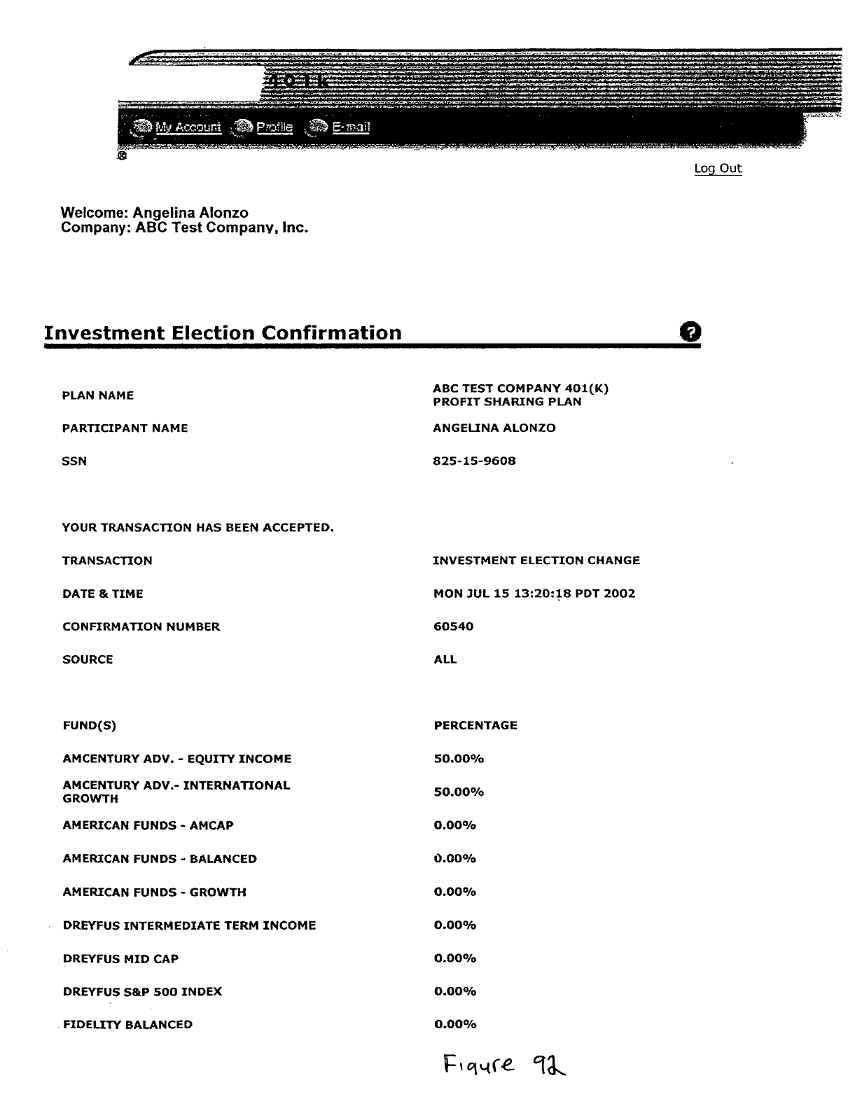

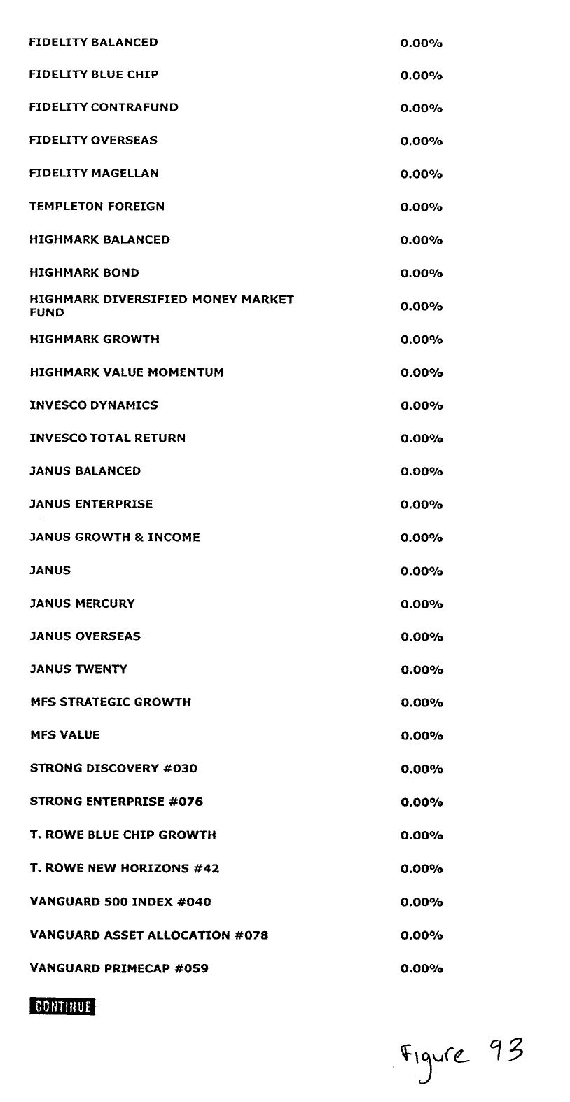

FIGS. 91-93 collectively illustrate screenshots of the investment interface (8608). The current allocations, if any, are shown in this interface (8608). To enter or change an allocation for a particular source, participants enter new percentages in the appropriate boxes.

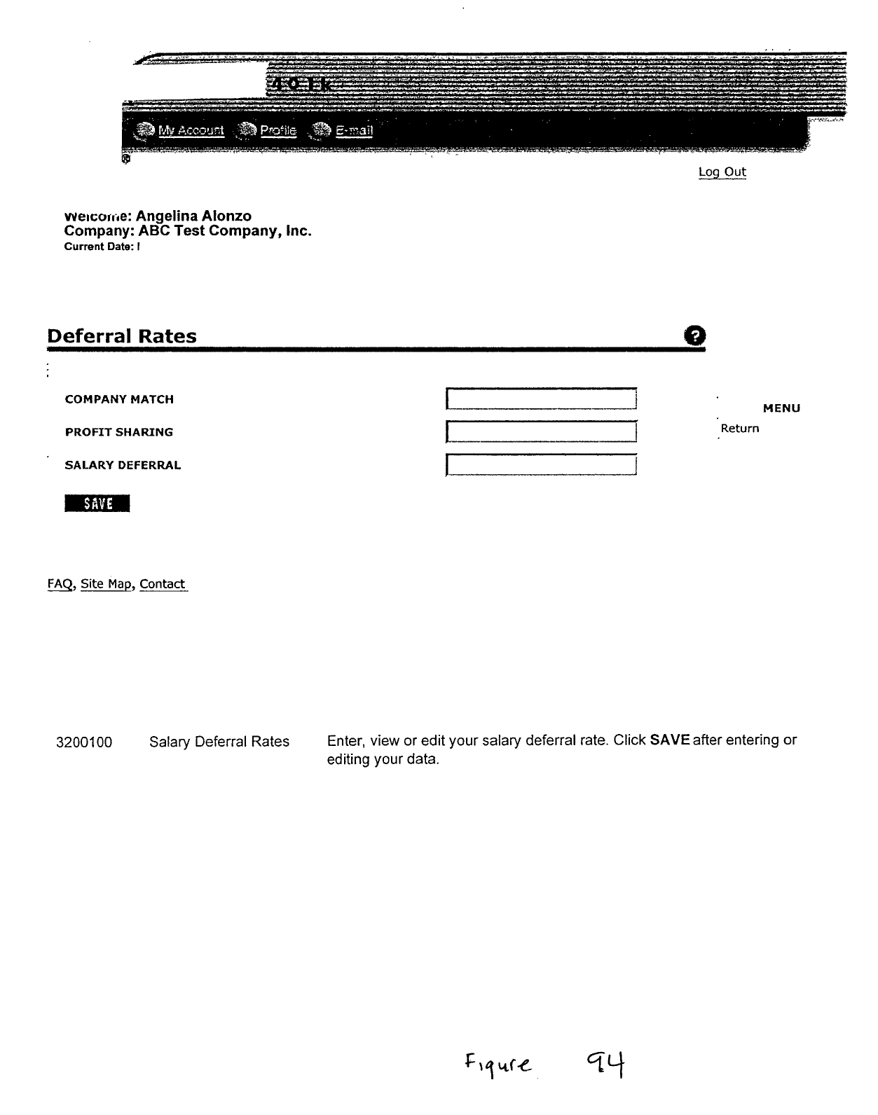

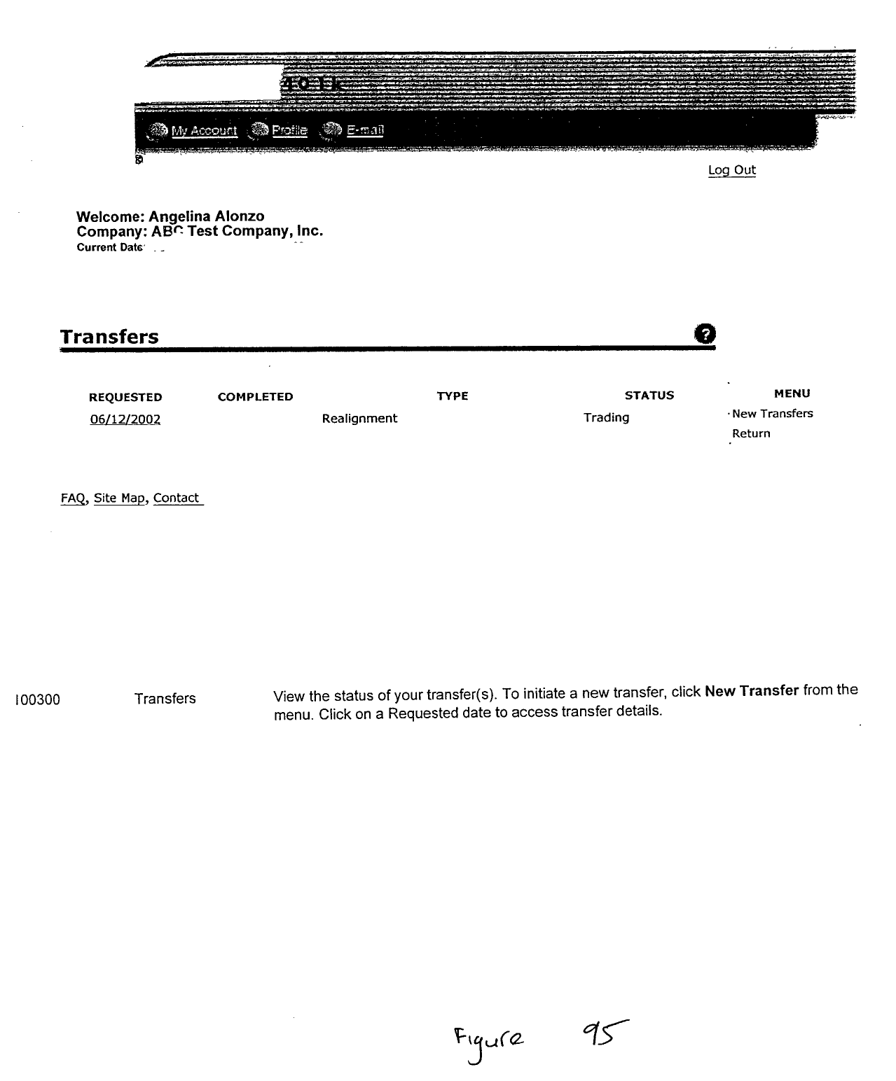

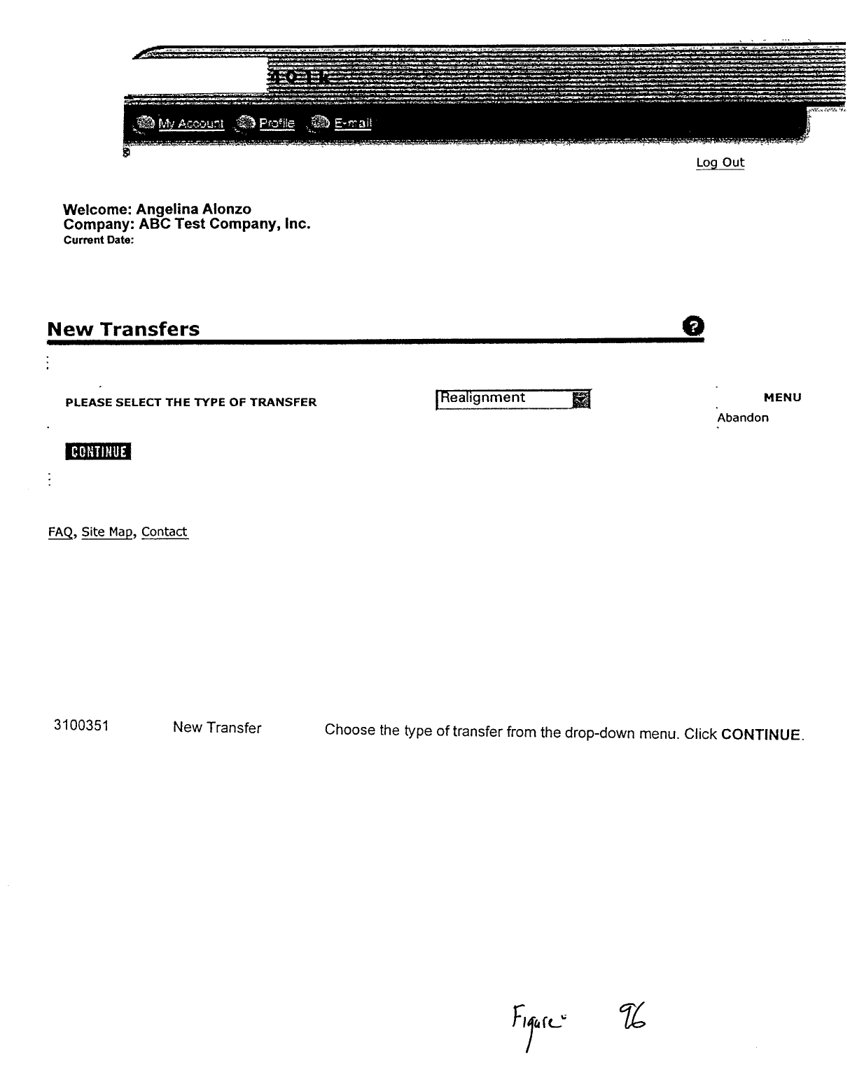

FIG. 94 illustrates a screenshot of the deferral rates interface (8610). This interface (8610) allows participants to enter, view, or edit their salary deferral rates. FIGS. 95-96 illustrate screenshots of the transfers interface (8612) that is used to view the current status of the transfer(s). It can be used to initiate new transfers.

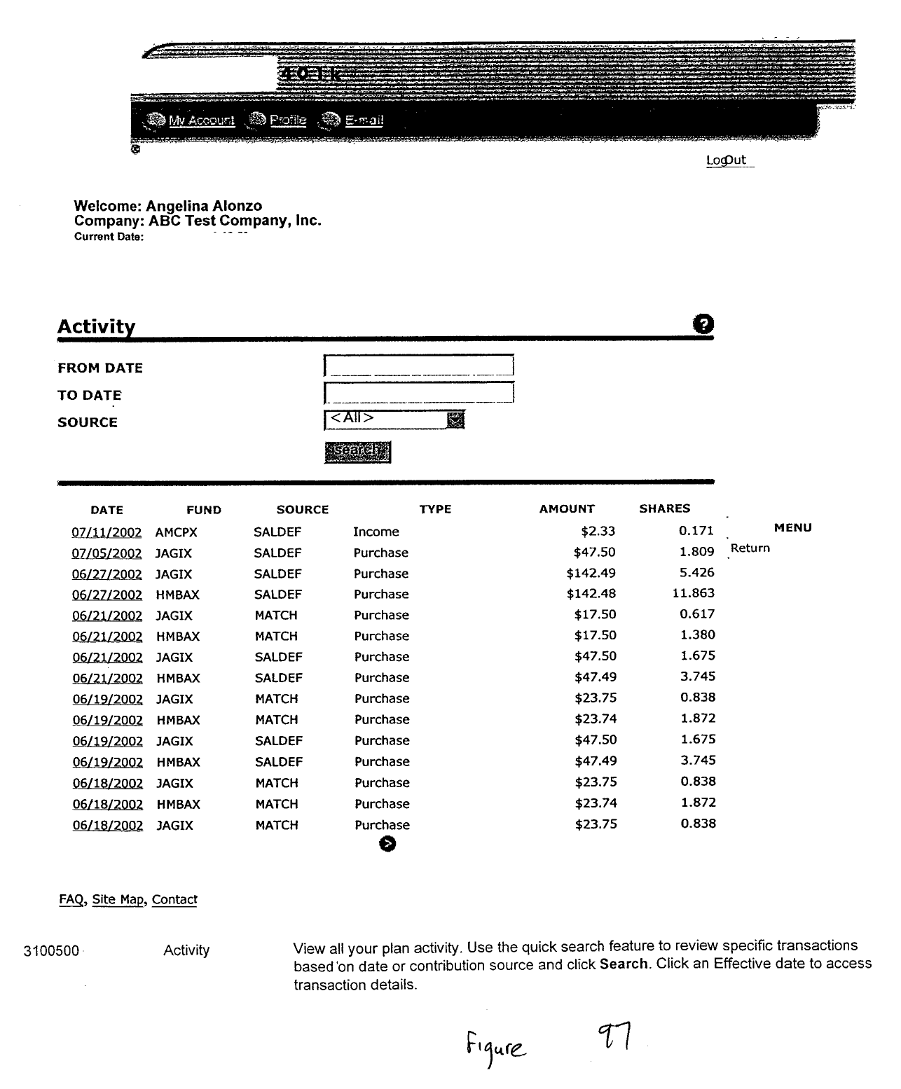

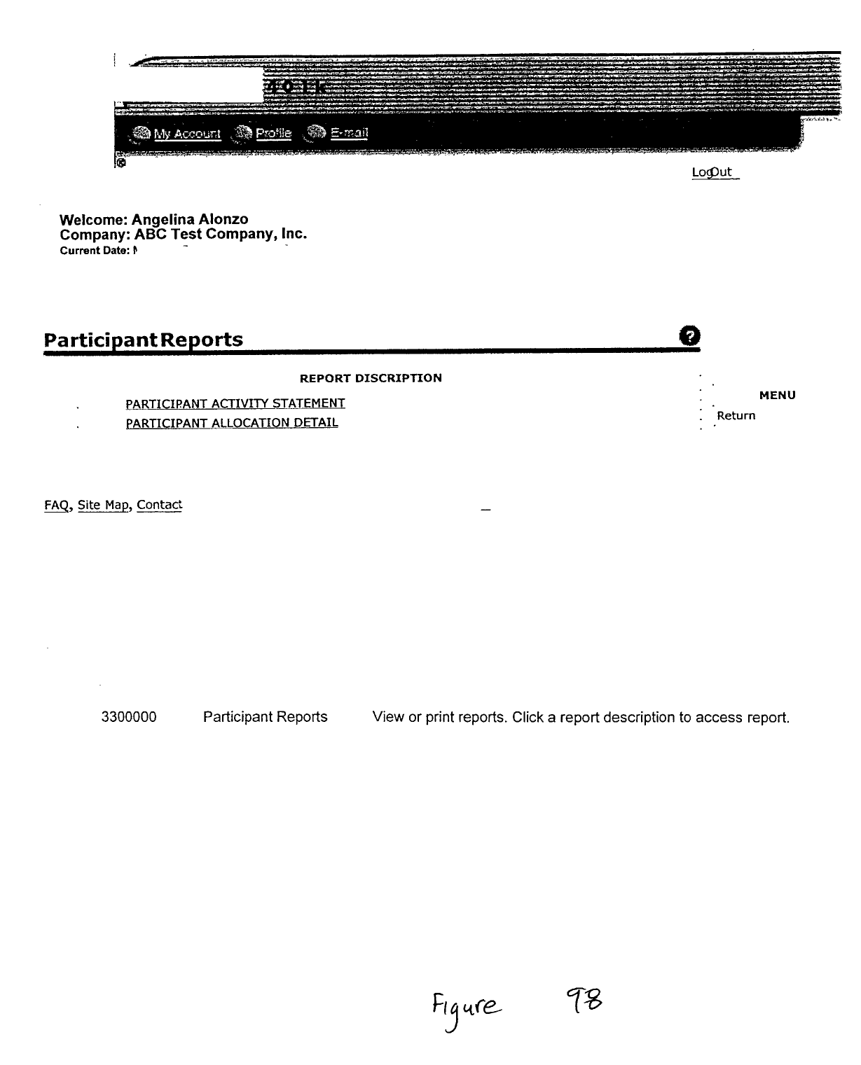

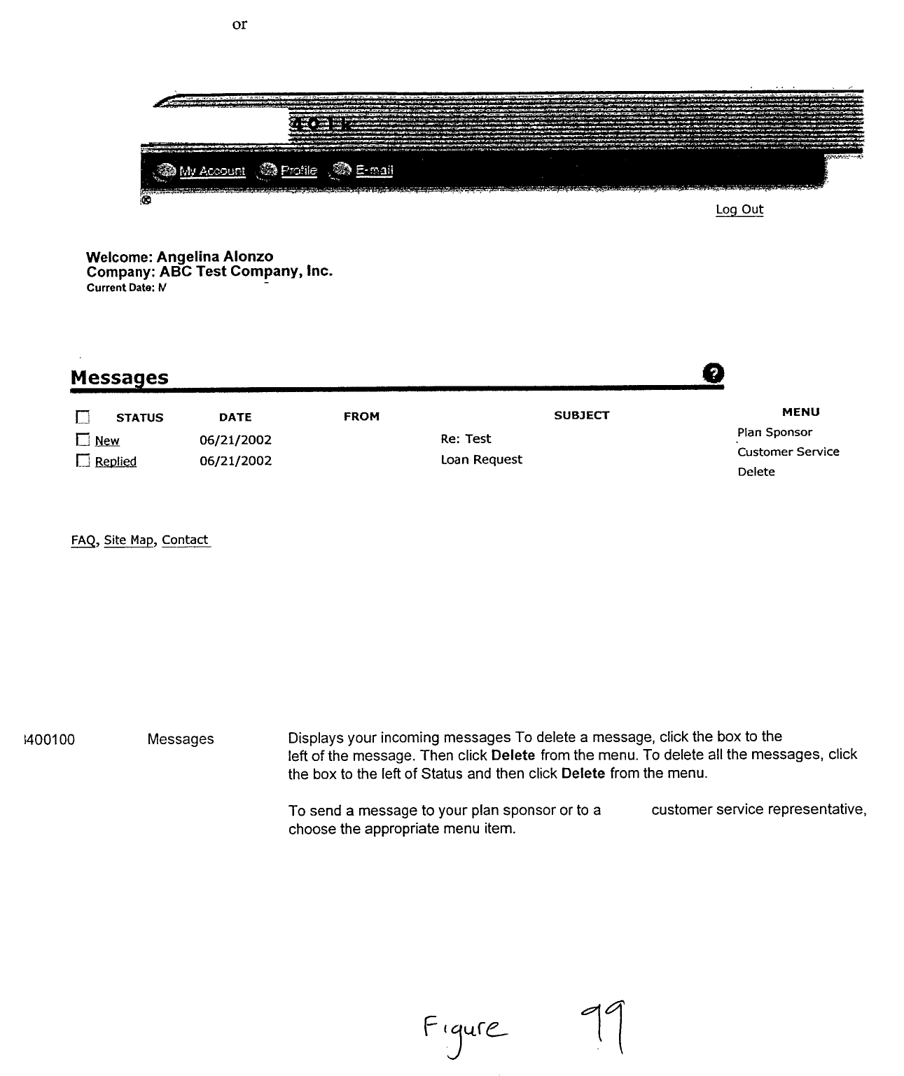

FIG. 97 illustrates a screenshot of the activity interface (8614) that is used to view all plan activities. Additionally, a quick search feature is used to review specific transactions based on date or contribution source. FIG. 98 illustrates a screenshot of the participant reports interface (8616) that is used to view or print reports associated with the participants (e.g., participant activity statement or participant allocation detail). FIG. 99 illustrates a screenshot of the messages interface (8618) that displays incoming messages. Messages can be sent from this interface to the plan sponsor or the customer service representative.

### Core Data Structure

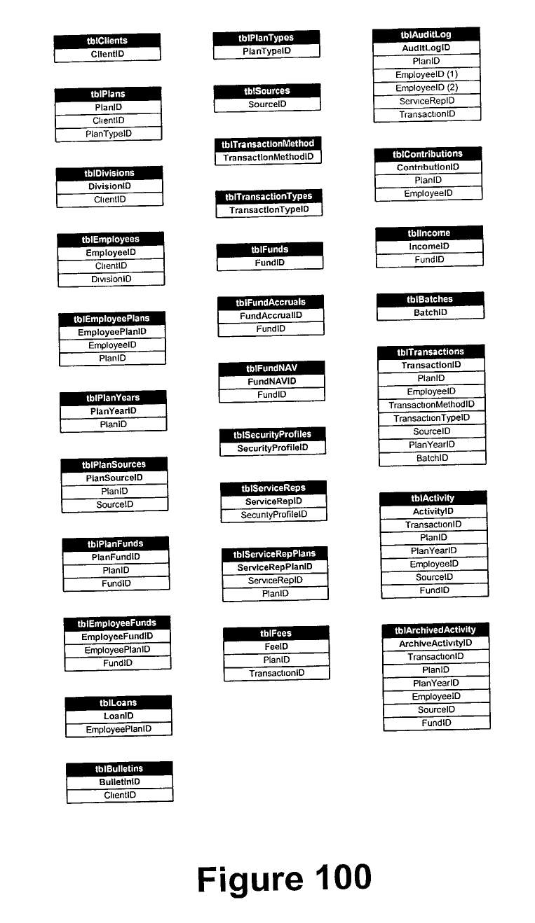

The core data structure illustrating the core tables used by the interface of the present invention is shown in FIG. 100.

This relational data structure has been designed to allow maximum system flexibility while still providing acceptable performance. In many cases, fields are replicated in certain tables to speed up query results—even though replication of these fields may seemingly contradict database “normalization” practices.

tblClients

Stores all necessary information for each client.

| | |
|---|---|
| Reference links: | <None> |

tblPlans

Stores all necessary information for each plan, including: the type of plan, fee information, inception date, vesting parameters, rules, etc.

| | |
|---|---|
| Reference links: | tblClients |
| tblPlanTypes | |

tblDivisions

Stores information for all divisions of each client, including: division name, address, primary contact, phone number, fax number, etc.

| | |
|---|---|
| Reference links: | tblClients |

tblEmployees

Stores information for all employees for each client, including: name, social security number, address, PIN Code, preferences, etc. Since employees are identified by a unique, system-assigned ID number, the same employee (identifiable by social security number) can be entered as an employee of multiple clients.

| | |
|---|---|
| Reference links: | tblClients |
| | tblDivisions |

tblEmployeePlans

Establishes relationship between employees and plans. Since employees can belong to more than one plan within their company (client), this table stores information showing which employees are enrolled into which plans.

| | |
|---|---|
| Reference links: | tblPlans |
| | tblEmployees |

tblPlanYears

Stores information about each plan year for each plan. Starting date and ending date for each plan year will be defined in this table. Short plan years will be allowed.

| | |
|---|---|
| Reference links: | tblPlans |

tblPlanSources

Defines which sources from tblSources are allowed within each plan. Also stores information about aging requirements (if any) for each source within each plan.

| | |
|---|---|
| Reference links: | tblPlans |
| | tblSources |

tblPlanFunds

Defines which funds from within the spectrum of funds (tblFunds) is allowed for use within each plan.

| | |
|---|---|
| Reference links: | tblPlans |
| | tblFunds |

tblEmployeeFunds

Stores allocation choices (Funds) for each employee within each plan. Employees can have different allocation choices for each plan in which they participate. This table also stores information required for the residual system, allowing automatic generation of residual distributions and transfers.

| | |
|---|---|
| Reference links: | tblEmployeePlans |
| | tblFunds |

tblLoans

Stores information for loans within each plan, including: principal, interest rate, duration, payment amount, etc.

| | |
|---|---|
| Reference links: | tblEmployeePlans |

tblBulletins

Stores bulletins entered for each client. Bulletins are visible upon login by employees and helps keep employees up to date on information regarding their plan(s).

| | |
|---|---|
| Reference links: | tblClients |

tblPlanTypes

Stores information on different plan types allowed by the system, including 401(k), money purchase, and profit sharing. Additional plan types can be added at any time.

| | |
|---|---|
| Reference links: | <None> |

tblSources

Stores information about money sources. Additional sources can be defined at any time.

| | |
|---|---|
| Reference links: | <None> |

tblTransactionMethods

Stores information about different transaction methods, such as: VRU, file import, manual input, etc.

| | |
|---|---|
| Reference links: | <None> |

tblTransactionTypes

Defines different types of transactions, such as: contribution processing, correction, loan payoff, partial payoff, update address, etc. Fees can be associated with each transaction type.

| | |
|---|---|
| Reference links: | <None> |

tblFunds

Stores information about the spectrum of funds offered by the bank, including: fund name, pet name, ticker, cusip, etc. Funds can be added, removed, or edited at any time.

| | |
|---|---|
| Reference links: | <None> |

tblFundAccruals

Stores daily accrual values for each fund. Ref. Links: tblFunds tblFundNAV stores daily net asset value information for each fund.

| | |
|---|---|
| Reference links: | tblFunds |

tblSecurityProfiles

Stores information and privileges associated with each security profile. Security profiles can be added and defined at any time.

| | |
|---|---|
| Reference links: | <None> |

tblServiceReps

Stores information about each customer service representative, including: name, security profile, etc. Customer service representatives can be added, deleted, or updated at any time.

| | |
|---|---|
| Reference links: | tblSecurityProfiles |

tblServiceRepPlans

Stores information about which plans each customer service representative is allowed to work with. “Superusers” will have the ability to work with all plans.

Linking to Clients would ensure single point-of-contact for all of a single clients' plans; however, linking to plans would allow different service representatives who are specifically trained in managing certain types of plans.

| | |
|---|---|
| Reference links: | tblServiceReps |
| | tblPlans |

tblFees

Stores information about fees posted to each plan and specifies the transaction for which the fee was posted.

| | |
|---|---|
| Reference links: | tblPlans |
| | tblTransactions |

tblAuditLog

Stores a detailed log of all activities that have been performed through the system, including: logins, logouts, processing, etc. Any activity that affects the system or the database will automatically be logged. The date and time of each activity will be logged.

| | |
|---|---|
| Reference links: | tblPlans |
| | tblEmployees |
| | tblServiceReps |
| | tblTransactions |

TblContributions

Stores detailed information about contributions made by each employee for the given plan. This is where the gross amounts will be stored before they are broken into individual allocations.

| | |
|---|---|
| Reference links: | tblPlans |
| | tblEmployees |

tblIncome

Income posted against each fund will be stored in this table before it is allocated through the income allocation algorithm.

| | |
|---|---|
| Reference links: | tblFunds |

tblBatches

All information exported to the VMS (or other) system(s) will be organized into batches. Information related to each batch that is exported will be stored here.

| | |
|---|---|
| Reference links: | <None> |

tbITransactions

Detailed information for each system transaction will be stored in this table.

| | |
|---|---|
| Reference links: | tblTransactionMethods |
| | tblTransactionTypes |
| | tblPlans |
| | tblEmployees |
| | tblSources |
| | tblPlanYears |
| | tblBatches |

tblActivity

Detailed information for each allocation/transaction that affects an employees' account balance in any way will be stored in this table. This table will be the main table that allows the calculation and reporting of account activity, balances, etc.

Since we are linking each activity record with an associated record in the tblTransactions table, the PlanID and EmployeeID fields are redundant; however, since the tblActivity table will be accessed very heavily, repetition of these fields will greatly improve system performance.

All required information will be stored including:

| | |
|---|---|
| | PlanID |
| | EmployeeID |
| | FundID |
| | TransactionID |
| | LoanID (for loan related activity) |
| | NAV |
| | Source |
| | “As Of” or “Effective” Date |
| | Trade Date |
| | Settlement Date |
| | Amount |
| | Shares |
| | Description |
| Reference links: | tblTransactions |
| | tblPlans |
| | tblEmployces |
| | tblSources |
| | tblFunds |
| tblArchivedActivity | |

Records will be transferred to this table from the tblActivity table when they pass beyond the user-defined archive period. Transferring information to an archival table will greatly increase system performance.

| | |
|---|---|
| Reference links: | tblTransactions |
| | tblPlans |
| | tblEmployees |
| | tblSources |
| | tblFunds |

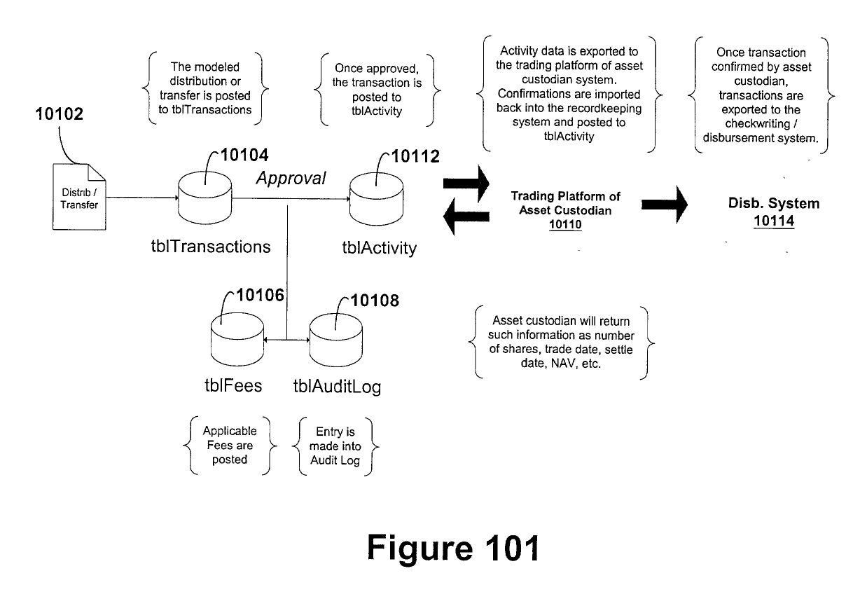

FIG. 101 illustrates an example of how the data structure of FIG. 100 is utilized for distributions and transfers. In this example, the modeled distribution or transfer 10102 is posted to the data structure—tblTransactions 10104. Additionally, any applicable fees are identified and posted to the data structure—tblFees 10106. An entry is also made in the audit log portion of the data structure—tblAuditLog 10108. Activity data is then exported to the trading platform of the asset custodian system 10110. Confirmations are imported back into the record keeping system and posted to the data structure—tblActivity 10112. Lastly, once the transactions are confirmed by the asset custodian 10110, transactions are exported to the check writing/disbursement system 10114. Asset custodian 10110 returns information such as, but not limited to: number of shares, trade date, settle date, or NAV.

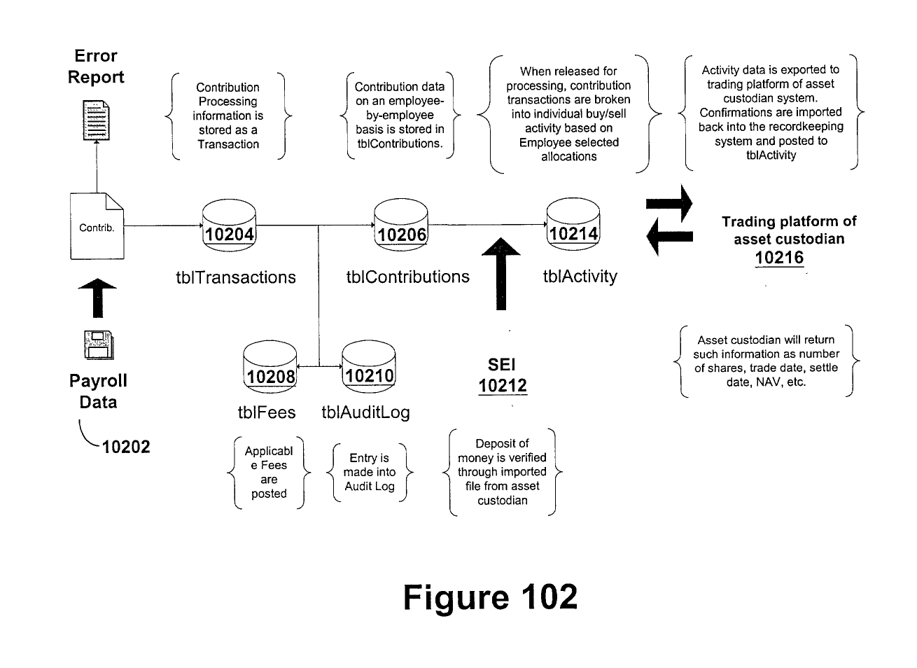

FIG. 102 illustrates an example of how the data structure of FIG. 100 is utilized for processing contributions. In this example, contribution information is extracted from payroll data 10202 and the contribution-processing information is stored as a transaction in the data structure—tblTransactions 10204. Additionally, contribution data on an employee-by-employee basis is stored in the data structure—tblContributions 10206. As in the example described in FIG. 10, applicable fees are posted in the data structure—tblFees 10208, and entries are made into the audit log by posting to the data structure—tblAuditLog 10210. Furthermore, upon verification (through an imported file from SEI 10212) of the deposited money, contributions are broken into individual buy/sell activity based on employee-selected allocations. Finally, activity data is exported to the trading platform of the asset custodian 10216, wherein confirmations are imported back into the record keeping system and posted to the data structure—tblActivity 10214. Just as in the example in FIG. 100, the asset custodian 10216 returns information such as, but not limited to: number of shares, trade date, settle date, or NAV.

The present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM or any other appropriate static or dynamic memory, or data storage devices.

Implemented in computer program code-based products are software modules implementing an interface that provides for real/near real-time access and management of retirement accounts (such as 401(k) accounts) over a network.

### Conclusion

A system and method has been shown in the above embodiments for the effective implementation of interfaces for the management of retirement accounts over a network. While various preferred embodiments have been shown and described, it will be understood that there is no intent to limit the invention by such disclosure but, rather, is intended to cover all modifications and alternate constructions falling within the spirit and scope of the invention, as defined in the appended claims. For example, the present invention should not be limited by software/program, computing environment, number of gateways, number of clusters or servers, or type of network.

The above enhancements are implemented in various computing environments. For example, the present invention may be implemented on a conventional IBM PC, mainframe, or equivalents, multi-nodal system (e.g., LAN) or networking system (e.g., Internet, WWW, wireless web). All programming, GUIs, display panels and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of graphics, object-oriented programming, Java, ColdFusion, etc.

1. A plurality of specialized interfaces interacting with a plurality of specialized gateways and providing plan provider representatives, plan sponsor representatives, and plan participants with access to a network-based retirement funds management system, said interfaces assisting in the management of retirement funds, said interfaces comprising:
a. a plan provider interface receiving inputs from said plan provider representatives and based on said received inputs performing, via instructions to a plan provider gateway, a plan sponsor gateway, or a plan participant gateway, any of, or a combination of, the following tasks: perform all plan maintenance, approve and modify plan sponsor settings and plan settings, process corrections and adjustments, review audit trail of transactions and activities for each plan, activate and/or suspend plans, enter system-wide bulletins to plan sponsors and/or participants via internal system e-mail, set fees and charges, maintain a spectrum of all available investments and funds, process and distribute income and dividends to participants' accounts across all plans, and review system logs;
b. a plan sponsor interface receiving inputs from said plan sponsors and based on said received inputs performing, via instructions to said plan sponsor gateway or a plan participant gateway, any of, or a combination of, the following tasks: setup and maintain client information, setup and maintain multiple concurrent plans, define fund availability, process plan activity, approve plan activity, administer plan activity, review fees and changes, enter company bulletins for plan participants via internal system e-mail, generating an e-mail message to plan sponsor's internal and external e-mail addresses regarding pending transactions that require plan sponsor approval, and perform compliance testing and corrections; and
c. a plan participant interface receiving inputs from said plan participants and based on said received inputs performing, via instructions to said plan participant gateway, any of, or a combination of, the following tasks: updating information associated with said participants, updating personal investment designations, view and print personal account statement or personal activity reports, sending messages to plan sponsor internal e-mail address, and monitoring, modeling and applying for retirement plan loans, transfers, and distribution.

2. A plurality of specialized interfaces interacting with a plurality of specialized gateways, as per claim 1, wherein said management of retirement funds is done in real-time.

3. A plurality of specialized interfaces interacting with a plurality of specialized gateways, as per claim 1, wherein said management of retirement funds is done in near real-time.

4. A plurality of specialized interfaces interacting with a plurality of specialized gateways, as per claim 1, wherein said interfaces are implemented via any of the following architectures: Java, .NET, or COM+.

5. A plurality of specialized interfaces interacting with a plurality of specialized gateways, as per claim 1, wherein said interfaces are rendered via an industry standard browser.

6. A plurality of specialized interfaces interacting with a plurality of specialized gateways, as per claim 1, wherein said plan sponsor interface performing compliance testing renders results associated with any of the following compliance tests: 402(g), 401(k), 401(m), 415, multiple use test, top heavy test, coverage test, and compensation test.

7. A plurality of specialized interfaces interacting with a plurality of specialized gateways, as per claim 1, wherein said network is any of the following: local area network (LAN), wide area network (WAN), or the Internet.

8. A plurality of specialized interfaces interacting with a plurality of specialized gateways, as per claim 1, wherein said retirement funds are funds associated with any of the following: 401(k) plan, money purchase plan, or profit sharing plan.

9. An article of manufacture comprising a computer usable medium having computer readable program code embodied therein for generating a plurality of specialized interfaces capable of interacting with a plurality of specialized gateways and providing plan provider representatives, plan sponsor representatives, and plan participants with access to a network-based retirement funds management system, said interfaces assisting in the real-time management of retirement funds, said medium comprising:
a. computer readable program code implementing a plan provider interface capable of receiving inputs from said plan provider representatives and based on said received inputs performing, via instructions to a plan provider gateway, a plan sponsor gateway, or a plan participant gateway, any of, or a combination of, the following tasks: perform all plan maintenance, approve and modify plan sponsor settings and plan settings, process corrections and adjustments, review audit trail of transactions and activities for each plan, activate and/or suspend plans, enter system-wide bulletins to plan sponsors and/or participants via internal system e-mail, set fees and charges, maintain a spectrum of all available investments and funds, process and distribute income and dividends to participants' accounts across all plans, and review system logs;
b. computer readable program code implementing a plan sponsor interface receiving inputs from said plan sponsors and based on said received inputs performing, via instructions to said plan sponsor gateway or a plan participant gateway, any of, or a combination of, the following tasks: setup and maintain client information, setup and maintain multiple concurrent plans, define fund availability, process plan activity, approve plan activity, administer plan activity, review fees and changes, enter company bulletins for plan participants via internal system e-mail, generating an e-mail message to plan sponsor's internal and external e-mail addresses regarding pending transactions that require plan sponsor approval, and perform compliance testing and corrections; and
C. computer readable program code implementing a plan participant interface receiving inputs from said plan participants and based on said received inputs performing, via instructions to said plan participant gateway, any of, or a combination of, the following tasks: updating information associated with said participants, updating personal investment designations, view and print personal account statement or personal activity reports, sending messages to plan sponsor internal e-mail address, and monitoring, modeling and applying for retirement plan loans, transfers, and distribution.

10. An article of manufacture, as per claim 9, wherein said program code is implemented in any of the following architectures: Java, .NET, or COM+.

11. A plurality of specialized interfaces interacting with a plurality of specialized gateways for the management of retirement funds, said interfaces comprising:
a. a first interface authorizing access to one of the following personnel: a plan provider representative, a plan sponsor representative, or a plan participant;
b. a second interface implementing a full service plan accessible by said authorized plan provider representatives, said second interface performing, via instructions to a plan provider gateway, a plan sponsor gateway, or a plan participant gateway, any of, or a combination of, the following tasks: perform all plan maintenance, approve and modify plan sponsor settings and plan settings, process corrections and adjustments, review audit trail of transactions and activities for each plan, activate and/or suspend plans, enter system-wide bulletins to plan sponsors and/or participants via internal system e-mail, set fees and charges, maintain a spectrum of all available investments and funds, process and distribute income and dividends to participants' accounts across all plans, and review system logs;
c. a third interface implementing a self service plan accessible by said authorized plan sponsor representatives, said second interface performing, via instructions to said plan sponsor gateway or a plan participant gateway, any of, or a combination of, the following tasks: setup and maintain client information, setup and maintain multiple concurrent plans, define fund availability, process plan activity, approve plan activity, administer plan activity, review fees and changes, enter company bulletins for plan participants via internal system e-mail, generating an e-mail message to plan sponsor's internal and external e-mail addresses regarding pending transactions that require plan sponsor approval, and perform compliance testing and corrections; and
d. a fourth interface accessible via said authorized plan participants and performing, via instructions to said plan participant gateway, any of, or a combination of, the following tasks: updating information associated with said participants, updating personal investment designations, view and print personal account statement or personal activity reports, sending messages to plan sponsor internal e-mail address, and monitoring, modeling and applying for retirement plan loans, transfers, and distribution.

12. A plurality of specialized interfaces interacting with a plurality of specialized gateways for the real-time management of retirement funds, as per claim 11, wherein said management of retirement funds is done in real-time.

13. A plurality of specialized interfaces interacting with a plurality of specialized gateways for the real-time management of retirement funds, as per claim 11, wherein said management of retirement funds is done in near real-time.

14. A plurality of specialized interfaces interacting with a plurality of specialized gateways for the real-time management of retirement funds, as per claim 11, wherein said interfaces are implemented via any of the following architectures: Java, .NET, or COM+.

15. A plurality of specialized interfaces interacting with a plurality of specialized gateways for the real-time management of retirement funds, as per claim 11, wherein said interfaces are rendered via an industry standard browser.

16. A plurality of specialized interfaces interacting with a plurality of specialized gateways for the real-time management of retirement funds, as per claim 11, wherein said plan sponsor interface performing compliance testing renders results associated with any of the following compliance tests: 402(g), 401(k), 401(m), 415, multiple use test, top heavy test, coverage test, and compensation test.

17. A plurality of specialized interfaces interacting with a plurality of specialized gateways for the real-time management of retirement funds, as per claim 11, wherein said network is any of the following: local area network (LAN), wide area network (WAN), or the Internet.

18. A plurality of specialized interfaces interacting with a plurality of specialized gateways for the real-time management of retirement funds, as per claim 11, wherein said retirement funds are funds associated with any of the following: 401(k) plan, money purchase plan, or profit sharing plan.
